(19) United States
(12) Patent Application Publication
(10) Pub. No.: US 2023/0415122 A1
(43) Pub. Date: Dec. 28, 2023

(54) DESALINATION OF WATER USING A COMPLEXING AGENT ATTACHED TO A MAGNETIC NANOPARTICLE

(71) Applicant: N W P T - NANO WATER PURIFICATION TECHNOLOGY LTD, Tel Aviv-Yafo (IL)

(72) Inventors: Vladimir KOGAN, Rehovot (IL); Yaron VIRTZER, Ramat Hasharon (IL); Remez LEV ARI, Herzelia (IL); Shiri CARMIELLI, Ness Ziona (IL)

(73) Assignee: N W P T - NANO WATER PURIFICATION TECHNOLOGY LTD, Tel Aviv-Yafo (IL)

(21) Appl. No.: 18/022,557

(22) Filed: Feb. 22, 2023

Related U.S. Application Data
(63) Continuation-in-part of application No. PCT/IL21/51033, filed on Aug. 23, 2021.

(30) Foreign Application Priority Data
Aug. 24, 2020 (IL) 276904

(51) Int. Cl. B01J 20/28; B01J 20/32; C02F 1/48; C02F 1/68

(52) U.S. Cl. CPC B01J 20/28009; B01J 20/28007; B01J 20/28016; B01J 20/3219; C02F 2103/08; C02F 1/488; C02F 1/683; C02F 2305/08; B01J 20/3255

(57) ABSTRACT

There is disclosed, a desalination apparatus making use of a particles including covalently bonded functionalized magnetic nanoparticles coupled to a complexing agent. For example, the complexing agent may include a crown ether. The particles are optionally used for removing salt from water, for example sea water. The apparatus optionally includes a magnet for magnetic filtering, concentrating and/or removing the particles and/or contaminant (e.g., salt). In some embodiments, the salt is then separated back from the particles using UV light. The remaining unclarified water may be washed out with the contaminant and/or used for salt production and/or disposed of (e.g., dumped back to the sea). Optionally, the particles are regenerated. For example, the regenerated particulars may be reused for further desalination steps (e.g., further salt removal from the clarified water) to clarify new input water. Covalently bonded functionalized magnetic nanoparticles coupled to a complexing agent are also disclosed.

### FIELD AND BACKGROUND OF THE INVENTION

The present invention, in some embodiments thereof, relates to the desalination of seawater and, more particularly, but not exclusively, to removing salt from water without removing other minerals and/or without membrane filtration.

U.S. Pat. No. 6,972,095 appears to disclose “A decontamination system uses magnetic molecules having ferritin cores to selectively remove target contaminant ions from a solution. The magnetic molecules are based upon a ferritin protein structure and have a very small magnetic ferritin core and a selective ion exchange function attached to their surface. Various types of ion exchange functions can be attached to the magnetic molecules, each of which is designed to remove a specific contaminant such as radioactive ions. The ion exchange functions allow the magnetic molecules to selectively absorb the contaminant ions from a solution while being inert to other non-target ions. The magnetic properties of the magnetic molecule allow the magnetic molecules and the absorbed contaminant ions to be removed from solution by magnetic filtration.”

U.S. Pat. No. 8,097,164 appears to disclose “A process for selectively removing contaminant ions from a solution includes: a) contacting the solution with magnetic particles coupled to selectively chelating ion exchange functionality containing moieties prepared by: i) activating carboxyl groups on the selectively chelating ion exchange functionality containing moieties by the formation of an acyl fluoride, and ii) reacting the acyl fluoride with the magnetic particles, the magnetic particles having a particle size less than 10 microns; b) allowing the chelating functionality coupled magnetic particles to selectively bind one or more of the contaminant ions; and, c) extracting the chelating functionality coupled magnetic particles and contaminant ions from the solution by magnetic filtration.”

U.S. Pat. No. 8,636,906 appears to disclose “magnetic nanoparticles and methods of using magnetic nanoparticles for selectively removing biologics, small molecules, analytes, ions, or other molecules of interest from liquids.”

International Patent Application no. 2018104958 appears to disclose “nanoparticle based desalination system and a method of desalination thereof. The subject matter provides a nanoparticle system having a core and a positively charged species coated on the core. The positively charged species has an ionizable group. The pH value of the nanoparticle system is more than the pKa value of the ionizable group and the nanoparticle system is configured to cause desalination of negatively charged ions from an effluent.”

Spanish patent no. 2598032 appears to disclose “Desalination method of brines. Extract the common salt contained in sea water, brackish water from wells or places where the excess of sodium, lithium or potassium chloride contained in the water affects the viability of industrial processes and/or domestic consumption or for the use of salts for industrial purposes. When working with seawater, the priority would be to obtain quality water for industrial use, which can be used as ingesting water or for agricultural use. The patent proposal is to use zero-valent iron nanoparticles, alone or in combination with cobalt or manganese nanoparticles, to extract sodium, lithium or potassium chloride from seawater or other waters rich in alkali halides using static magnetic fields.”

Additional art may include studies showing negative health effects that may be associated with conventionally desalinated water and/or lack of minerals such as Magnesium in water.

Additional art may include:
Koren, Gideon & Shlezinger, Meital & Katz, Rachel & Shalev, Varda & Yona, Amitai. (2016). Seawater desalination and serum magnesium concentrations in Israel. Journal of Water and Health. 15:10.2166/wh.2016.164. https://www.researchgate.net/publication/311527623 Seawater de salination and serum magnesium concentrations in Israel
Koren, Gideon & Yona, Amitai & Shlezinger, Meital & Katz, Rachel & Shalev, Varda. (2018). Sea water desalination and removal of iodine; effect on thyroid function. Journal of Water and Health. 16.wh2018372.10.2166/wh.2018.372: https://www.researchgate.net/publication/324385621 Sea water d esalination and removal of iodine effect on thyroid function
Shlezinger, Meital & Yona, Amitai & Akriv, Amichay & Gabay, Hagit & Shechter, Michael & Leventer-Roberts, Maya. (2018). Association between exposure to desalinated sea water and ischemic heart disease, diabetes mellitus and colorectal cancer; A population-based study in Israel. Environmental Research. 166.10.1016/j.envres.2018.06.053: https://www.researchgate.net/publication/326190272 Association between exposure to desalinated sea water and ischemic heart disease diabetes mellitus and colorectal cancer A population-based study in Israel
Shlezinger, Meital & Yona, Amitai & Goldenberg, Ilan & Atar, Shaul & Shechter, Michael. (2019). Acute myocardial infarction severity, complications, and mortality are associated with a lack of magnesium intake through consumption of desalinated seawater. Magnesium research. 32.10.1684/mrh.2019.0449: https://www.researchgate.net/publication/336104555 Acute myoca rdial infarction severity complications and mortality associat ed with lack of magnesium intake through consumption of desali nated seawater

### SUMMARY OF THE INVENTION

According to an aspect of some embodiments of the invention, there is provided a system for purifying water including: complexing units each of the complexing units including a complexing site configured to bind a contaminant, a reactor configured for mixing water containing the contaminant with the complexing units, a concentrator configured for drawing the complexing units to a release area, the release area selected from inside of the reactor and in communication with the reactor; an energy source configured to direct energy to the release area causing the complexing sites to release a portion of the contaminant.

According to some embodiments of the invention, the complexing unit is connected to a nanoparticle by a covalent bond.

According to some embodiments of the invention, the nanoparticle is a magnet.

According to some embodiments of the invention, the concentrator includes a magnet.

According to some embodiments of the invention, the magnet includes an electromagnet.

According to some embodiments of the invention, the magnet includes a permanent magnet.

According to some embodiments of the invention, the magnet is movable between a location near the release site for concentrating the particles and a location far from the release site for freeing the particles.

According to some embodiments of the invention, the energy source is configured to direct light to the release area (e.g., visible and/or InfraRed (IR) and/or Ultraviolet (UV) and/or white light and/or sunlight).

According to some embodiments of the invention, the energy source is configured to direct UV light to the release area.

According to some embodiments of the invention, the energy source includes at least one source of ultraviolet light and a means to direct sunlight to the release area.

According to some embodiments of the invention, the contaminant is salt, and the complexing site is configured to bind a component of the salt.

According to some embodiments of the invention, the system is configured for carrying by a person.

According to some embodiments of the invention, the system is packaged in a container for delivery by standard shipping.

According to some embodiments of the invention, the system is built onto a ship.

According to some embodiments of the invention, the system is built onto a car, SUV, van or truck.

According to an aspect of some embodiments of the invention, there is provided a complexing unit for use in purifying water including: at least two complexing sites and a joint connecting the at least two complexing sites, the joint having a release mode and a collecting mode wherein the in the collecting mode, the at least two complexing sites are far apart and can each complex a contaminant ion and in the release mode the at least two complexing sites are close together such that repulsion between like ions prevents at least a portion of the complexing sites from complexing the contaminant.

According to some embodiments of the invention, each at least two complexing sites includes a crown ether.

According to some embodiments of the invention, the joint includes a diazo moiety.

According to some embodiments of the invention, the complexing unit further includes: a magnetic portion for magnetic filtering of the complexing unit.

According to some embodiments of the invention, the complexing unit further includes: a nanoparticle attached to the complexing unit via a covalent bond.

According to some embodiments of the invention, the nanoparticle is magnetic.

According to some embodiments of the invention, the complexing sites are configured to complex to a sodium ion.

According to some embodiments of the invention, the contaminant includes salt.

According to some embodiments of the invention, the joint is configured to change the mode by exposure to an energy.

According to some embodiments of the invention, the energy includes light.

According to some embodiments of the invention, the energy includes UV light.

According to some embodiments of the invention, the energy includes sunlight.

According to an aspect of some embodiments of the invention, there is provided a method of water purification including: mixing a plurality of complexing units with water containing a contaminant; binding the contaminant with the complexing units; concentrating the complexing units bound to the contaminant to an impound area; outputting clean water from a portion of the reactor isolated from the impound zone; releasing the contaminant from the complexing units into a reduced water volume thereby producing concentrated contaminant; collecting the concentrated contaminant.

According to some embodiments of the invention, the releasing includes exposing the complexing units to radiation.

According to some embodiments of the invention, the exposing includes exposing the complexing unit to at least one of UV light, white light and sunlight.

According to some embodiments of the invention, the radiation includes ultraviolet light.

According to some embodiments of the invention, the concentrating includes exposing the complexing units to a magnetic field.

According to some embodiments of the invention, the collecting includes drawing the complexing units to an impound area with a magnet.

According to some embodiments of the invention, the collecting includes activating the magnet.

According to some embodiments of the invention, the contaminant includes salt.

According to some embodiments of the invention, the complexing agent includes a crown ether.

According to some embodiments of the invention, the complexing unit includes a joint connecting the at least two complexing units, the joint having a release mode and a collecting mode wherein the in the collecting mode, the at least two complexing units are far apart and can each complex a contaminant ion and in the release mode the at least two complexing units are close together such that repulsion between like ions prevents at least a portion of the complexing units from complexing the contaminant.

As mentioned above, the complexing unit is most preferably provided in the form of a surface-modified magnetic particle having a crown ether covalently bonded on its surface through at least one linker, as shown by Formula 2:

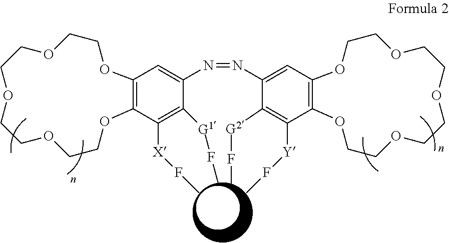

wherein the solid circle indicates the magnetic particle (e.g., magnetic nanoparticle with size from 2 to 1000 nm, e.g., from 50 to 300 nm), n=0, 1, 2, and wherein each of F—X′, F-G¹′, F-G²′ and F—Y′ is either a linker connecting the crown ether to the particle, or is null. For example, a single linker may connect the crown ether to the particle, e.g., either F-G²′ or F—Y′, or a pair of linkers, e.g., both F-G¹′ and F-G²′.

The linker contains a linkage selected from:

amide bond —C(O)NH— or —C(O)NR—, wherein R is C1-C10 (e.g., C1-C5) straight or branched optionally substituted alkyl, cycloalkyl, —(CH₂)ₚ-optionally substituted aryl, wherein p is from 0 to 5, inclusive (for example, when p=1 and aryl is benzene, then R is the benzyl group), and —(CH₂)ₚ-heteroaryl (the connectivity may be in any of the two possible directions, i.e., the carbon and nitrogen atoms of the amide bond are adjacent to the magnetic particle and crown ether, respectively, or vice versa);
ether bond;
thioether bond;
imine bond —HC═N— or —RC═N—, wherein R is C1-C10 alkyl (e.g., C1-C5) (the connectivity may be in any of the two possible directions, i.e., the carbon and nitrogen atoms of the imine bond are adjacent to the magnetic particle and crown ether, respectively, or vice versa);
ester bond —C(O)—O— (the connectivity may be in any of the two possible directions, i.e., the carbon and oxygen atoms of the ester bond are adjacent to the magnetic particle and crown ether, respectively, or vice versa); and
C3-C6 ring or heterocyclic group, which are obtainable by cycloaddition reaction.

The surface-modified magnetic particle having a crown ether covalently bonded on its surface through at least one linker, as shown by Formula 2, forms another aspect of the invention.

It is prepared through a reaction between a functionalized magnetic particle (e.g., Fe₃O₄) and suitable benzo crown ethers, i.e., a reaction between group F on the magnetic nanoparticles and group X, G¹, G² and Y attached to the benzo crown ether of Formula 1 shown below, whereby a corresponding linker F—X′, F-G¹′, F-G²′ and F—Y′, with the linkages set out above, is formed. Preferred examples include:
a magnetic particle having one or more —NH₂ functional group on its surface and a crown ether which contains —COOH or —COOR² groups as defined below, such that on reaction, a linker is formed which comprises an amide bond (or vice versa: the magnetic particle has —COOH groups on its surface, and the crown ether contains —NH₂ or —NHR² groups as defined below);
a magnetic particle bearing thiol —SH group on its surface, and a crown ether which contains a carbon-carbon double bond (—C═C— functionality), such that on reaction, a linker is formed which comprises a thioether bond (or vice versa: the magnetic particle has —C═C— functionality on its surface, whereas the crown ether contains the —SH group);
a magnetic particle having hydroxyl —OH on its surface, and crown ether substituted with —COOH group, such that on reaction, a linker is formed which contains an ester bond (or vice versa); and
a magnetic particle having an azide —N═N═N attached to its surface, and a crown ether having terminal carbon-carbon triple bond, such that on reaction, a linker is formed which comprises a triazole ring.

Preferred Examples of a surface-modified magnetic particle having a crown ether covalently bonded on its surface, according to Formula 2, include:

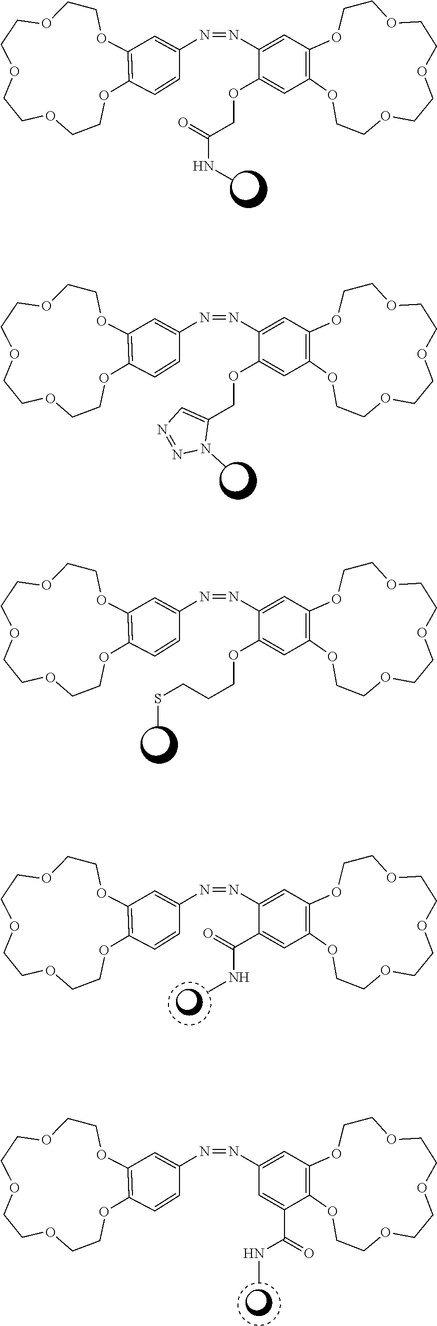 [SMILES: CNC(=O)COc1cc2c(cc1/N=N\c1ccc3c(c1)OCCOCCOCCOCCO3)OCCOCCOCCOCCO2 ; Cn1nncc1COc1cc2c(cc1/N=N\c1ccc3c(c1)OCCOCCOCCOCCO3)OCCOCCOCCOCCO2 ; CSCCCOc1cc2c(cc1/N=N\c1ccc3c(c1)OCCOCCOCCOCCO3)OCCOCCOCCOCCO2 ; CNC(=O)c1cc2c(cc1/N=N\c1ccc3c(c1)OCCOCCOCCOCCO3)OCCOCCOCCOCCO2 ; CNC(=O)c1cc(/N=N\c2ccc3c(c2)OCCOCCOCCOCCO3)cc2c1OCCOCCOCCOCCO2]

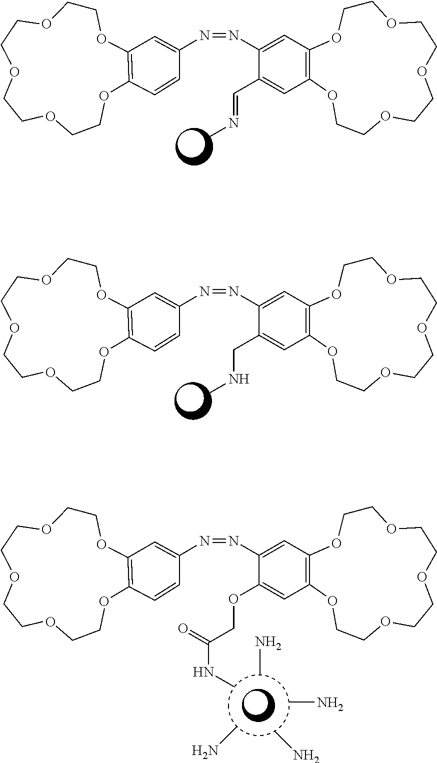

wherein the dashed line indicates a silanol layer applied onto the magnetic particle;

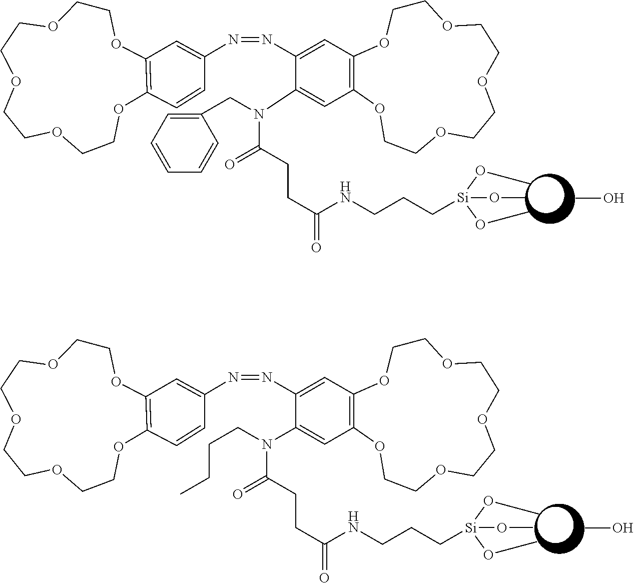

Suitable crown ethers and synthetic pathways for obtaining such crown ethers are illustrated below. The crown ethers are represented by Formula 1:

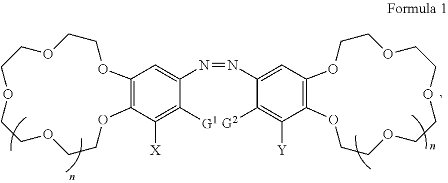

wherein, n=0, 1, 2 (preferably n=1);
G¹, G², X, Y are independently selected from H, —OH, —O-Metal, —CN, —R¹, —C(O)H, —NH₂, —NHR², —N₃, —SH, —O—R³, —COOH, —COOR², —R⁴COOH, —R⁴COOR², —O(SO₂)—R⁵;
R¹ is optionally substituted alkyl (e.g., hydroxy-substituted alkyl, oxo-substituted alkyl and halogenated alkyl), alkenyl or alkynyl;
R² is alkyl, cycloalkyl (optionally with hetero atoms), aryl, and heteroaryl;
R³ is substituted alkyl (e.g., with —COOH, such as —CH₂COOH), alkynyl, alkenyl;
R⁴ is linear or branched alkylene, oxo-substituted linear or branched alkylene; hydroxy-substituted linear or branched alkylene, linear or branched alkenylene;
R⁵=alkyl, halogenated alkyl, aryl and heteroaryl.
and wherein at least one of G¹, G², X, Y is other than hydrogen or unsubstituted alkyl.

The crown ethers of Formula 1 and their methods of synthesis form additional aspects of the invention. As mentioned above, the surface modified magnetic particles of Formula 2 serve for the removal of ions from water, through the capture/release mechanism described herein.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by the computer using any suitable operating system. In an exemplary embodiment of the invention, one or more tasks according to exemplary embodiments of the method and/or system as described herein are performed by a data processor, such as a computing platform for executing a plurality of instructions. Optionally, the data processor includes a volatile memory for storing instructions and/or data and/or non-volatile storage, for example, a magnetic hard disk and/or removable media, for storing instructions and/or data. Optionally, a network connection is provided as well. A display and/or a user input device such as a keyboard or mouse are optionally provided as well.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the shown are by way of example and for purposes of illustrative discussion of embodiments of the invention. In this regard, the description taken with the drawings makes apparent to those skilled in the art how embodiments of the invention may be practiced.

In the drawings:

FIG. 1A is a block diagram of a water desalination system in accordance with an embodiment of the current invention;

FIG. 1B is a block diagram of a water desalination system with an active particle return in accordance with an embodiment of the current invention;

FIG. 2A is a flow chart illustration of a method of water desalination in accordance with an embodiment of the current invention;

FIG. 2B is a flow chart illustration of a method of water desalination with active particle recovery in accordance with an embodiment of the current invention;

FIG. 3 is a schematic view of a photo responsive diazo-crown ether unit switching between in a catching configuration (trans configuration) and a releasing configuration (cis configuration) in accordance with an embodiment of the current invention;

FIG. 4A is a schematic view of crown ethers close one to another, prior to releasing configuration, in accordance with an embodiment of the current invention (cis configuration);

FIG. 4B is a schematic view of crown ethers close one to another in a releasing configuration wherein electrostatic repulsion releases a portion of caught ions in accordance with an embodiment of the current invention;

FIG. 5 is a schematic view of a complexing agent with an alkyne-modified bis benzocrown detached from a magnetic nanoparticle in accordance with an embodiment of the current invention;

FIG. 6 is a schematic view of an alkyne-modified bis benzocrown attached at a condition of alkyne-azide Huisgen bipolar 1,3-cycloaddition to a magnetic nanoparticle in accordance with an embodiment of the current invention;

FIG. 7 is a schematic illustration of a scalable desalination system in accordance with an embodiment of the current invention;

FIG. 8 is a schematic illustration of a scalable desalination system with active particle return in accordance with an embodiment of the current invention;

FIG. 9 is a schematic illustration of a scalable desalination system in accordance with an embodiment of the current invention;

FIG. 10 is a schematic illustration of a scalable desalination system with active particle return in accordance with an embodiment of the current invention;

FIG. 11A is an image of a backpack water purification system in accordance with an embodiment of the current invention;

FIG. 11B is a schematic illustration of a backpack water purification system in accordance with an embodiment of the current invention;

FIG. 12 is a schematic illustration of a vehicle transportable water purification system in accordance with an embodiment of the current invention;

FIG. 13 is a schematic illustration of a ship transportable water purification system in accordance with an embodiment of the current invention.

### DESCRIPTION OF SPECIFIC EMBODIMENTS OF THE INVENTION

The present invention, in some embodiments thereof, relates to the desalination of seawater and, more particularly, but not exclusively, to removing salt from water without removing other minerals and/or without membrane filtration.

The present invention removes salt from water without heat.

The present invention removes salt from water with low energy/electricity requirements which are estimated to be reduced by ˜95%, thereby making desalinated water more affordable for most crop irrigation. The cost estimation is based on the fact that the separation is conducted by applied magnetic field gradients from a permanent rare earth magnet, and hence does not require huge electricity consumption demand by the high pressure feed pumps currently used in the desalination process to operate the process at 40-80 bars.

### Overview

UNESCO estimates that around 2.2 billion people live without access to safe, clean drinking water. By 2050, up to 5.7 billion people could be living in areas where water is scarce for at least one month a year. With seawater making up 97.5% of the world's water resource, low energy desalination solutions will be a vital component of providing sufficient levels of good-quality drinking water for a growing population.

The invention in some embodiments thereof relates generally to the method for purifying water, and more particularly an apparatus and method for water desalination (salt removal). Desalination refers to any of several processes that remove salt and other minerals from water. Water is desalinated, for example, to convert it to potable fresh water and/or for industrial use and/or for agricultural use.

Many methods of desalination are available. For example, reverse osmosis (RO) or distillation systems for large scale water purification. Many of these methods are characterized by high energy demand. RO systems often require both high pressure produced by pumps and/or extensive maintenance due to fouling and damage to the membrane. Thus, in many applications, distillation and/or RO are problematic, for example, for use in places in which energy is limited, such as third world countries and/or rapid deployment such as after hurricane storms or earthquakes. The present invention, in some embodiments thereof, is directed to overcoming or at least reducing the effects of one or more of the problems set forth above.

An aspect of some embodiments of the current invention relates to a desalination apparatus making use of particles including covalently bonded functionalized magnetic nanoparticles coupled to a complexing agent. For example, the complexing agent may include a crown ether. The particles are optionally used for removing salt from water, for example, sea water. The apparatus optionally includes a magnet for magnetic filtering, concentrating and/or removing the particles. Optionally, after the particles are filtered and/or concentrated the clarified water is drained for use. In some embodiments, the salt is then separated back from the particles, for example, using UV light, white light and/or sunlight. The salt may then be washed out, for example with the remaining water. For example, between 85 to 100% of the water may be clarified and/or 60 to 85% of the water may be clarified and/or 30 to 60% of the water may be clarified. The remaining unclarified water may be washed out with the salt and/or used for salt production and/or disposed of (e.g., dumped back to the sea) and/or transferred with the regenerated particles for further clarification. Optionally the regenerated particles can then be reused for further desalination steps (e.g., further salt removal from the clarified water) and/or to clarify new input water.

Additionally or alternatively, a desalination system may include a pump, a sonication system and/or a heating system. In some embodiments, the invention may include removing salt from water. For example, salt may be removed from flowing water. For example, the system may remove the majority of salt out from the water source like seawater, lake and/or brackish ground water and/or brine.

In some embodiments, the energy and/or electricity requirements may be reduced by between 75 to 99% and/or 50 to 75% and/or 25 to 50% and/or 5 to 25% in comparison to RO. In some embodiments, this will make desalinated water affordable for crop irrigation. In some embodiments, separation is conducted by applied magnetic field gradients, for example from a permanent rare earth magnet. Such separation may not require huge electricity consumption demand by the high pressure feed pumps currently used in the desalination process.

An aspect of some embodiments of the current invention relates to a unit (for example a nanoparticle) configured for removing the salt from water. Optionally, the unit includes a magnetic nanoparticle coupled to an ion catching unit. The unit in some embodiments thereof may be regenerated and reused. In a preferred embodiment, salt (e.g., a sodium cation and/or a chloride ion) is trapped by the catching unit (for example the catching unit may include a crown ether). Optionally, a strong magnetic field attracts and/or repels the units. For example, a properly applied field may pull the units over to the sidewalls of a water tank leaving behind purified water. The units are optionally washed away and/or collected for further use. Alternatively or additionally, a valve may direct water from one end of the water tank to the other end allowing for continuous processing. Additionally or alternatively, the system may comprise a power supply for activating a strong magnetic field for concentrating the magnetic units, for example near the bottom of a water tank to allow quick and/or easy separation of the purified water from the concentrated units.

An aspect of some embodiments of the current invention relates to the regeneration of particles. Optionally, the ion catching unit may include multiple complexing agents connect to a form changing bond. For example, under a first condition (e.g., dark) the bond holds the complexing agents far apart allowing each complexing agent to catch an ion. Optionally, when exposed to another condition (e.g., light) the bond changes shape bringing the complexing agents to close together causing the release of a portion of the ions. For example, the complexing agent may include a crown ether group. For example, the bond may include a Diazo moiety. For example, the functionalized nanoparticles are reuse by removing and/or releasing bound salts from the particles using a UV light source and/or a white light source and/or another energy source. Alternatively or additionally, the system may include one or more mirrors, prisms and/or lenses to direct sunlight as a source of light for release.

In some embodiments, the process is scalable. For example, by the application of linearly scalable continuous stirred tank reactors with water flow under gravitation or by single tank or pipes process. For multiple uses, the invention, in some embodiments thereof, provides a method of removing the salt from the trapping unit.

Some embodiments of the present invention may provide various advantages or benefits. For example, the present invention, may facilitate construction and/or maintenance of a desalination system at almost any place on Earth and not only in specific geographical locations that are typically close to a power plant and/or near sea shore (for cooling the power plant). Some embodiments of the current invention require less space than conventional desalination plants and/or may be used in areas of less expensive land than conventional desalination plants. In some embodiments, a desalination plant may produce less noise than plants of conventional technologies. For example, reverse osmosis plants may use pumps to achieve high pressures to push water across a semipermeable membrane and/or against an osmotic gradient; pumps may create significant noise. In some embodiments of the current invention, may employ fewer pumps and/or pump water at lower pressures and/or pump less volume and/or reduce noise. The above features of some embodiments of the current invention may facilitate positioning a desalination plant nearby to a city. For example, placing a desalination plant near a city may save 10's or 100's of kilometers of pipelines, pumps and maintenance needed to transport water from the desalination plant to the city.

Some embodiments of the present invention are small-size relative to conventional desalination plants, and/or have a small and/or smaller carbon footprint. Optionally, construction and installation are easier, faster, less expensive, and/or have less environmental impact than convention desalination plants. Some embodiments of the present invention are scalable and/or may be implemented at a small mid and/or a large scale, and/or may solve or mitigate the problem of depletion of non-renewable energy sources.

Some embodiments of the present invention may be environmentally friendly. Optionally, the system is based on a closed loop. For, example there may be reduced and/or no chemical pollution and/or polluting aspects compared to conventional desalination plants. Optionally, the system will reduce the carbon footprint of the power plant compared to conventional desalination plants. Some embodiments may be deployed virtually anywhere and are not limited to only regions with power plants and/or near the sea (for cooling).

Some embodiments of the present invention may require a small and/or reduced land footprint when compared to conventional desalination plants. Alternatively or additionally, a plant in accordance with some embodiments of the current invention may be more economical to construct, operate and/or maintain, relative to conventional desalination plants. Some embodiments of the present invention may be installed underground.

Some embodiments of the current invention save resources on pumping of salt water; for example, a conventional desalination plant typically needs powerful and expensive pumps, which are also expensive to operate and maintain.

Some embodiments of the present invention will not require a particular geographical location and/or access to a power plant. For example, they may be implemented and constructed in any area near urban areas and cities (and thus avoiding and/or reducing and/or minimizing the cost to distribute the water from the desalination plant to consumers), which can save tens to hundreds of kilometers of water pipes and/or pumps and/or power and/or maintenance. For example, a desalination plant according to some embodiments of the current invention may be positioned in or next to highly-populated areas, away from (or without access to) a seashore or other body of water. The salt can be used for another purpose like salt for industry and consumers etc.

In some embodiments, a desalination system of the current invention removes salt and/or other contaminants selectively while leaving behind beneficial minerals. For example, conventional desalination methodologies (e.g., membrane filtration, distillation) often remove Magnesium Calcium and Potassium. The removal of Magnesium from drinking water may have a negative health effect on people who depend on the desalinated water for drinking (e.g., ischemic heart disease, diabetes mellitus and/or colorectal cancer). In some embodiments of the current invention, salt is removed from water while Magnesium is substantially unaffected and/or mostly unaffected and/or is left with the desired concentration. Alternatively or additionally, Magnesium and/or other minerals may be selectively removed, retained and/or concentrated and/or collected according for instance with the intended use of the water. Water including the proper quantities of minerals (e.g., Calcium, Magnesium, Boron and/or Potassium) may be advantageous for agriculture. An aspect of some embodiments of the current invention includes selectively removing some contaminants (e.g., salt) while selectively retaining and/or adjusting quantities of other minerals in quantities that make the water more suitable for agriculture.

In some embodiments, a system in accordance with the current invention may be less vulnerable to disruption than conventional systems (e.g., membrane filtration and/or distillation). For example, in disaster situations, power supplies may be disrupted. Energy intensive water supply technologies may be disrupted. Such disruption of water supply may compound the disaster. In some embodiments, the current invention allows water purification and/or desalination with reduced power consumption and/or reduced vulnerability to disruption. Alternatively or additionally, some embodiments of the current invention may facilitate transportable water purification and/or desalination systems (for example by ship and/or in containers) that can be transported to a disaster and/or drought stricken area to alleviate short term water supply disruption.

In some embodiments of the current invention, desalination of water is achieved with reduced cost in terms of chemicals, environmental impact and/or labor. For example, conventional desalination methodologies (e.g., membrane filtration) may require chemically intensive and/or labor intensive cleaning (for example of membranes). For example, this cleaning may result in a need to dispose of acidic cleaning waste that may result in significant environmental damage. Furthermore, some conventional desalination techniques (e.g., membrane filtration) may require expensive upkeep (for example of filtration membranes). Some embodiments of the current invention achieve desalination with reduced cleaning, upkeep, and/or environmental impact.

An aspect of some embodiments of the present invention is related to the field of improving population health due to the effect of a magnetic field on water. For example, when applied to water the magnetic field may restructure the water molecules into very small water molecule clusters.

In some embodiments, a system may include a small number of nanoparticles. For example, to achieve high levels of contaminant removal the system may recycle and/or repeated the purification process multiple times to further purify the water of the contaminant (e.g., salt).

In some embodiments, a system may include a large number of nanoparticles. For example, the system may achieve high levels of contaminant removal of contaminant (e.g., salt) in a single cycle.

### SPECIFIC EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

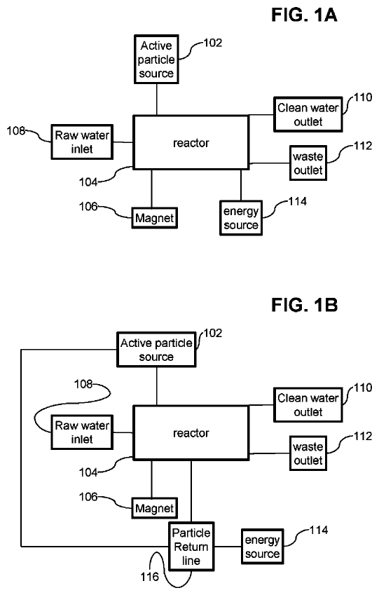

FIG. 1A is a block diagram of a water purification and/or desalination system in accordance with an embodiment of the current invention.

FIG. 1B is a block diagram of a water purification and/or desalination system with an active particle return in accordance with an embodiment of the current invention. In some embodiments, raw water having a contaminant, for example, salt, enters an inlet 108 and/or is mixed in a reactor 104 with activated particles 102. The particles 102 optionally include a complexing agent for the contaminant and/or a magnetic portion. Optionally, particles are designed to release the contaminant on exposure to energy, for example, the energy may include light (e.g., visible and/or InfraRed (IR) and/or Ultraviolet (UV) and/or white light and/or sunlight) or energy of another form (e.g., radio wave, microwave and/or heat). Optionally, the system includes a magnet 106 and/or an energy source 114 (e.g., a source of energy that causes the release of the contaminant from the complexing agent). Optionally, the system includes a clean water outlet 110 and/or a waste outlet 112. In some embodiments, the system may include an active particle return line 116.

In some embodiments, magnet 106 includes a rare earth magnet and/or an electro-magnet which may be connected to a power source to provide the magnetic field. Alternatively or additionally, magnet 106 may include a superconducting electromagnet. Optionally, magnet 106 may be configured for filtering magnetic particles from fluid in reaction 102. For example, magnet 106 may be positioned near a particle impound area in reactor 104 such that when magnet 106 is deactivated, the particles 102 are free to mix throughout the fluid in the reactor 104 and/or when the magnet 106 is activated, the particles are drawn to the impound area. For example, the impound area may be near a wall of reactor 104 and/or a bottom of reactor 104. In some embodiments, the impound area may be associated with the waste outlet 112 and/or a particle return line 116 and/or may be configured for isolation from the rest of the reactor (e.g., by means of a valve and/or a moving wall, etc.). Optionally, a clean water outlet 110 is connected to the reactor at a location that is not in the impound area and/or is far from the impound area. For example, the impound area may include a space near the floor of reactor 104 and/or the magnet 106 may be positioned below the floor of the reactor and/or waste outlet 112 may be located near or in the floor of reactor 104 and/or clean water outlet 110 may be located higher up in the reactor. Optionally magnet 106 is activated by directing power to magnet 106 (e.g., an electromagnet) and/or by moving magnet 106 towards the impound area and/or towards the reactor (e.g., for a rare earth magnet). Optionally magnet 106 is deactivated by cutting power to magnet 106 (e.g., an electromagnet) and/or by moving magnet 106 away from the impound area and/or away from the reactor (e.g., for a rare earth magnet).

In some embodiments, a system for water purification and/or desalination may be connected to a power supply and/or include a controller. For example, the system may include a dedicated power supply (e.g., a battery and/or a generator) and/or may be connected to a power grid and/or an external power supply. Optionally, a controller may control valves, pumps and/or other components of the system. Optionally, the controller may monitor the system. For example, the controller may receive status information from flow sensors and/or volume sensors and/or concentration sensors (for example electrical conductivity sensors) and/or other temperature sensors and/or pressure sensors and/or other sensors. Optionally, the controller may coordinate actions of the system and/or detect malfunction and/or improve performance (for example repeating cycles of purification to achieve the desired output quality and/or improve efficiency.

In some embodiments, an energy source 114 may direct energy toward the impound area of reactor 104 and/or toward particle return line 116. For example, the energy may cause the particles to release all or some of the complex contaminants (e.g., salt).

Optionally, the raw water source for the system may include seawater and/or brackish water and/or brine. In some embodiments, the water treatment process includes source-contaminated water that may be pretreated. Optionally, the system includes a pretreatment module. For example, pretreatment may include ultra-filtration and/or micro-filtration to remove large molecules. For example, pretreatment may include biological material. In some embodiments, the water is held in a mixing water tank including a mixer.

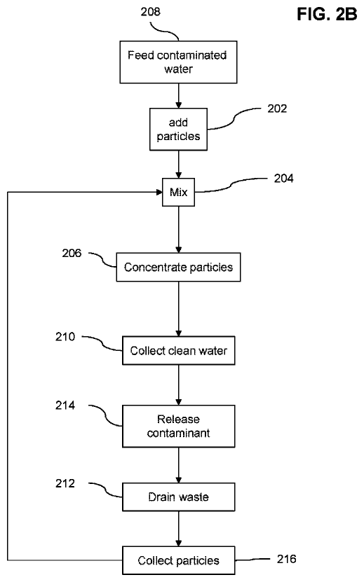

In some embodiments, the system may include a controller, actuators, and/or sensors, for example as described above with respect to FIG. 3A.

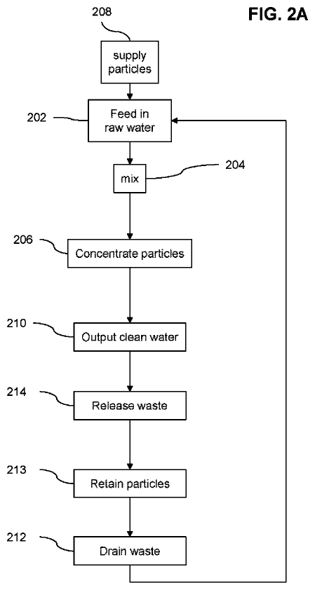

FIG. 2A is a flow chart illustration of a method of water desalination in accordance with an embodiment of the current invention.

In some embodiments, a reactor is supplied 208 with contaminant isolating units (for example magnetic complexing particles for example as described in FIGS. 3 to 6). Optionally the reactor is filled 202 with raw water (e.g., contaminated water for example where the contaminant is salt). The raw water and isolating units are optionally mixed 204 and/or allowed to react, for example, until the isolating units complex to a significant portion of the contaminant. Optionally, the complexed portion of the contaminant and/or the particles are then concentrated 206 (e.g., in an impound area) and/or separated from the clean water, for example, by activating a magnet to draw the particles with the contaminant to an impound area of the reactor. Optionally clean water is then outputted 210 from the rest of the reactor. In some embodiments, the clean water may be outputted 210 for use. Alternatively or additionally, the outputted 210 water may be put through the reactor again as raw water for further purification. For example, after a few purifications, which are optionally controlled according to suitable sensors, for example, a salinity sensor and/or a conductivity sensor, the water may be ready for use. Optionally, the contaminant is released 214 from the isolation units after the clean water has been outputted 210 from the reactor. For example, an energy source may radiate energy on the remaining isolation units and/or cause them to release 214 all or a part of the contaminant. For example, UV light may be directed to the isolating units causing them to release 214 contaminants.

After this stage, the remaining concentrated contaminated water is optionally drained 212 out (e.g., via gravitation and/or a pump and/or a valve) while the particles isolating units are retained 213 in the reactor (e.g., by magnetic forces). Optionally, new raw water (and/or the partially purified output water) is fed 202 into the reactor, and/or the isolation units are released to mix 204 into the input water.

For example, a magnet may be deactivated and/or moved away from the reactor to release the particles.

The concentration 206 step optionally involves the use of an external magnetic field to segregate the magnetic nanoparticles some or all of which are complexed with bound target from the remaining portion of the liquid. For example, the particles may be concentrated in an impound area (which may also be a release area) of the reactor. The extraction may be a batch or continuous process. The external magnetic field may be formed by any type of magnet having a sufficient field force. Strong rare earth magnets that do not use electricity and/or electromagnets provide a magnetic field that attracts the nanoparticles to the specified location depending on the specific process and apparatus configuration. In some embodiments, the impound area may include the bottom of the liquid receptacle containing the liquid to be purified. The magnetic field may be generated by one or more external magnets to generate a magnetic field flux is between suitable sensor 100 to 1,000 Gauss and/or between 1,000 to 100,000 Gauss and/or between 100,000 to 300,000 Gauss and/or between 300,000 Gauss to 1,000,000 Gauss, preferably between about 100 Gauss and about 60,000 Gauss, most preferably between about 5,000 Gauss and about 30,000 Gauss are used.

In some embodiments, some of the mechanisms in the system may have secondary benefits. For example, the process of releasing contaminants may involve irradiating the water with UV radiation which may also disinfect the water (for example by killing bacteria and/or deactivating viruses). For example, the concentration of the particles with magnets may also remove iron from the water.

FIG. 2B is a flow chart illustration of a method of water desalination with active particle recovery in accordance with an embodiment of the current invention. Optionally, the step of releasing 214 contaminants from the isolation units may be performed in a separate reactor from the main reactor where the isolation units are mixed 204 with the raw water. This may be advantageous in cases where the conditions and/or geometry of the main reactor are not conducive to the release process and/or when the release process takes a significant amount of time. Additionally or alternatively, there may be an additional step of collecting 216 the regenerated isolation units after they have released 214 a portion of the contaminant and/or returning them to the main reactor.

In some embodiment, the recovered nanoparticles may be added to the clean water and/or desalination may be repeated multiple times on the same water to further purify the water of salt. For example, repeated application of particles may be used when there are only a small number of particles.

Alternatively or additionally, it may take only one time to further purify the water of salt, for example, when there is a large number of nanoparticles.

The nanoparticles are optionally regenerated and/or are reusable. In a typical one tank batch embodiment, the liquid is held in a mixing tank fitted with a stirrer. The stirrer can be a continuous stirrer, non-continuous stirrer, a magnetic stirrer, or other mixing apparatus that achieves proper mixing of the liquid and nanoparticles.

Functionalized or unfunctionalized nanoparticles are mixed with the contaminated water, for example, from 1 sec to 500 min, preferably between about 10 sec to about 200 min, most preferably between about 1 min to about 60 minutes with the aid of the mixing apparatus.

FIG. 3 is a schematic view of a photoresponsive diazo-crown ether unit switching between a catching configuration 336 and a releasing configuration 338 in accordance with an embodiment of the current invention.

The following explanation is supplied to give a possible rational explanation to a possible theoretical model underlying the invention, but without limiting the invention to a particular theoretical model. Optionally, in dark conditions, a joint, for example including a diazo moiety 332, connects to two crown ethers 334 distanced apart in a catching configuration 336. For example, in the catching configuration 336, the crown ethers 334 may be connected to the diazo moiety 332 in the trans configuration. Optionally, in the catching configuration, each crown ether is free to complex the target (e.g., an ion). Upon exposure to light at a particular frequency and/or power, the unit switches 335 from the catching configuration 336 to the releasing cis configuration 338. For example, the crowns 334 are brought close to one another. For example, when exposed to ultraviolet (UV) light, the crown ethers 334 connected by the diazo moiety 332 in the cis configuration. Optionally, when the ethers 334 are brought together, a portion of the complexed ions may be released for example due to repulsive forces between the cations. For example, about half the cations may be released.

In some embodiments, a crown ether 334 may be based on benzo-15-5 crowns and/or benzo-18-6 crowns that may be symmetrical or non-symmetrical. Alternatively or additionally, a crown ether 334 may be based on Bis benzo-15-5-crowns, bis benzo-18-6-crowns and mixed benzo-15-5-crown-benzo-18-6 crown. Any or all of the above crowns and/or any combination thereof may be connected via a diazo moiety 332. Alternatively or additionally, a different moiety may be used to connect two or more complexing agents and/or ion trapping moieties. In some embodiments, covalent bonds between functionalized magnetic nanoparticles and functionalized crown ether may be formed via azide, amine, carboxylic acid, alcohol, phenol and others on the magnetic side, and alkyne, carboxylic acid, amine and others on the crown side. Connection of the magnetic nanoparticle to the complexing agent bin includes a triazole, amide, ester, a substituted amide, various covalent bonds and many other connections.

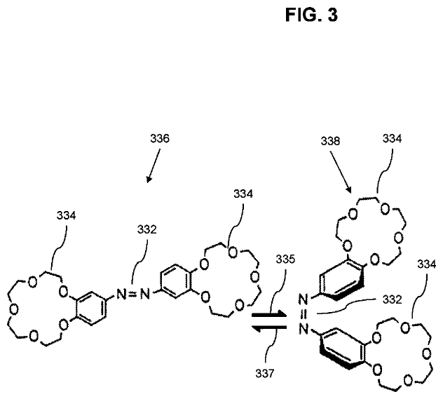

FIG. 4A is a schematic view of crown ethers 334 in a far from one to another in a catching configuration 436 holding two cations 440 in accordance with an embodiment of the current invention.

FIG. 4B is a schematic view of crown ethers 334 close one to another in a releasing configuration 438 wherein electrostatic repulsion releases a portion of caught ions 440 in accordance with an embodiment of the current invention. For example, when the crown ethers 334 are distanced one from the other, each crown ether 334 may trap a similar ion (e.g., a cation 340 (e.g., Na⁺) and/or anion (e.g., Cl⁻)); but when the crown ethers 334 are brought close to one another, the similarly charged ions 340 may repel each other causing, for example, about half of the ions 340 to be released back into solution. For example, the catching process may be in the trans mode, when complexing agents (for example crown ethers 334) catch each one ion. A release process occurs, for example, under UV and/or visible light and/or white light and/or sunlight the complexing agents move close one to another, and electrostatic repulsion releases half of the ions.

In some embodiments, complexing agents include molecules and/or moieties that are able to form coordinative bonds with ions. For example, crown ether type moieties may complex alkali metals cations. Crown ethers 334 may include, for example, heterocyclic chemical compounds that consist of a ring containing several ether groups. Common crown ethers include oligomers of ethylene oxide, the repeating unit being ethyleneoxy, i.e., —CH₂CH₂O—. Important members of this series include the tetramer (n=4), the pentamer (n=5), and the hexamer (n=6). Benzo-crown ethers include heterocyclic chemical compounds that are fused to the benzene ring. Benzyl and phenyl aza-crowns include moieties where benzylic and phenylic groups are attached to one or more Nitrogens of the crown.

The term “Crown” refers to the resemblance between the structure of a crown ether bound to a cation, and a crown sitting on a head. The first number in a crown ether's name refers to the number of atoms in the cycle, and the second number refers to the number of those atoms that are oxygen. Although the term crown ether has a specific meaning it is applied herein to a much broader collection of molecules than just the oligomers of ethylene oxide such as the nitrogen containing ligands known as cryptands as well as mixed oxygen-nitrogen compounds, e.g., aza-crowns.

In some embodiments, crown ethers strongly bind certain cations, forming complexes. In some embodiments, a crown ether may have high selectivity to particular ions based on ring size. Optionally, the oxygen atoms coordinate with a cation located at the center of the ring, whereas the exterior of the ring is hydrophobic. A characteristic of a crown ether of some embodiments of the current invention is the complexation of the ether Oxygens (or Nitrogens) with various ionic species. For example, once a charged ionic species is bound, the crown compound is then termed “host-guest” chemistry. The crown ether may act as the “host” taking ionic species as its “guest.” In some embodiments, the crown compound locks guest atoms in a solution and wraps around it. The size of the polyether influences the affinity of the crown ether for various cations. For example, some 18-crown-6 ethers have a high affinity for a potassium cation, some 15-crown-5 ethers have an affinity for sodium cations, and some 12-crown-4 ethers have an affinity for lithium.

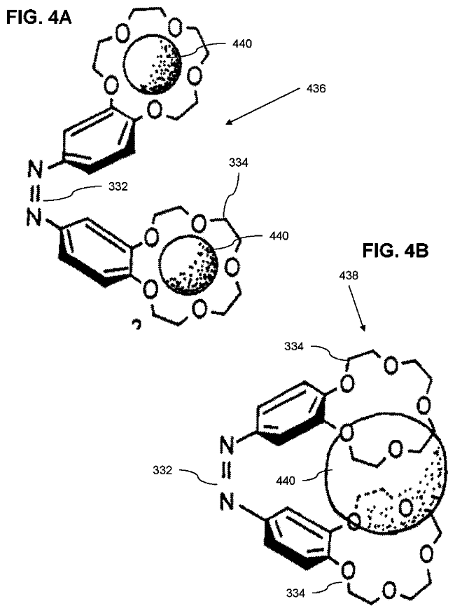

FIG. 5 is a schematic view of a complexing agent 538 with an alkyne-modified bis-benzocrown detached from a magnetic nanoparticle in accordance with an embodiment of the current invention.

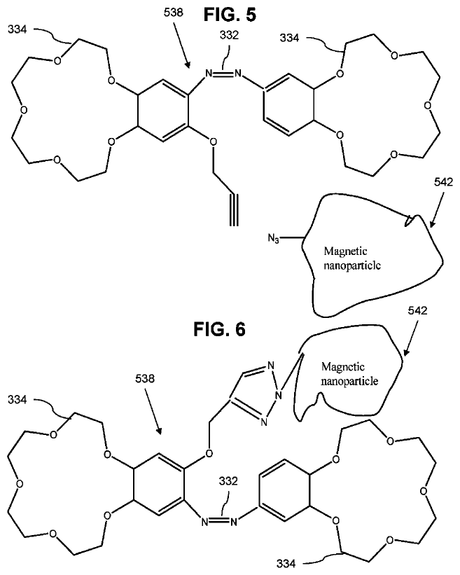

FIG. 6 is a schematic view of an alkyne-modified bis-benzocrown attached at a condition of alkyne-azide Huisgen bipolar 1,3-cycloaddition to a magnetic nanoparticle in accordance with an embodiment of the current invention. The nanoparticles can range in diameter, between about 1 nm and about 1000 nm, preferably 1 to 50 nm most preferably 1 to 20 nm. Optionally, a covalent bond between functionalized magnetic nanoparticles and functionalized crown ether is formed via carboxyl to amine coupling from both sides. The resulting particle/nanoparticle is a magnetic active complexing unit in accordance with an embodiment of the current invention. Connection of the magnetic nanoparticle to the complexing agent may include a triazole, amide, ester, a substituted amide, various covalent bonds and many other connections.

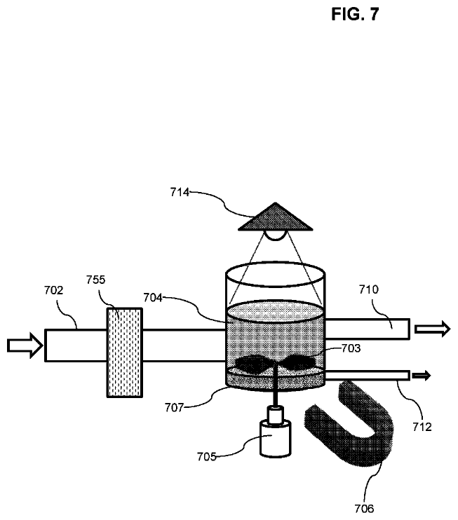

FIG. 7 is a schematic illustration of a scalable desalination system in accordance with an embodiment of the current invention. In some embodiments, the system includes an inlet 702 in fluid communication with a reactor 704. For example, reactor 704 may include a tank stirred by an impeller 703 driven by a motor 705 for raw contaminated water (e.g., sea water). Optionally a pretreatment module 755 which may include for example a sand filter and/or a carbon filter and/or a porous filter and/or a mesh filter and/or a ceramic filter and/or a chemical treatment.

In some embodiments, the system includes a particle concentrator 706. Optionally, the concentrator is activated to collect the complexing particles and/or a contaminant complexed thereto to an impound area 707 (for example near the bottom of the reactor 704) which is in the embodiment of FIG. 7 is also a release area. For example, the concentrator 706 may include a magnet. For example, the magnet may include an electromagnet that is activated and/or deactivated by switching on or off power to the magnet. Alternatively or additionally, the concentrator may include a permanent magnet (e.g., a rare earth magnet) which is activated/deactivated by moving the magnet near and/or away from the impound area 707.

Alternatively or additionally, the magnet may remain active permanently, and/or the contaminated water may be circulated through the impound area to react with the particles (for example by strong mixing with a mixing module [e.g., impeller 703]). Once the particles and/or contaminants are concentrated in the impound area, clean water may be drained off through a clean water outlet 710. Optionally, suitable sensors measure the salt level, and/or a controller monitors the sensors, for example, to verify that the water is clean. Optionally, the controller will control various actuators (e.g., pumps, valves and/or other components of the system to achieve desired water quality and/or desired water quantity and/or reduce costs and/or increase efficiency. For example, the clean water outlet 710 may drain fluid from reactor 704 at an area separated (e.g., far away from and/or isolated by a barrier) from the impound area 707.

In some embodiments, a release module 714 causes the particles to release a portion of the contaminant complexed to them. For example, the release module 714 may include an energy source (e.g., a UV radiation source) that radiates energy to the particles and/or the impound area 707. Optionally, after the contaminant has been released, the concentrated contaminant is drained via waste outlet 712. For example, waste outlet 712 may be in fluid communication with the impound area and/or drain fluid from the impound area. Draining fluid from the impound area is optionally performed while the particles are retained in reactor 704, for example via the concentrator 706 retaining the particles. For example, the particles may be retained by a magnetic field, and/or the particles may be retained in the impound area.

In some embodiments, the complexing particles are optionally added to the reactor continuously depending on the volume of water that needs to be treated and/or according to the desired quality (e.g., salinity) of the output water. After the reactor is filled with water, the mixer will mix while an exit valve is closed. Once the reaction has equilibrated, a magnetic field will optionally be applied, preferably using a permanent magnet at the bottom of the reactor with an open exit valve from the water tank. The nanoparticles will be collected at the bottom of the water tank. The water flows to the next step by gravitation or with low pressure pumps.

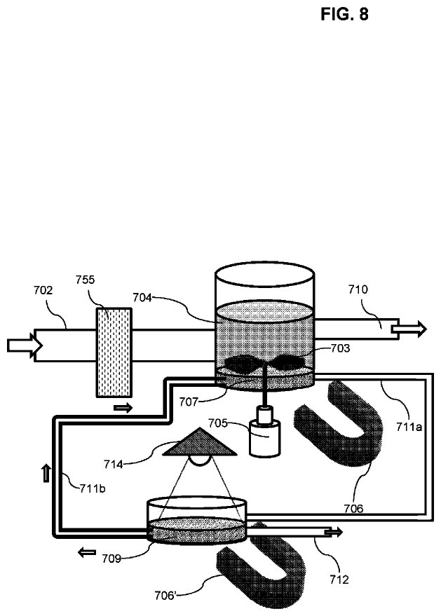

FIG. 8 is a schematic illustration of a scalable desalination system with active particle return in accordance with an embodiment of the current invention.

In some embodiments, recirculation line 711a is in fluid communication with impound area 707 and/or release area 709. While particles and/or complex contaminants are concentrated in impound area 707, clean water is removed from outlet 710. Optionally, some or all of the remaining fluid and/or the particles and/or the complexed contaminant are drained through the recirculation line 711a to a release area 709. In some embodiments, a release module 714 causes the particles to release a portion of the contaminant complexed to them. For example, the release module 714 may include an energy source (e.g., a UV radiation source) that radiates energy to the particles and/or the release area 709. Optionally, after the contaminant has been released, the concentrated contaminant is drained via a waste outlet 712. For example, waste outlet 712 may be in fluid communication with the impound area and/or drain fluid from the impound area. Draining fluid from the impound area is optionally performed while the particles are retained in the reactor 704, for example via a concentrator 706′ retraining the particles in the impound area (optionally concentrator 706′ may be the same as concentrator 706. For example, the impound area and/or the release area 709 may be close enough to each other to both be affected by (e.g., be within an effective portion of the magnetic field of) one concentrator 706. Alternatively, concentrator 706 may move between a position that retains particles in impound area 707 and a position that retains particles in the release area 709.

In some embodiments, the complexing particles are optionally added to the reactor continuously depending on the volume of water that needs to be treated. After the reactor is filled with water, the mixer will mix while an exit valve is closed. Once the reaction has equilibrated, a magnetic field will optionally be applied, preferably using a permanent magnet at the bottom of the reactor with an open exit valve from the water tank. Optionally, while fluid is exiting the tank in return line 711a concentrator 706 is deactivated allowing the particles to flow to the release area 709. Optionally, when the concentrated contaminant is drained through the waste outlet 712 while concentrator 706′ holds the particles in the release zone. Optionally, after the release of the complexed particles, returned to the reactor, for example, via a recycle line 711b.

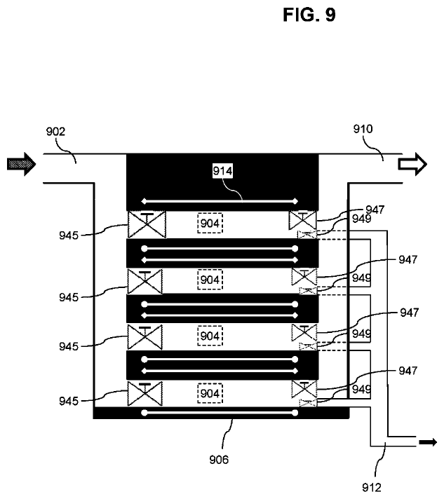

FIG. 9 is a schematic illustration of a scalable desalination system in accordance with an embodiment of the current invention. In some embodiments, contaminated fluid enters an inlet 902 and is directed through a series of valves 945 to a series of parallel reactors 904. Each reactor 904 including a concentrator 906 and/or a release module 914. For example, incoming contaminated fluid is mixed with complexing magnetic particles which complex the contaminant. The incoming fluid is channeled and divided through valves 945 to parallel reactors 904 where the particles and the complexed contaminant are collected by the concentrators into the impound area of reactors 904. Clean water is discharged from each reactor through an outlet valve 947 (optionally in communication with reactor 904 but isolated from the impound area) to an outlet 910. Optionally, after discharging the clean water, a series of waste release valves 949 are opened connecting each impound zone to a waste outlet manifold 912 and/or discharging concentrated contaminant. Optionally during discharge, the concentrator remains active, holding the particles in the reactor for the next batch of water. In some embodiments, clean water is an outlet from the system for use. Alternatively or additionally, the clean outlet water may be recirculated to the inlet 902 for further purification.

Details of the concentrators 906, release modules 914 and/or particles may be similar to other embodiments described herein.

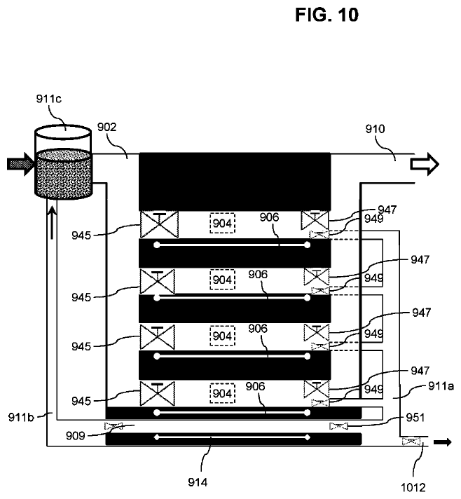

FIG. 10 is a schematic illustration of a scalable desalination system with active particle return in accordance with an embodiment of the current invention. In some embodiments, instead of releasing contaminant from the complexing particles in the series of reactors 904, the particles with the complexed contaminant are channeled by valves 949 to a recirculation channel 911a to a release area 909 wherein a release module 914 releases the contaminant. Optionally while the particles are held in the release area by a concentrator 906, the concentrated waste is released through a waster outlet valve 951 to outlet 1012. Optionally the particles are then recycled to the incoming fluid through a recycling line 911b and/or a mixing tank 911c and/or back to the reactors 904.

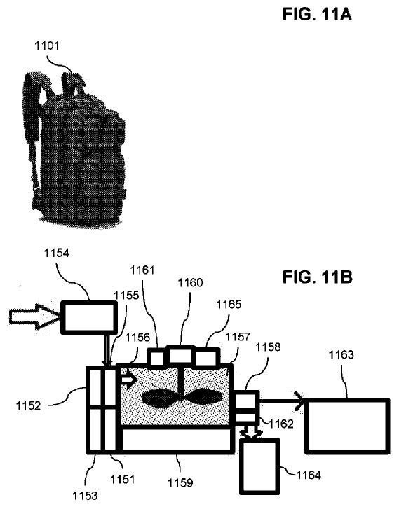

FIG. 11A is an image of a backpack water purification system in accordance with an embodiment of the current invention.

FIG. 11B is a schematic illustration of a backpack water purification system in accordance with an embodiment of the current invention.

In some embodiments, a small desalination system may fit into a backpack 1101 and/or be light enough to be carried by a person. For example, the system may weigh between 5 to 20 kg and/or between 1 to 5 kg and/or between 20 to 40 kg. For example, the total volume of the system may range between 30 to 50 liters.

In some embodiments, the system may include a power supply unit (PSU) 1151. Optionally PSU 1151 includes a power DC to DC converter module. This unit optionally further includes a rechargeable battery 1153 (and/or another portable power supply that is optionally located inside the backpack). For example, the power converter may split the power giving respective levels of voltage and/or current to each of the other system modules. In some embodiments, the system may not include battery 1153 and/or may be configured to use power from an external power supply (e.g., an external battery, a generator, a solar power source and/or a domestic power grid). Optionally, a solar converter may be included and/or may be used to recharge battery 1153.

In some embodiments, a Command and Control Unit (CCU) 1152 performs command & control. For example, CCU 1152 may include a processor that controls various other modules, and/or CCU 1152 may include sensors for example for verifying that system modules are working properly. CCU 1152 may output information for example on a local screen or smartphone, for example via RF communication like Wi-Fi/Bluetooth.

In some embodiments, an inlet module 1154 includes for example a tube that connects the system to a contaminated water source (e.g., sea water contaminated with salt). Alternatively or additionally, the inlet includes a water pump. Optionally the pump is operationally connected to PSU 1151 to get the power and/or to CCU 1152 for control.

In some embodiments, the system includes a pretreatment module 1155. For example, pretreatment modules 1155 may include a filter (for example a sand filter and/or a carbon filter and/or a porous filter and/or a mesh filter and/or a ceramic filter).

In some embodiments, a system may include a water valve 1156 in order to control the input water. For example, valve 1156 may be located between pretreatment module 1155 and a main reactor. For example, the main reactor may include a tank 1157 and/or a mixing unit 1160. Optionally valve 1156 is operationally connected to PSU 1151 to get the power and/or to CCU 1152 for control.

In some embodiments, the system includes an output valve 1158 that controls water movement from the main reactor to a fresh water tank 1163. Optionally valve 1158 is operationally connected to PSU 1151 to get the power and/or to CCU 1152 for control.

In some embodiments, a system includes an Electro Magnet 1159. Optionally magnet 1159 is operationally connected to PSU 1151 to get the power and/or to CCU 1152 for control.

In some embodiments, the system includes a mixing unit 1160. For example, the mixing unit may include a motor connected to a suitable water propeller which causes circulation inside the main reactor 1157. Optionally mixing unit 1160 is operationally connected to PSU 1151 to get the power and/or to CCU 1152 for control.

In some embodiments a system includes an energy source 1161, for example, a UV light. Optionally energy source 1161 is operationally connected to PSU 1151 to get the power and/or to CCU 1152 for control.

In some embodiments, reactor 1157 is filled with contaminated water and/or mixed with active particles which complex with the contaminant (e.g., salt). Optionally, the contaminant and/or the particles are then separated from the water, for example, by activating magnet 1159 to draw the particles with the contaminant to the bottom of reactor 1157. Optionally clean water can then be drained from a higher portion of reactor 1157 (e.g., using output valve 1158). The clean water may be output and/or returned to the reactor for further purification. Optionally, energy source 1161 is activated after the fresh water has been drained from reactor 1157. For example, the bottom of the main reactor 1157 contains the particles which hold the contaminant. At this stage, the UV light optionally directs light to the nanoparticles causing them to release contaminants. After this stage, the remaining concentrated contaminated water is optionally moved out via gravitation and/or a pump 1162 and/or valve while magnet 1159 continues to hold the particles.

In some embodiments after contaminant release from the particles, waste (for example concentrated contaminant with some water) is directed to a waste outlet 1164. For example, waste outlet 1164 may include a waste tank and/or a tube back to the contaminated water source and/or to an external dumping ground (e.g., an output tube that drains to the ground and/or a domestic drain).

In some embodiments, a system may include sensors 1165. For example, sensors 1165 may measure the volume and/or quality of water in reactor 1157 and/or fresh water tank 1163 and/or waste tank 1164. For example, sensors may measure flow between components and/or power consumption and/or battery 1153 status and/or temperature of various components. Optionally sensors 1165 are operationally connected to PSU 1151 to get the power and/or to CCU 1152 for control and/or to report data.

In some embodiments, a backpack desalination system may produce between 1 to 10 liters and/or between 10 to 50 liters and/or between 50 to 200 liters per day. For example, a bigger heavier pack may produce more water. Optionally, the backpack may include storage of clean water, for example between 1 to 4 liters and/or between 4 to 15 liters. Optionally, a backpack may include a rechargeable battery. For example, the battery may include power for between 1 hour to 12 hours and/or between 12 hours to 48 hours and/or between 48 hours to 200 hours of operation. Alternatively or additionally, the backpack may include one or more mirrors and/or lenses to direct sunlight as a source of light for salt release, for example, when a UV light source is not available.

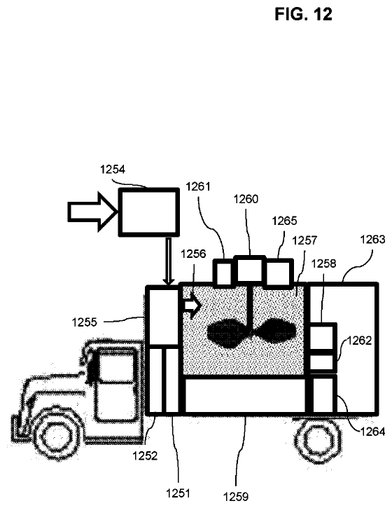

FIG. 12 is a schematic illustration of a vehicle transportable water purification system in accordance with an embodiment of the current invention. For example, the transportable system may be connected to a dedicated vehicle (e.g., an SUV and/or a small truck and/or a large truck and/or a train car) and/or a transportable package (e.g., a system on a pallet for easy transport in trucks and/or by air and/or a standard cargo container for easy transport by air, sea and/or truck and/or rail).

In some embodiments, the system may include a power supply unit PSU 1251. Optionally PSU 1251 includes a power DC to DC converter module. This unit optionally connects to a power supply of the vehicle. For example, the power converter may split the power giving respective levels of voltage and/or current to each of the other system modules. In some embodiments, the system may be configured to use power from an external power supply (e.g., an external battery, a generator, a solar power source and/or a domestic power grid).

In some embodiments, a Command and Control Unit CCU 1252 performs command & control. For example, CCU 1252 may include a processor that controls various other modules, and/or CCU 1252 may include sensors for example for verifying that system modules are working properly. The CCU 1252 may output information for example on a local screen or smartphone, for example via RF communication like Wi-Fi/Bluetooth.

In some embodiments, an inlet module 1254 includes for example a tube that connects the system to a contaminated water source (e.g., sea water contaminated with salt). Alternatively or additionally, the inlet includes a water pump. Optionally the pump is operationally connected to PSU 1251 to get the power and/or to CCU 1252 for control.

In some embodiments, the system includes a pretreatment module 1255. For example, pretreatment modules 1255 may include a filter (for example a sand filter and/or a carbon filter and/or a porous filter and/or a mesh filter and/or a ceramic filter.

In some embodiments, a system may include a water valve 1256 in order to control the input water. For example, valve 1256 may be located between pretreatment module 1255 and a main reactor. For example, the main reactor may include a tank 1257 and/or a mixing unit 1260. Optionally valve 1256 is operationally connected to PSU 1251 to get the power and/or to CCU 1252 for control.

In some embodiments, the system includes an output valve 1258 that controls water movement from the main reactor to a fresh water tank 1263. Optionally valve 1258 is operationally connected to PSU 1251 to get the power and/or to CCU 1252 for control.

In some embodiments, a system includes an Electro Magnet 1259. Optionally magnet 1259 is operationally connected to PSU 1251 to get the power and/or to CCU 1252 for control.

In some embodiments, the system includes a mixing unit 1260. For example, the mixing unit may include a motor connected to a suitable water propeller which causes circulation inside the main reactor 1257. Optionally mixing unit 1260 is operationally connected to PSU 1251 to get the power and/or to CCU 1252 for control.

In some embodiments a system includes an energy source 1261, for example, a UV light. Optionally energy source 1261 is operationally connected to PSU 1251 to get the power and/or to CCU 1252 for control.

In some embodiments, reactor 1257 is filled with contaminated water and/or mixed with active particles which complex with the contaminant (e.g., salt). Optionally, the contaminant and/or the particles are then separated from the water, for example, by activating magnet 1259 to draw the particles with the contaminant to the bottom of reactor 1257. Optionally clean water can then be drained from a higher portion of reactor 1257 (e.g., using output valve 1258). The clean water may be output and/or returned to the reactor for further purification. Optionally, energy source 1261 (for example including a light source and/or a UV light source) is activated after the fresh water has been drained from reactor 1257. For example, the bottom of the main reactor 1257 contains the particles which hold the contaminant. At this stage, the UV light optionally directs light to the nanoparticles causing them to release the contaminant. After this stage, the remaining concentrated contaminated water is optionally moved out to waste outlet 1264 via gravitation and/or a pump 1262 and/or valve while magnet 1259 continues to hold the particles.

In some embodiments after contaminant release from the particles, waste (for example concentrated contaminant with some water) is directed to a waste outlet 1264. For example, waste outlet 1264 may include a waste tank and/or a tube back to the contaminated water source and/or to an external dumping ground (e.g., an output tube that drains to the ground and/or a domestic drain).

In some embodiments, a system may include sensors 1265. For example, sensors 1265 may measure the volume and/or quality of water in reactor 1257 and/or fresh water tank 1263 and/or waste tank 1264. For example, sensors may measure flow between components and/or power consumption and/or temperature of various components. Optionally sensors 1265 are operationally connected to PSU 1251 to get the power and/or to CCU 1252 for control and/or to report data.

In some embodiments, a system mounted on a car and/or an SUV and/or a van and/or a light truck and/or a truck may produce between 100 to 1,000 liters and/or between 1,000 to 10,000 liters and/or between 10,000 to 100,000 liters of water per day. For example, the car and/or SUV and/or van and/or light truck may store clean water in a quantity of between 100 to 1,000 liters and/or between 1,000 to 10,000 liters.

For example, the truck may store clean water in a quantity of between 100 to 10,000 liters and/or between 10,000 to 80,000 liters.

In some embodiments, the car and/or SUV and/or van and/or light truck and/or truck includes a rechargeable battery which may support the operation of the water purifying system for between 1 hour to 1 day and/or between one day to 1 week.

In some embodiments, the car and/or SUV and/or van and/or light truck and/or truck includes fuel and/or an alternator which may support the operation of the water purifying system for between 1 hour to 1 day and/or between one day to 1 week and/or between 1 week to 1 month and/or between 1 month to 1 year. For example, the car and/or SUV and/or van and/or light truck and/or truck may be configured to purify between 1 to 40 and/or between 40 to 200 and/or between 200 to 1,000 liters per hour and/or between 1,000 to 10,000 liters per hour. For example, the car and/or SUV and/or van and/or light truck and/or truck may be configured to store between 1 to 40 and/or between 40 to 200 and/or between 200 to 1,000 and/or 1,000 to 10,000 and/or 10,000 to 80,000 liters of clean water.

In some embodiments, a suitable truck mounted purification system and/or a container mounted system may produce between 100 to 1,000 liters and/or between 1,000 to 10,000 liters and/or between 10,000 to 100,000 gallons of water per day. In some embodiments, the suitable truck mounted purification system and/or container mounted system may store between 100 to 1,000 liters and/or between 1,000 to 10,000 liters and/or between 10,000 to 100,000 liters of water. In some embodiments, the suitable truck mounted purification system and/or container mounted system includes a rechargeable battery which may support the operation of the water purifying system for between 1 hour to 1 day and/or between one day to 1 week. In some embodiments, the suitable truck mounted purification system and/or container mounted system includes fuel and/or an alternator and/or generator which may support the operation of the water purifying system for between 1 hour to 1 day and/or between one day to 1 week and/or between 1 week to 1 month and/or between 1 month to 1 year. For example, the suitable truck mounted purification system and/or container mounted system may be configured to purify between 10 to 400 and/or between 400 to 2,000 and/or between 2,000 to 50,000 liters per hour.

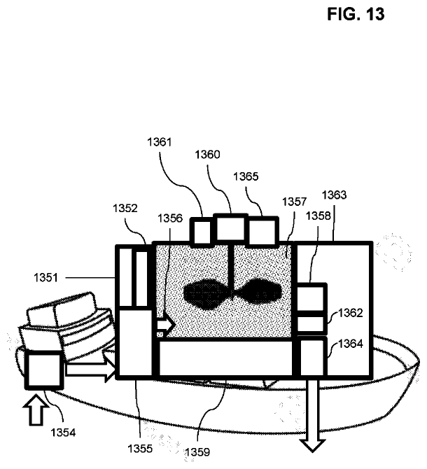

FIG. 13 is a schematic illustration of a ship transportable water purification system in accordance with an embodiment of the current invention.

In some embodiments, the system may include a power supply unit PSU 1351. Optionally PSU 1351 includes a power DC to DC converter module. This unit optionally connects to a power supply of the ship. For example, the power converter may split the power giving respective levels of voltage and/or current to each of the other system modules. In some embodiments, the system may be configured to use power from an external power supply (e.g., an external battery, a generator, a solar power source).

In some embodiments, a Command and Control Unit CCU 1352 performs command & control. For example, CCU 1352 may include a processor that controls various other modules, and/or CCU 1352 may include sensors for example for verifying that system modules are working properly. CCU 1352 may output information for example on a local screen or smartphone, for example via RF communication like Wi-Fi/Bluetooth.

In some embodiments, an inlet module 1354 includes for example a tube that connects the system to a contaminated water source (e.g., sea water contaminated with salt). Alternatively or additionally, the inlet includes a water pump. Optionally the pump is operationally connected to PSU 1351 to get the power and/or to CCU 1352 for control.

In some embodiments, the system includes a pretreatment module 1355. For example, the pretreatment modules 1355 may include a filter (for example a sand filter and/or a carbon filter and/or a porous filter and/or a mesh filter and/or a ceramic filter.

In some embodiments, a system may include a water valve 1356 in order to control the input water. For example, valve 1356 may be located between pretreatment module 1355 and a main reactor. For example, the main reactor may include a tank 1357 and/or a mixing unit 1360. Optionally valve 1356 is operationally connected to PSU 1351 to get the power and/or to CCU 1352 for control.

In some embodiments, the system includes an output valve 1358 that controls water movement from the main reactor to a fresh water tank 1363. Optionally valve 1358 is operationally connected to PSU 1351 to get the power and/or to CCU 1352 for control.

In some embodiments, a system includes an Electro Magnet 1359. Optionally magnet 1359 is operationally connected to PSU 1351 to get the power and/or to CCU 1352 for control.

In some embodiments, the system includes a mixing unit 1360. For example, the mixing unit may include a motor connected to a suitable water propeller which causes circulation inside the main reactor 1357. Optionally mixing unit 1360 is operationally connected to PSU 1351 to get the power and/or to CCU 1352 for control.

In some embodiments a system includes an energy source 1361 (e.g., a source of light and/or UV light). Optionally energy source 1361 is operationally connected to PSU 1351 to get the power and/or to CCU 1352 for control.

In some embodiments, reactor 1357 is filled with contaminated water and/or mixed with active particles which complex with the contaminant (e.g., salt). Optionally, the contaminant and/or the particles are then separated from the water, for example, by activating magnet 1359 to draw the particles with the contaminant to the bottom of reactor 1357. Optionally clean water can then be drained from a higher portion of reactor 1357 (e.g., using output valve 1358). The clean water may be output and/or returned to the reactor for further purification. Optionally, energy source 1361 is activated after the fresh water has been drained from the reactor 1357.

For example, the bottom of the main reactor 1357 contains the particles which hold the contaminant. At this stage, the UV light optionally directs light to the nanoparticles causing them to release the contaminant. After this stage the remaining concentrated contaminated water is optionally moved out, for example, to waste outlet 1364, via gravitation and/or a pump 1362 and/or valve while magnet 1359 continues to hold the particles.

In some embodiments after contaminant release from the particles, waste (for example concentrated contaminant with some water) is directed to a waste outlet 1364. For example, waste outlet 1364 may include a waste tank and/or a tube back to the contaminated water source and/or to an external dumping ground (e.g., an output tube that drains to the ground and/or a domestic drain).

In some embodiments, a system may include sensors 1365. For example, sensors 1365 may measure the volume and/or quality of water in reactor 1357 and/or fresh water tank 1363 and/or waste tank 1364. For example, sensors may measure flow between components and/or power consumption and/or temperature of various components. Optionally sensors 1365 are operationally connected to PSU 1351 to get the power and/or to CCU 1352 for control and/or to report data.

The preparation of the surface-modified magnetic nanoparticles having a crown ether covalently bonded on its surface is now described in detail.

### Synthesis of Magnetic Nanoparticles

Magnetic nanoparticles, e.g., iron oxide Fe₃O₄, are usually obtained by co-precipitation from a solution of ferrous and ferric salts, e.g., chloride salts, with molar proportion Fe²⁺:Fe³⁺ in the range of 1:3 to 3:1, upon addition of a base such as ammonium hydroxide, usually at elevated temperature. The particles thus formed have reactive hydroxyl groups attached to their surface, which serve for further functionalization, i.e., incorporation of a variety of functional groups.

One approach is to react the aforementioned Fe₃O₄ nanoparticles, having reactive hydroxyl groups on their surface, with amino-substituted trialoxysilane, for example, H₂N(CH₂)₃Si(OC₂H₅)₃ (3-Triethoxysilylpropylamine; APTES):

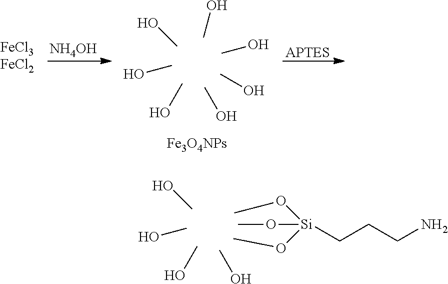

The reaction with APTES can be performed in different organic solvents, e.g., alcohols like MeOH, EtOH, IPA, t-BuOH; benzene and alkyl-substituted benzene like toluene, THF, water and aqueous mixtures of THF or alcohol, etc., and over a wide temperature range from RT up to reflux.

Improved loading of amine functional group onto the surface can be achieved if the Fe₃O₄ nanoparticles are first reacted with tetraethoxysilane (TEOS), to create silanol groups on the surface of the nanoparticles, followed by a reaction with APTES or the like. The description which follows applies to both the single step APTES and two-step TEOS/APTES variants. The reaction product of the two-step variant is represented by the following structure where dashed line indicates the silanol groups created by TEOS or similar reagents:

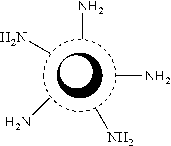

The so-formed amino functionalized nanoparticle may be subsequently modified, for example, through the reactions illustrated below, to introduce other reactive groups onto the surface:

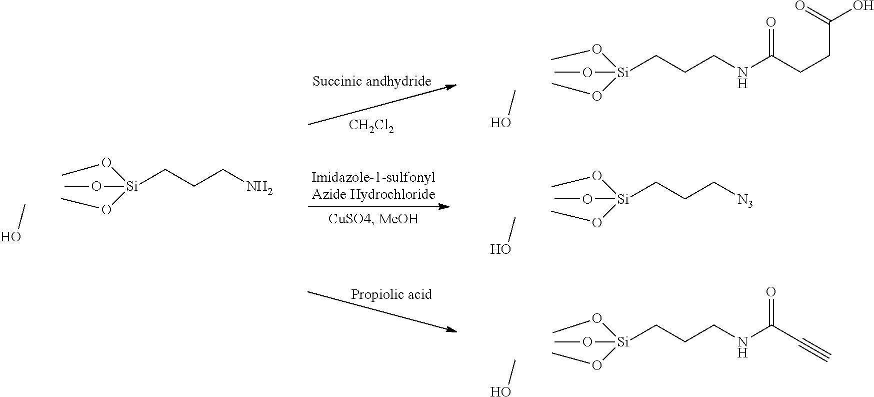

Amines are known to react with succinic anhydride, which in reactions near room temperature, undergoes a ring opening amidation reaction to form succinamic acid (succinic acid-amine). The reaction was performed in a broad range of conditions with different organic solvents known from the art, e.g., ethyl acetate, DCM, chloroform, etc., with or without the presence of AcOH. The temperature can be from RT to reflux.

The synthesis of azides from the corresponding amines also is known from the art and can be accomplished with any type of “diazo donor”, e.g., imidazole-1-sulfonyl azide hydrochloride in the presence of CuSO₄ in MeOH.

The reaction of propiolic acid with primary amine can be made in mild conditions with a variety of organic solvents, e.g., THF, DMF, 1,4-Dioxane, or in water, in the presence of coupling agents.

Surface functionalized magnetic nanoparticles are also commercially available, e.g., from Turbobeads LLC (Switzerland), with average particle diameter <100 nm, bearing primary amine groups, carboxylic acid groups and azide groups (e.g., —C₆H₅—CH₂—NH₂; —C₆H₅—CH₂—COOH and —C₆H₅—CH₂—N₃).

Preferred surface functionalized magnetic nanoparticles, which can react with crown ethers to form surface modified magnetic nanoparticles having a crown ether covalently bonded on its surface, include:
—NH₂ surface functionalized magnetic nanoparticles;
—COOH surface functionalized magnetic nanoparticles;
—N₃ surface functionalized magnetic nanoparticles;
—C≡CH surface functionalized magnetic nanoparticles;
—OH surface functionalized magnetic nanoparticles;
—SH surface functionalized magnetic nanoparticles;
—C═C— surface functionalized magnetic nanoparticles.

In general, the loading levels of different functional groups (amine, acid, azide, etc.) on the magnetic nanomaterial vary depending on the nature of the functional group and preparation methods and is roughly in the range from 0.1 mmol/g to 100 mmol/g, e.g., from 0.1 to 10 mmol/g. For example, amine and acid loading levels are in the range from 1 mmol/g to 100 mmol/g (e.g., 1 to 10 mmol/g), and azide loading level is from 0.1 mmol/g to 1 mmol/g.

### Syntheses of Crown Ether

Crown ethers to be covalently bonded to the surface functionalized magnetic nanoparticles are represented by Formula 1:

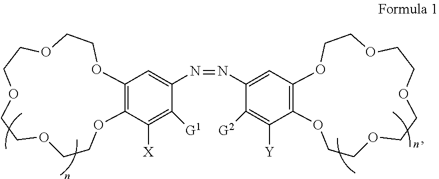

wherein, n=0, 1, 2;
G¹, G², X, Y are independently selected from H, —OH, —O-Metal, —CN, —R¹, —C(O)H, —NH₂, —NHR², —N₃, —SH, —O—R³, —COOH, —COOR², —R⁴COOH, —R⁴COOR², —O(SO₂)—R⁵;
R¹ is optionally substituted alkyl (e.g., hydroxy-substituted alkyl, oxo-substituted alkyl and halogenated alkyl), alkenyl or alkynyl;
R² is alkyl, cycloalkyl (optionally with hetero atoms), aryl, and heteroaryl;
R³ is substituted alkyl (e.g., with —COOH, such as —CH₂COOH), alkynyl, alkenyl;
R⁴ is linear or branched alkylene, oxo-substituted linear or branched alkylene; hydroxy-substituted linear or branched alkylene, linear or branched alkenylene;
R³ is alkyl, halogenated alkyl, aryl and heteroaryl; wherein at least one of G¹, G², X, Y is other than hydrogen or unsubstituted alkyl.

As used herein, alkyl is preferably linear or branched C1-C10 (e.g., C1-C5) alkyl;
Alkenyl is preferably linear or branched (e.g., C2-C5) alkenyl;
Alkynyl is preferably linear or branched (e.g., C2-C5) alkynyl;
alkylene is preferably C1-C10 alkylene (e.g., C1-C5) for example, —(CH₂)ₚ—, wherein p is from 1 to 10, e.g., 1-5; the alkylene may be branched);
alkenylene is preferably C2-C10 alkenylene, that is, containing a carbon-carbon double bond in the chain, and may be linear or branched;
aryl refers to one or more (optionally substituted) aromatic rings (e.g., alkyl-substituted benzene ring), and to aromatic rings in which the connectivity is through a non-ring atom, such as Ar—(CH₂)ₚ—, in which p is from 0 to 5, (e.g., p=1, meaning that a benzylic carbon is covalently bonded to e.g., the nitrogen in the —NHR² group attached to the benzo crown ether of Formula 1).
heteroaryl indicates the presence of oxygen, sulfur and/or nitrogen atoms in the aromatic ring.

By “optionally substituted” is meant to include substitution with alkyl, halogen, hydroxy, alkoxy, nitrile (—CN) and aryl.

Specific Examples include:

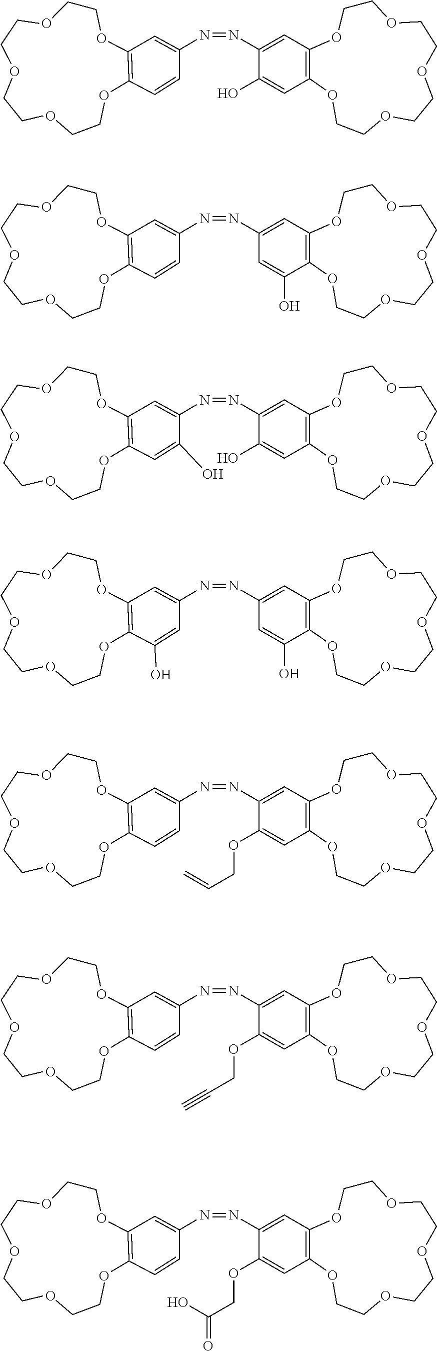

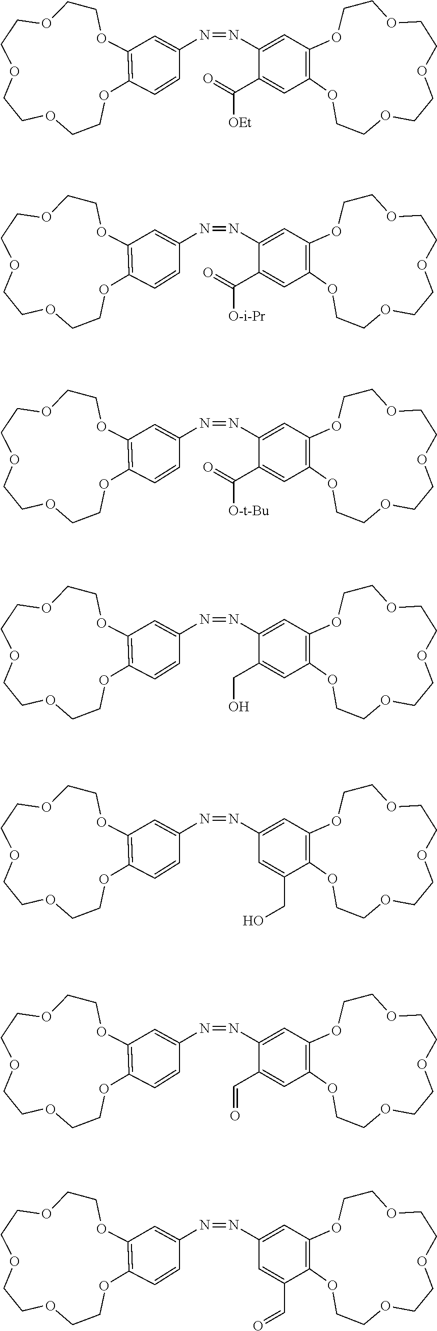

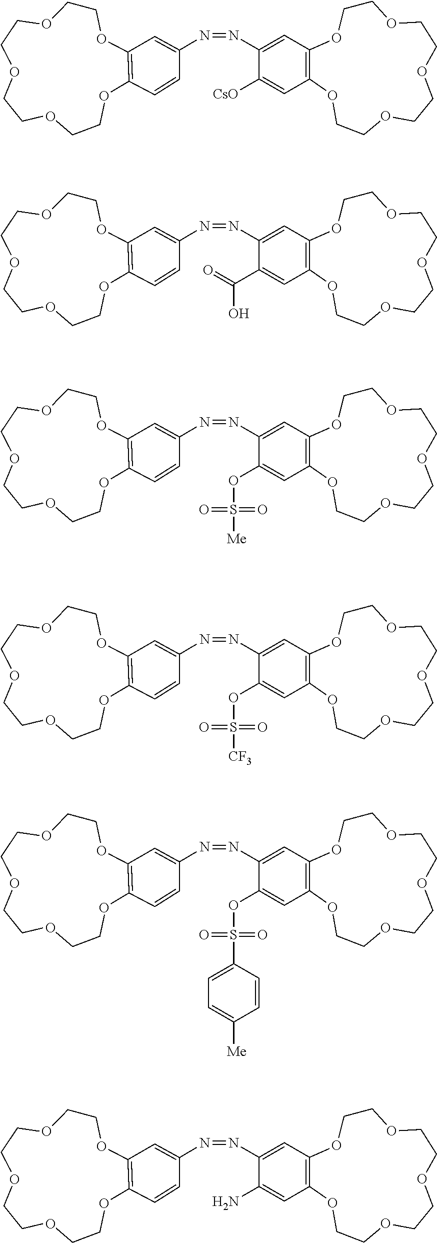

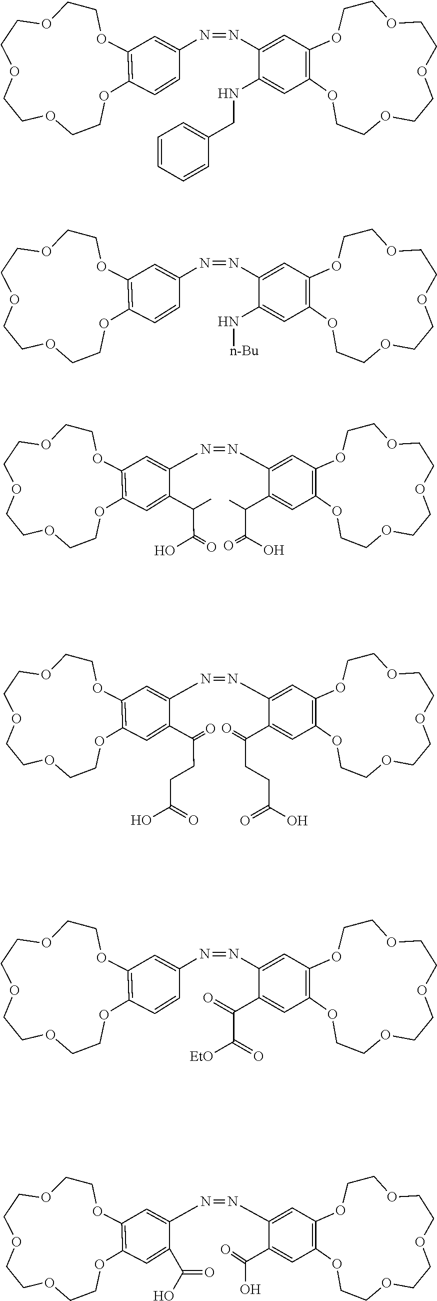

The crown ethers are accessible through several reaction pathways.

The first reaction pathway, which is shown in Scheme 1A, is based on the preparation of bisazocrownethers via crown ether diazonium salt.

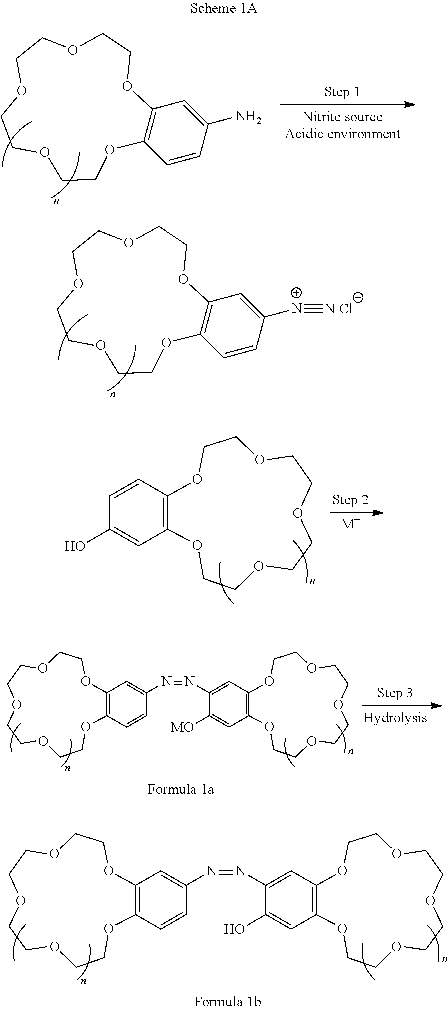

The process which corresponds to Scheme 1A comprises combining amino-substituted benzo crown ether (e.g., benzo-15-crown-5 or benzo-18-crown-6, with amine group attached to carbon benzene ring:

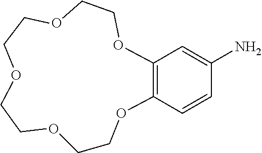 [SMILES: Nc1ccc2c(c1)OCCOCCOCCOCCO2]

with nitrite source in a strong acid (e.g., concentrated hydrochloric acid-10M) to form the corresponding diazonium salt:

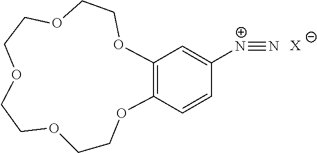

wherein X⁻ is the counter anion supplied by the acid
(e.g.,

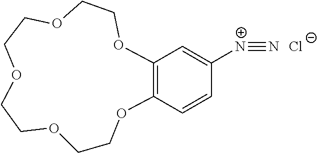 [SMILES: N#[N+]c1ccc2c(c1)OCCOCCOCCOCCO2 ; [Cl-]]

which is shown in Scheme 1A)
and reacting the diazonium salt with phenol crown ether (e.g., phenol-15-crown-5-ether or phenol-18-crown-6-ether) in the presence of alkali or alkaline earth base (e.g., MOH, M₂CO₃, wherein M is alkali metal) to form the corresponding alkali phenoxide of Formula 1a.

The acidic environment is supplied by a mineral acid, e.g., aqueous hydrochloric acid. For example, an inorganic nitrite source (e.g., sodium nitrite) or organic nitrite source (e.g., t-butyl nitrite) is slowly added to a solution of the starting material (amino-substituted benzo crown ether) in methanol, in the presence of the aqueous acid. The addition of the nitrite source takes place at a temperature below 0° C. The diazonium salt is not isolated; as shown in Step 2 of Scheme 1A, the reaction mixture containing the diazonium salt is added to an alkaline aqueous solution of the phenol crown ether, which was prepared beforehand. That is, the phenol crown ether is dissolved in water in the presence of an alkali base (the alkali metal is indicated by the letter M), preferably M₂CO₃, especially, Cs₂CO₃. The so-formed precipitate of the corresponding alkali phenoxide of Formula 1a (e.g., cesium phenoxide) is separated from the solution by filtration. As shown in Step 3 of Scheme 1A, hydrolysis of the alkali salts of the phenoxides of Formula 1a, e.g., in alcohol/water mixture, in the presence of an acid, leads to the corresponding phenols of Formula 1b.

The obtained metal phenolate (Formula 1a) and phenol (Formula 1b) are useful intermediates as they readily undergo subsequent transformations, like the alkylation reactions shown in Scheme 1B using haloalkyne, haloalkene and haloacetic acids to give the corresponding ethers and incorporate useful reactive groups into the crown ether (e.g., carbon-carbon double or triple bonds, carboxylic acid) to enable, with the aid of such groups, the covalent binding of the crown ether of Formula 1 to the magnetic nanoparticles.

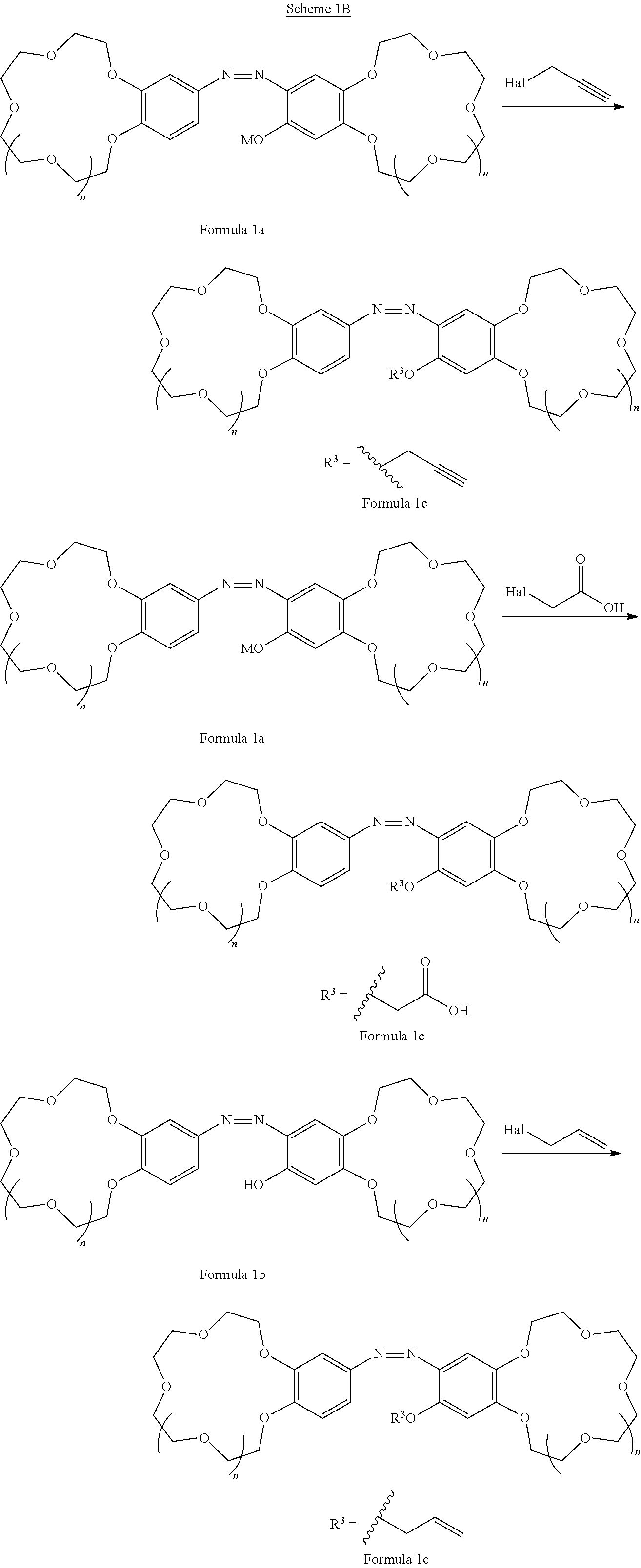

Thus, the invention further provides a process which comprises a step of alkylating the alkali phenoxide of Formula 1a with haloalkyne or halo-carboxylic acid, or alkylating the phenol of Formula 1b with haloalkene, to form a compound of Formula 1 wherein G¹, X, Y are hydrogens and G² is —OR³ where R³ is as previously defined.

Alkylation of the alkali phenoxide of Formula 1a takes place in methanol/water mixture by addition of haloalkyne such as propargyl halide (e.g., Hal is Br), as a solution in water immiscible organic solvent. The reaction reaches completion at room temperature. The reaction mixture is worked up by the removal of methanol, addition of water, and extraction with an organic solvent. The product, e.g., is recovered from the organic phase. One preferred crown ether afforded by this method has the structure shown below:

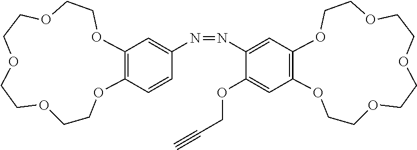 [SMILES: C#CCOc1cc2c(cc1/N=N\c1ccc3c(c1)OCCOCCOCCOCCO3)OCCOCCOCCOCCO2]

Alkylation of the alkali phenoxide of Formula 1a with haloacetic acids, e.g., 2-bromoacetic acid or 2-chloroacetic acid can also take place in a methanol/water mixture. The reaction mixture is worked up by evaporation of methanol, and extraction with an organic solvent, e.g., dichloromethane. The crown ether bearing the acidic groups is eventually recovered by acidification of the aqueous phase. One preferred crown ether compound afforded by this method has the structure shown below:

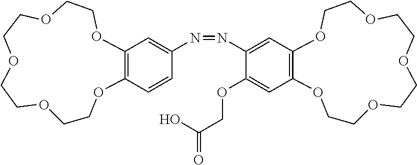 [SMILES: O=C(O)COc1cc2c(cc1/N=N\c1ccc3c(c1)OCCOCCOCCOCCO3)OCCOCCOCCOCCO2]

The phenol of Formula 1b also undergoes alkylation, e.g., with haloalkene in a polar aprotic solvent such as DMF, acetonitrile and DMSO in the presence of a base, e.g., alkali carbonate, at elevated temperature. One preferred crown ether afforded by this method has the structure shown below:

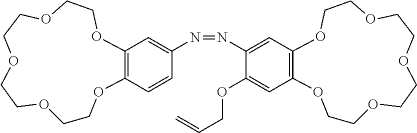 [SMILES: C=CCOc1cc2c(cc1/N=N\c1ccc3c(c1)OCCOCCOCCOCCO3)OCCOCCOCCOCCO2]

Another important variant of the invention involves the incorporation of a secondary amine functionality into the crown ether of Formula 1, via a two-step process shown in Scheme 1 C, consisting of transformation of the phenol of Formula 1b into sulfonic ester:

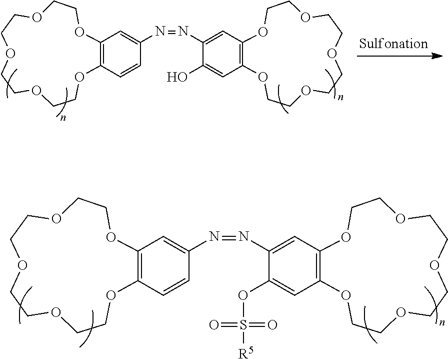

and transition-metal catalyzed amination of the sulfonic ester to the corresponding secondary amine:

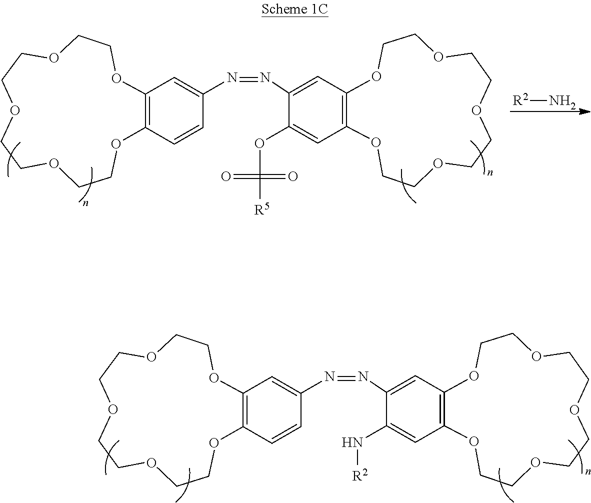

In the first step of Scheme 1 C, the phenol of Formula 1b is converted to a sulfonate, for example, by reaction with:
a) a source of methane sulfonyl group (CH₃SO₂) e.g., mesyl chloride;
b) a source of toluene sulfonyl group (H₃CC₆H₄SO₂), e.g., tosyl chloride; or c) a source of triflyl group (CF₃SO₂), e.g., triflic anhydride.

The a), b) and c) reactions take place in, e.g., a halogenated organic solvent such as dichloromethane in the presence of an organic base, e.g., amine such as trialkyl amine. For example, a solution of the reagent (CH₃SO₂C1, H₃CC₆H₄SO₂C1 or (CF₃SO₂)₂O is slowly added to a reaction vessel that was previously charged with a solution of the phenol of Formula 1b and the amine base. Preferred crown ethers of Formula 1 afforded by the first step of Scheme 1 C are shown below (i.e., G² is —O(SO₂)—R⁵, wherein R⁵ is alkyl, halogenated (e.g., fluorinated) alkyl and alkyl-substituted aryl):

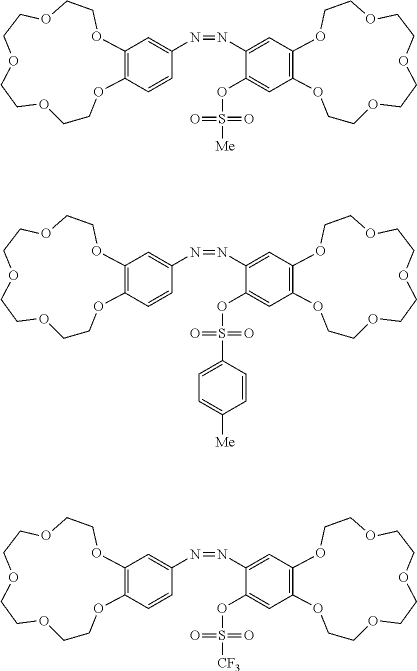 [SMILES: CS(=O)(=O)Oc1cc2c(cc1/N=N\c1ccc3c(c1)OCCOCCOCCOCCO3)OCCOCCOCCOCCO2 ; Cc1ccc(S(=O)(=O)Oc2cc3c(cc2/N=N\c2ccc4c(c2)OCCOCCOCCOCCO4)OCCOCCOCCOCCO3)cc1 ; O=S(=O)(Oc1cc2c(cc1/N=N\c1ccc3c(c1)OCCOCCOCCOCCO3)OCCOCCOCCOCCO2)C(F)(F)F]

In the second step of Scheme 1C, a secondary amine is formed by reacting the sulfonic ester with alkyl amine (e.g., R² is C1-C5 alkyl group; for example, the alkyl amine is butyl amine) or with amine compound in which the amino group is connected to an aromatic ring directly (aniline), or by C1-C3 carbon chain (e.g., —NHR² in Formula 1 is C₆H₅— (CH₂)ₚ—NH—, in which p is 0, 1 or 2; for example, the reactant is benzyl amine). The reaction takes place in an aprotic solvent, chiefly cyclic ethers such as 2-methyltetrhydrofurane, in the presence of transition metal (e.g., Pd or Ni) catalyst, phosphine-based ligand and a strong base, namely, alkoxide. Preferred crown ethers of Formula 1 afforded by the second step of Scheme 1C are shown below (i.e., the secondary amine derivatives in which G² is —NHR², wherein R² is alkyl, halogenated (e.g., fluorinated) alkyl and alkyl-substituted aryl):

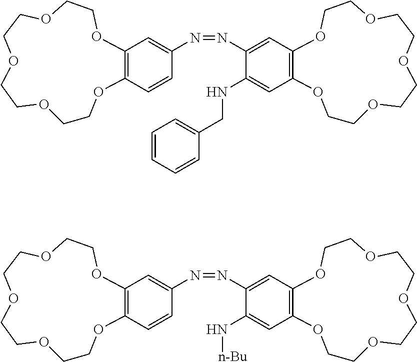

It is also possible to transform the sulfonyl ester Formula 1 (i.e., G² is —O(SO₂)—R⁵, wherein R⁵ is trifluoromethyl) to primary amine, i.e., the corresponding aniline, under similar conditions, namely, palladium-catalyzed coupling of the sulfonyl ester of Formula 1 with ammonia supplied in the form of ammonium salt (e.g., as ammonium sulfate) in a cyclic ether solvent (e.g., dioxane, 2-methyltetrahydrofuran or their mixture) in the presence of a strong non-nucleophilic base, namely, tert-butoxide. The aniline derivative of Formula 1 is shown below:

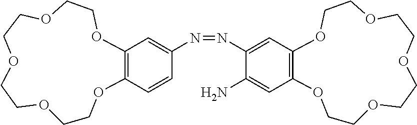 [SMILES: Nc1cc2c(cc1/N=N\c1ccc3c(c1)OCCOCCOCCOCCO3)OCCOCCOCCOCCO2]

Useful palladium catalysts include: Pd₂(dba)₃ (palladium dibenzylideneacetone), Pd acetate, Pd₂Cl₂dppf [1,1′-Bis(diphenylphosphino) ferrocene]dichloropalladium(II).

Useful P ligands include: BINAP, 2-Dicyclohexylphosphino-2′,4′,6′-triisopropylbiphenyl (XPhos), tert-Bu-XPhos, Biphenyl-dicycloheyl phospihe and dppf [1,1′-Bis(diphenylphosphino)ferrocene].

Another approach to the synthesis of crown ethers of Formula 1 is illustrated in Schemes 2A-2I depicted below. The key synthetic step is oxidation of the amino benzocrown ether under strongly oxidizing conditions. For example, the reaction with, e.g., potassium permanganate or potassium dichromate in DCM, can be accomplished at RT to give the “unsubstituted” bisazocrownether.

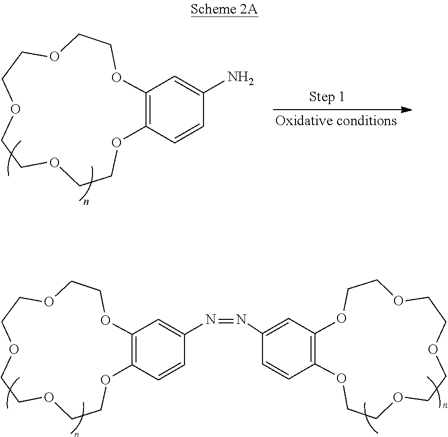

The so-formed unsubstituted bisazocrown ethers are useful intermediates in the syntheses of mono- and di-substituted bisazocrown ethers. For example, different diazoacetates can react under catalytic conditions to form different mono-esters with good yield. The reactions can be performed in a wide range of organic solvents like DCM, THF, DMF, toluene, etc., with various metal based catalysts, e.g., Pd(OAc)₂, in the presence of an oxidant such as Cu(OAc)₂. Hydrolysis of some of the obtained esters affords mono-acid with good yield (Scheme 2B; Alk indicates alkyl).

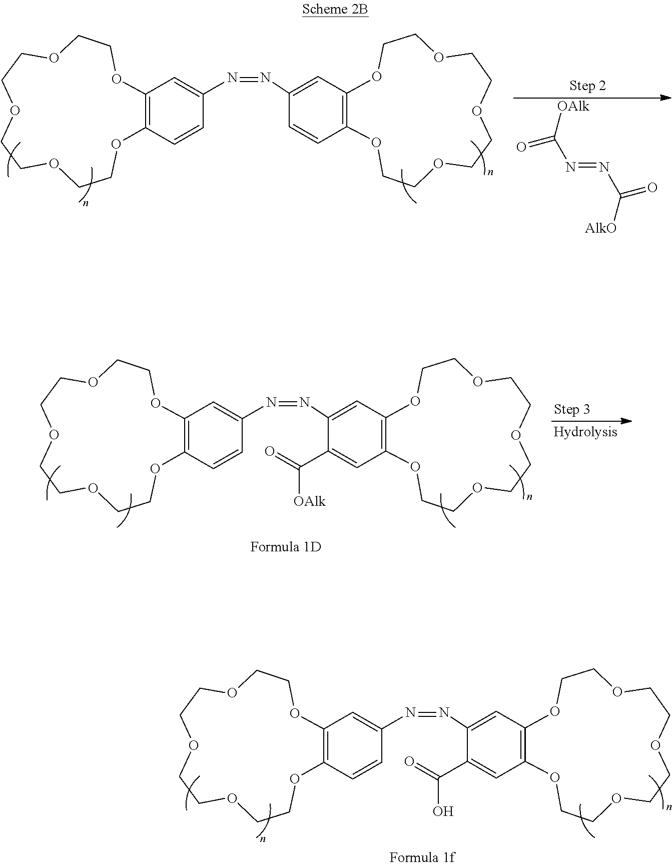

Another example is the formylation of the unsubstituted bisazocrown ethers with POCl₃ or COCl₂, in DMF at high temperature (e.g., above 100° C.). The reaction goes with the formation of two isomers of the mono-formylated product (1e, 1e′) as well as the di-aldehyde. Purification of the aldehyde bisazocrownether followed by oxidation gives the corresponding mono-acid (1f, 1f′). A variety of oxidants may be used, e.g., NaClO₂, NaOBr, cerium(IV) ammonium nitrate, SeO₂, sodium selenite, H₂O₂ in the presence of different catalysts, at comparatively mild conditions in different organic solvents, e.g., DMF, THF, DCM, etc.

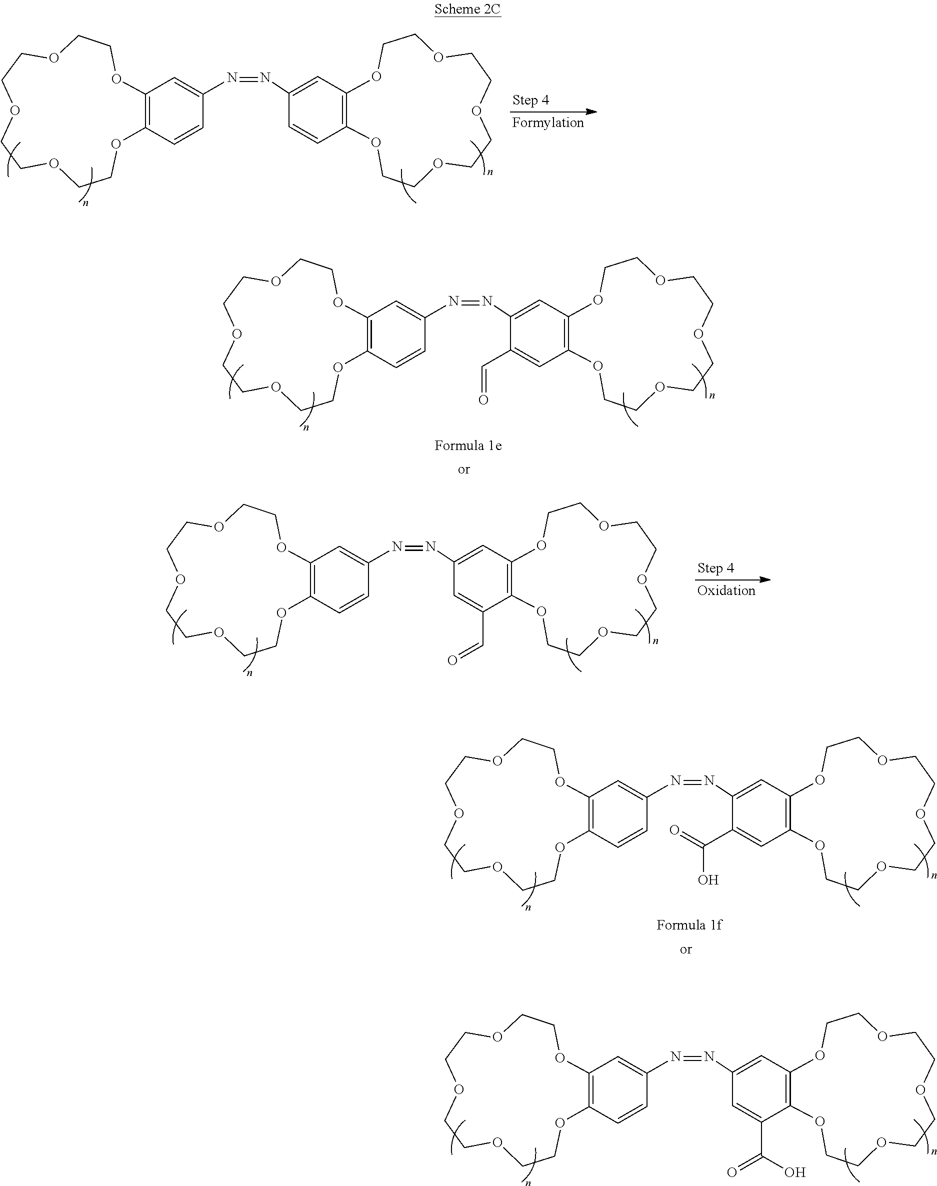

The aldehyde isomers can be reduced to the corresponding alcohols with the aid of acceptable reductants, such as lithium aluminum hydride (LiAlH₄), sodium borohydride (NaBH₄), or hydrogen (H₂) in the presence of a transition catalyst such as nickel (Ni), palladium (Pd), platinum (Pt), or rhodium (Rh).

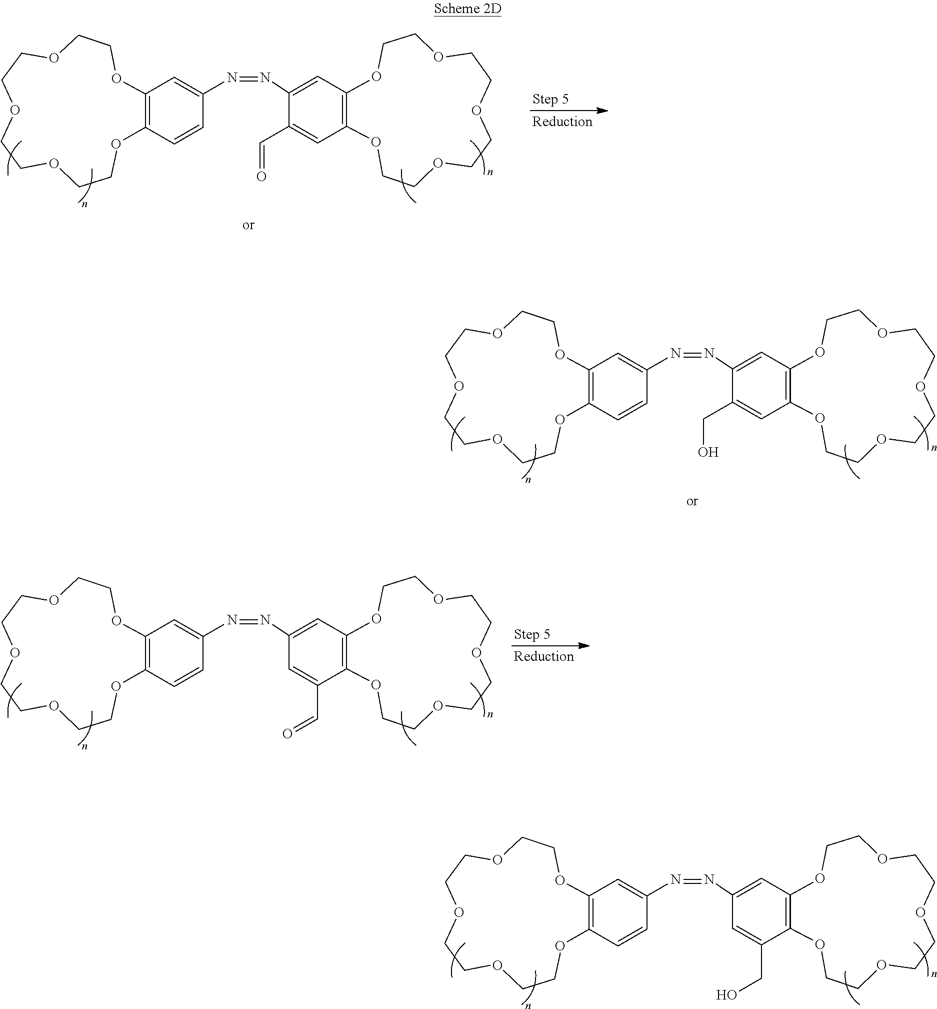

The Cannizzaro reaction can be performed in basic conditions, e.g., with KOH, to disproportionate the aldehyde to both the —COOH and —CH₂OH groups.

The aldehydes can be alkylated to form corresponding alkylalcohols by treating with organolithium or Grignard reagent under usual conditions and suitable solvents, e.g., ethers, THF, etc. (Scheme 2E; Alk indicates alkyl).

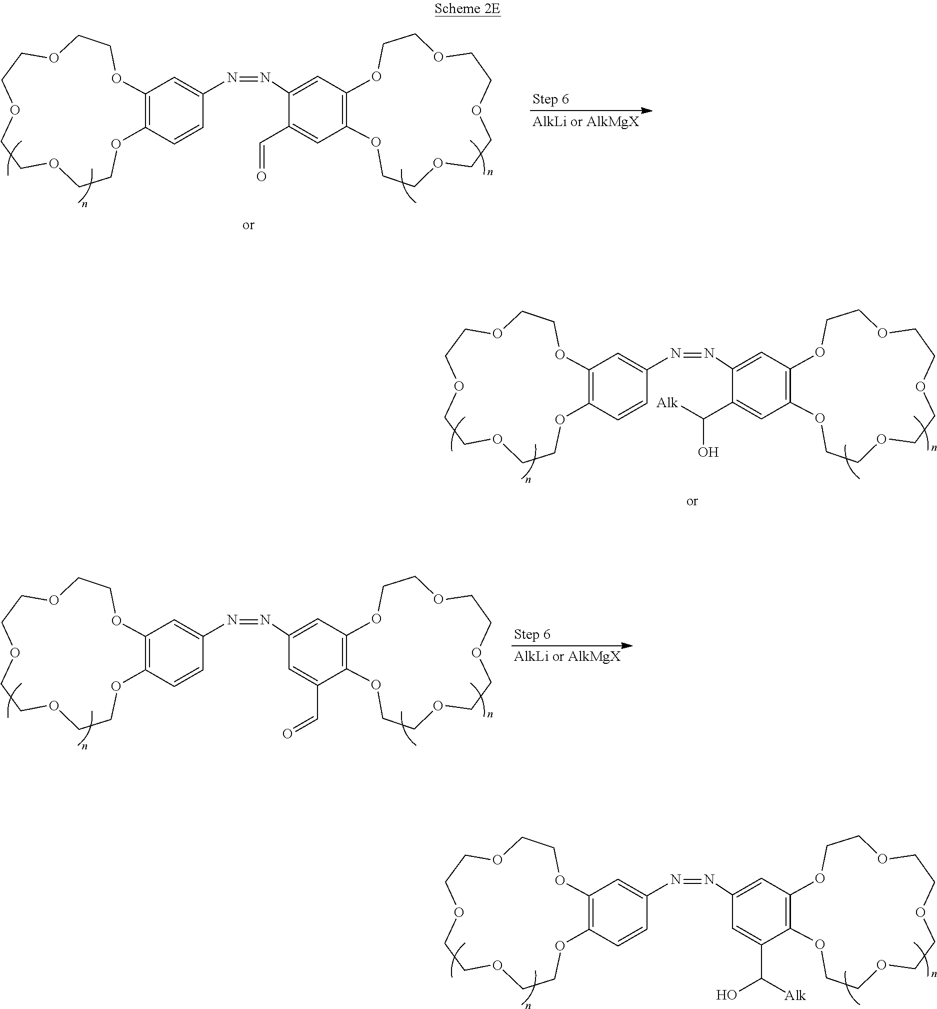

The unsubstituted bisazocrown ethers can also undergo direct alkylation to incorporate acidic functionality into the bisazocrown ethers, e.g., through reaction with a carboxylic acid such as Lactic acid, which may be performed in acetonitrile in the presence of a Lewis acid or a superacid such as Phosphotungstic acid (Scheme 2F), to form a diacid compound of Formula 1:

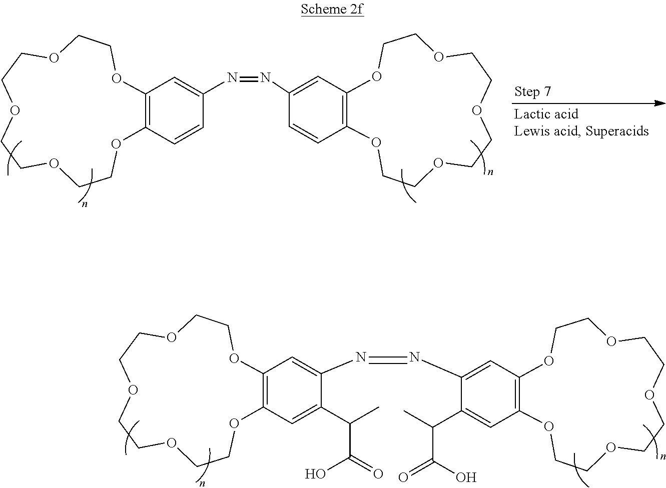

This reaction can be done also with other acids, e.g., acrylic acid and its alkylated derivatives (Scheme 2G).

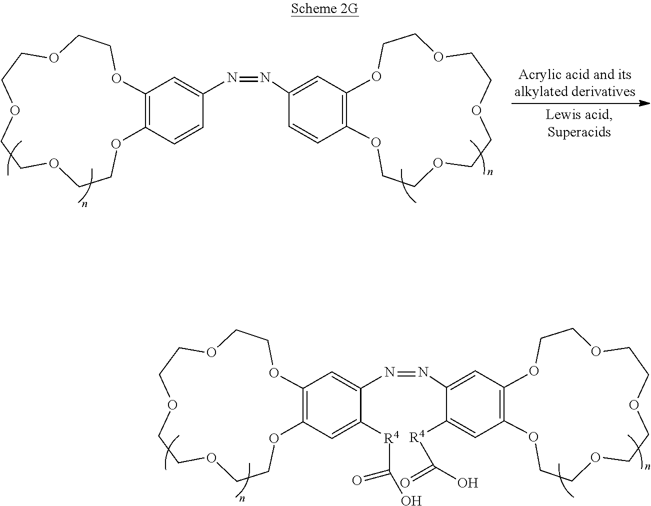

The reaction can be done also with derivatives of dicarboxylic acids, e.g., anhydrides such as succinic anhydride, or with butyrolactone, and others (Scheme 2H), to give a mixture of the mono or di-acid compound of Formula 1.

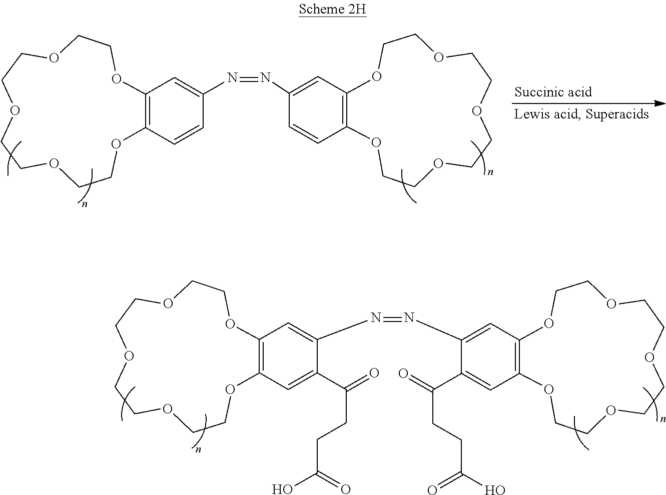

The acid esters, salts and homologs (e.g., Glycolic acid or its esters such as Methyl glycolate) gave mainly monoproducts as well as in the case of Glyoxylic acid and its derivatives (Scheme 2I).

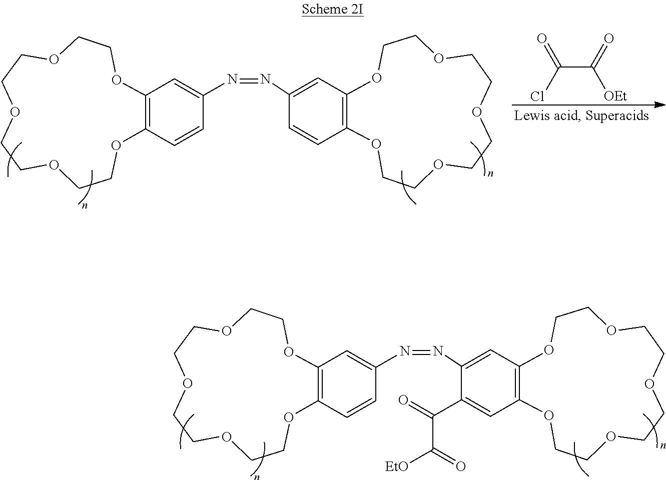

Lewis acid include BF₃, Hf(OTf)₄, Zr(OTf)₄, Ti(OTf)₄, Sc(OTf)₃, Sn(OTf)₂, Sn₃(PW₁₂O₄₀)₄, Sn₃(PMo₁₂O₄₀)₄ YPW₁₂O₄₀, YPMo₁₂O₄₀, Y₅(PMo₁₀V₂O₄₀)₃, Y₅(PW₁₀V₂O₄₀)₃ SnSiW₁₂O₄₀ (Y is trivalent metal such Al³⁺, Sc³⁺).

Superacids include H₃PW₁₂O₄₀, H₃PMo₁₂O₄₀, HF*SbF5, bmimSbF5, TfOH, etc.

It should be noted that the unsubstituted bisazocrownether is also accessible from the nitro-benzocrown ether, as shown in Scheme 3, when this nitro-benzocrown ether is reduced to form the azo compound, e.g., using zinc metal in a basic environment. Detailed reaction conditions are set out below, in reference to step 5 of Scheme 4.

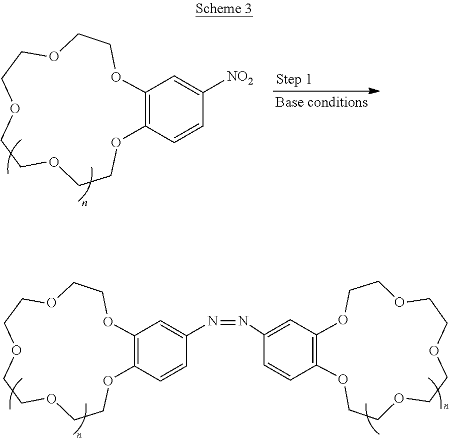

Turning now to Scheme 4, it illustrates a synthetic pathway for preparing a compound of Formula 1, in which G¹ and G² are the same, for example, both are —COOH, with the aid of either amino- or nitro-benzocrownethers, in which the aromatic ring is further substituted with —COOH group. These important intermediates, which, as already explained above in reference to Schemes 2 and 3, can lead to the desired bisazocrownether under appropriate conditions (i.e., in the presence of a strong oxidant or upon reduction with Zn in a highly alkaline environment, respectively), are depicted below:

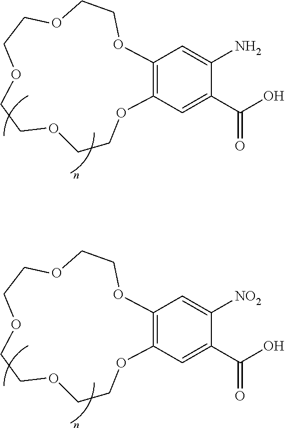

“anthranilic acid” crown ether “nitrobenzoic acid” crown ether

These useful intermediates, which form another aspect of the invention, can be prepared through the synthetic pathway shown in Scheme 4.

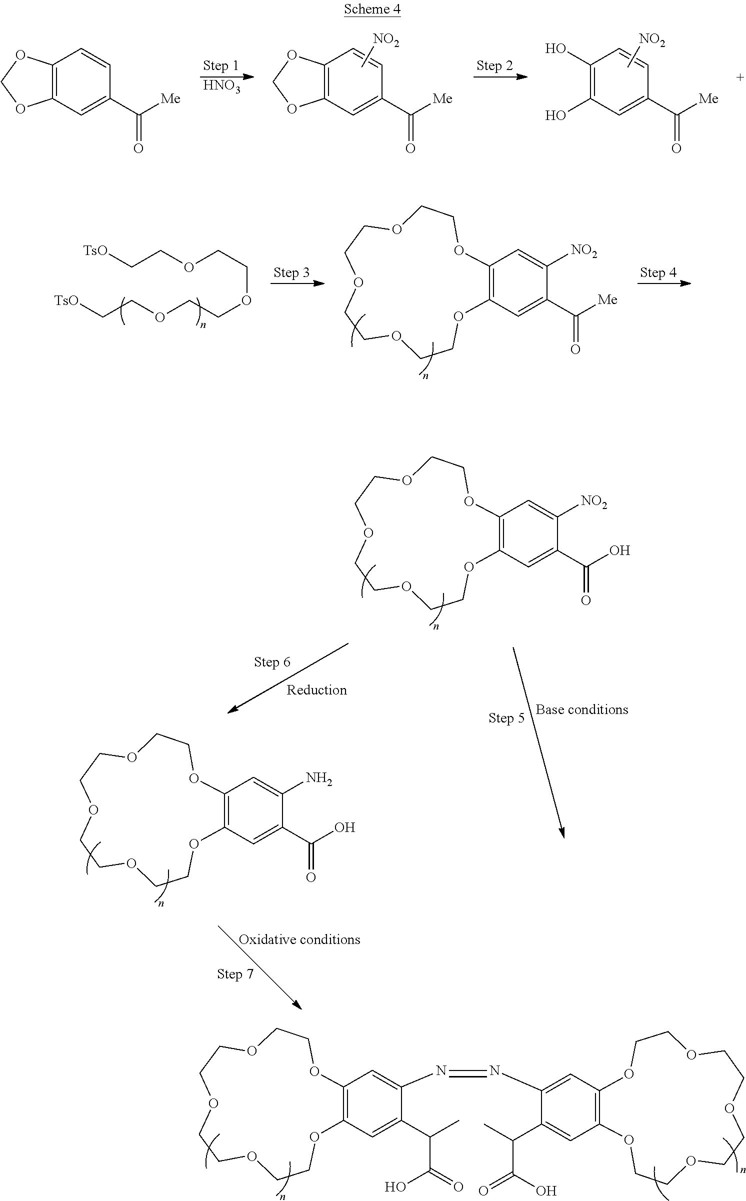

To arrive at the “nitrobenzoic acid” crown ether intermediate depicted above, 5-acetyl-1,3-benzodioxole is nitrated by nitric acid in the presence of sulfuric acid to form the nitro-substituted 1,3-Benzodioxole (step 1), followed by cleavage of the 1,3-dioxolane ring to obtain nitrocatechol derivative (step 2). Step 2 can be performed in the presence of AlCl₃, for example. Next, coupling the nitrocatechol derivative with polyethylene glycol bistosylate leads to nitro-acetophenone benzocrown ether. The methyl ketone can be converted to the corresponding carboxylic acid by the haloform reaction, i.e., by reacting with halogen in the presence of a base, to convert the acetyl into a carboxyl group.

The “nitrobenzoic acid” crown ether intermediate undergoes reduction in an alkaline environment (e.g., with metal such as zinc powder), affording directly the azo compound of Formula 1, in which G¹ and G² are both —COOH. Suitable reaction solvents include methanol, with cesium hydroxide as the base (step 5).

Alternatively, the “nitrobenzoic acid” crown ether is transformed into the diacid azo compound of Formula 1 via a two-step process. That is, by reduction of the nitro group to give the “anthranilic acid” crown ether intermediate (step 6 of Scheme 4), followed by oxidation of the amino group of “anthranilic acid” crown ether intermediate to give the diacid azo compound of Formula 1.

Reduction of “nitrobenzoic acid” crown ether to the “anthranilic acid” crown ether can be achieved with the aid of reductants used for the reduction of the nitroaromatics, e.g., hydrazine hydrate, iron in acidic media, sodium sulfide or hydrosulfite, Tin(II) chloride, metal hydrides, etc., as well as catalytic or non-catalytic hydrogenation known from the art. The conditions for step 7 are as previously described in reference to Scheme 2.

Accordingly, the invention also provides a process for preparing a compound of Formula 1, wherein G¹ and G² are the same, comprising:
reducing nitro-benzocrown ether having the structure:

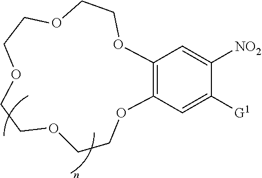

in an alkaline environment with zinc metal, to afford the compound of Formula 1:

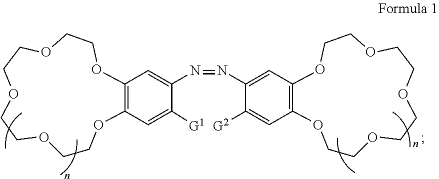

or
reducing the nitro-benzocrown ether to the corresponding amino-benzocrown ether, followed by oxidation to the compound of Formula 1:

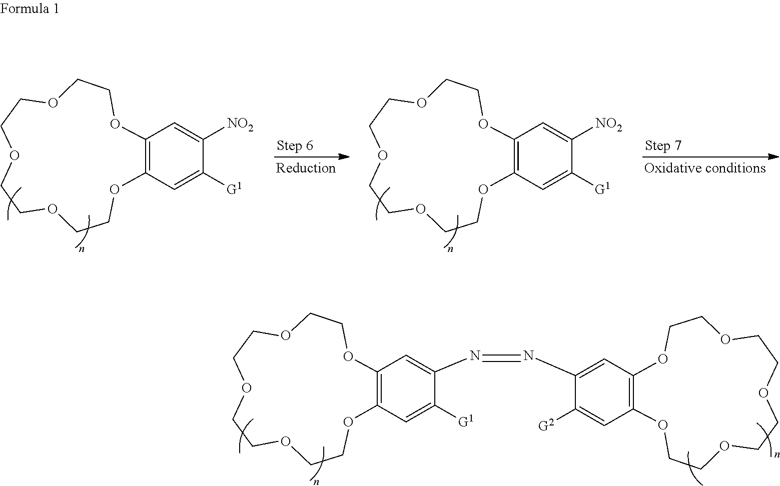

A general remark applied to Schemes 1 to 4 is that reactions involving the participation of crown ether derivatives bearing higher homologues, namely, —(CH₂)ₚX where X is the functional group and m is 1, 2, . . . , which require basic conditions, are advanced more effectively with the aid of sodium hydride in place of cesium carbonate. Sodium is washed out at the end of the process with HClO₄, HCl or hot water, such that the sites of the crown ether are available for their intended use.

### Coupling Crown Ether of Formula 1 to Magnetic Nanoparticles

The coupling of the surface functionalized magnetic nanoparticles and the crown ether of Formula 1, to give the “complexing unit” of Formula 2 (i.e., the surface modified magnetic nanoparticle having the crown ether covalently bonded to its surface through at least one linker is achieved by the synthetic approaches illustrated in Schemes 5a to 5e.

The synthesis of the compound by Formula 2, based on a triazole-containing linker created through a cycloaddition reaction, was performed by “click-chemistry” of propargylic dibenzocrown ether with azido-modified MNPs (Scheme 5a). The reaction is carried out under acceptable conditions for azide-alkyne cycloaddition reaction known from the art, e.g., Huisgen 1,3-Dipolar cycloaddition conditions using different copper or ruthenium catalysts, e.g., Cu(NO₃)₂, CuSO₄, Cu(I), pentamethylcyclopentadienyl ruthenium chloride, etc. The reaction can be performed with or without ascorbic acid in different organic solvents, e.g., 1,4-dioxane, acetonitrile, alcohols, toluene, etc., or water.

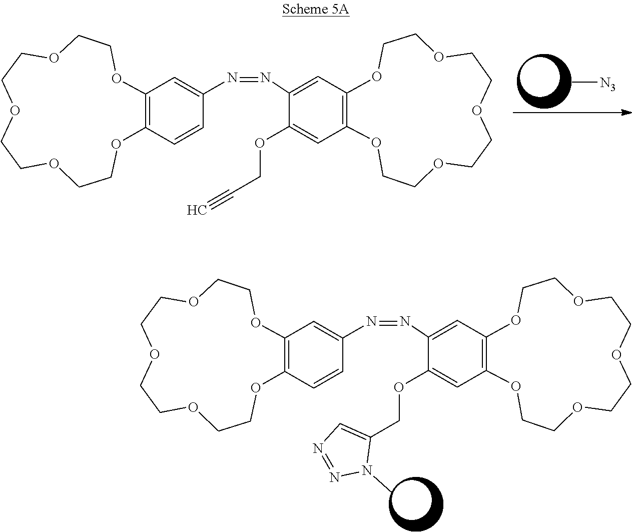

The synthesis of the compound of Formula 2, based on an amide-containing linker formed through the reaction of a carboxylic acid-substituted crown ether of Formula 1 with amino-functionalized magnetic particle, is shown in Scheme 5b. The reaction can be carried out in water and in a variety of organic solvents, such as acetonitrile, THF, DMF, etc., optionally in the presence of one or more coupling agents, e.g., a carboxyl activating agent for the coupling of primary amine to generate the amide bond such as 1-Ethyl-3-(3-dimethylaminopropyl)carbodiimide (EDCI), and hydroxybenzotriazole (HOBT) hydrate.

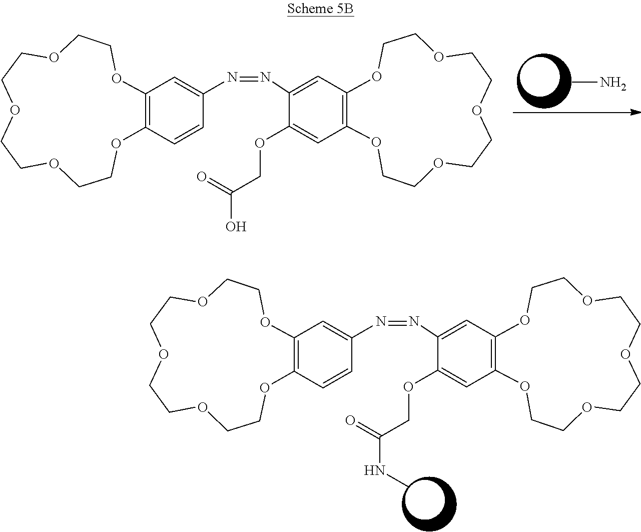

Instead of using coupling agents, it is also possible to activate the acid to the corresponding acyl chloride and then proceed to the amide bond formation.

Another approach to the formation of the amide-containing linker to covalently connect the nanoparticle and the crown ether is by aminolysis reaction between a carboxylate derivative of the crown ether and amine-functionalized magnetic particle. The reaction progresses by a nucleophilic addition-elimination mechanism with the alkoxy group as a leaving group, forming the corresponding secondary amide. The reaction can take place in a high boiling aprotic solvent over a wide temperature range, from 0° C. up to reflux temperature (Scheme 5c).

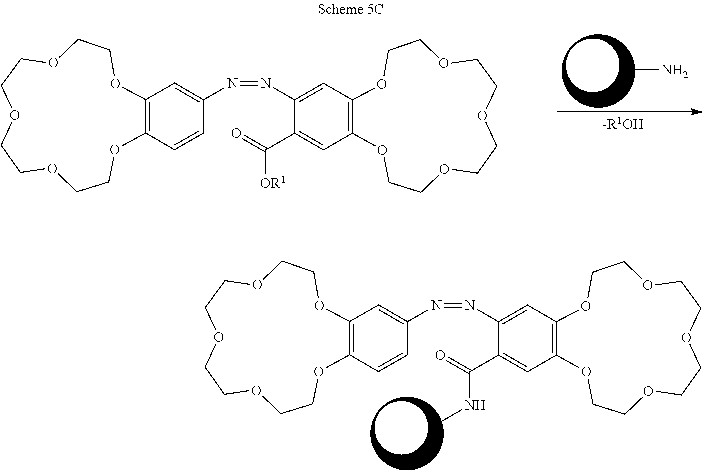

Covalently bonding the crown ether to the magnetic particle can also be achieved through a reaction of an aldehyde derivative of the crown ether of Formula 1 with the amine-functionalized nanoparticle, with the formation of an imine-containing linker. Imine formation progresses effectively at mild acidic conditions (˜pH at about 5), and therefore the reaction generally benefits from the presence of a weak acid. Suitable reaction solvents include THF, 2-Me-THF, IPA, MeOH, water, etc., and a mixture thereof. The resulting imine can be reduced with conventional reducing agents to a secondary amine. The reaction can be performed in a large variety of solvents, e.g., water, alcohols, THF, 1,4-dioxane, etc. as illustrated in Scheme 5D.

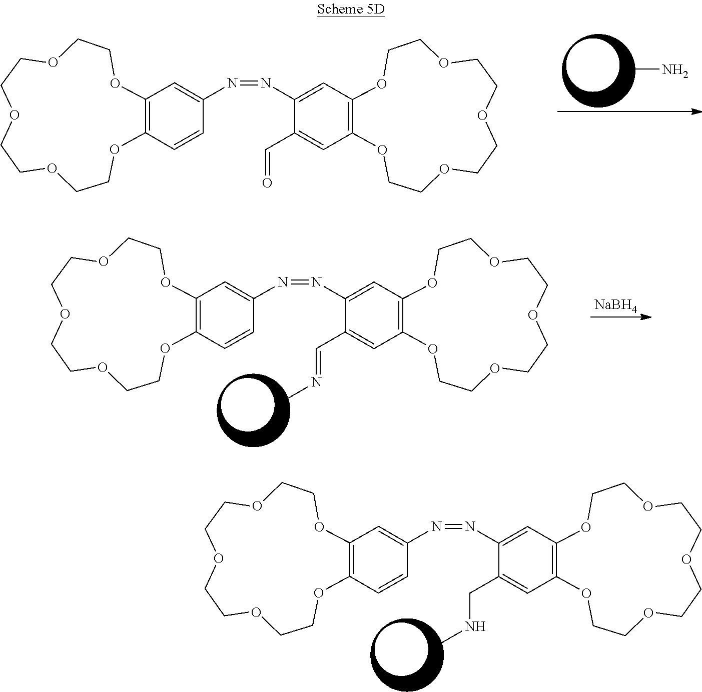

Covalently binding the crown ether of Formula 1 to the magnetic particle via a thioether-containing linker is accomplished under photocatalytic thiol-ene reaction (also known as alkene hydrothiolation). A suitable solvent system consists of a mixture of aliphatic or aromatic hydrocarbon and a polar aprotic solvent, e.g., cyclohexane/THF, benzene/THF, benzene/acetonitrile, benzene/DMF, etc., with the former being especially preferred. The reaction can be conducted over a wide temperature range; but because the reaction progresses in a satisfactory manner also at ambient temperature, ambient conditions are preferred (Scheme 5E).

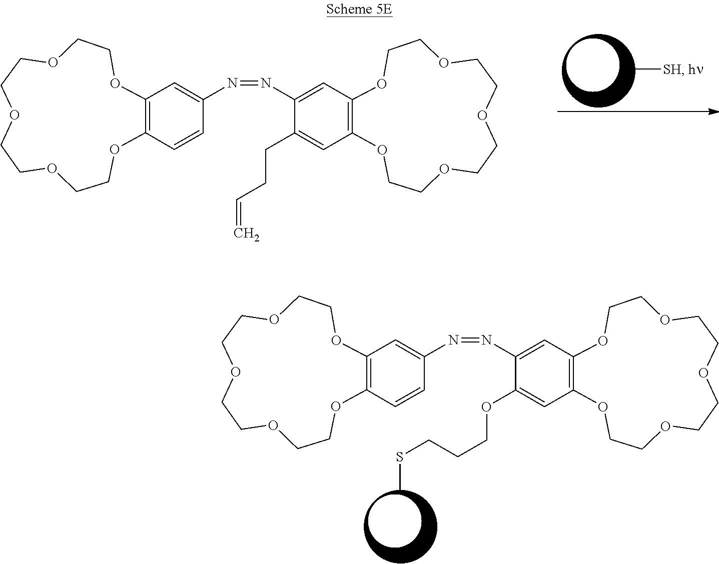

Accordingly, the invention further relates to a process of preparing a surface-modified magnetic nanoparticle having a crown ether covalently bonded on its surface of Formula 2:

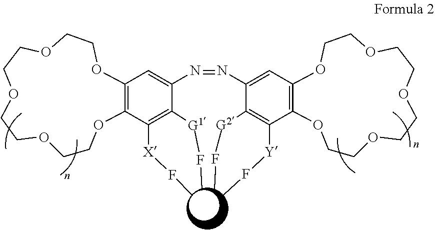

comprising the steps of:
providing functionalized magnetic nanoparticles, bearing functional group F on their surface;
reacting the functionalized magnetic nanoparticles with a compound of Formula 1, wherein at least one of the groups G¹,
G², X, Y is reactive towards the functional group F; and collecting the nanoparticles.

For example:
the functional group F contains —NH₂, and the group G² contains —COOH or —COOR², such that on reaction, a linker is formed which comprises an amide bond;
the functional group F contains —COOH, and the group G² contains —NH₂ or —NHR², such that on reaction, a linker is formed which comprises an amide bond;
the functional group F contains thiol —SH, and the group G² contains carbon-carbon double bond, such that on reaction, a linker is formed which contains a thioether bond;
the functional group F contains hydroxyl —OH, and the group G² contains —COOH, such that on reaction, a linker is formed which contains an ester bond; and
the functional group F comprises an azide and the group G² comprises a carbon-carbon triple bond, such that on reaction, a linker is formed which comprises a triazole ring.

It is expected that during the life of a patent maturing from this application many relevant technologies will be developed and the scope of the terms are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention.

Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate the number and a second indicate the number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments unless the embodiment is inoperative without those elements.

Various embodiments and aspects of the present invention as delineated hereinabove and as claimed in the claims section below find experimental support in the following examples.

### EXAMPLES

### Methods

HPLC: The separation of materials was performed by HPLC using an Agilent 1200 HPLC system consisting of a quaternary pump, degassing device, autosampler, diode array detector (PDA), and Agilent ChemStation software. A Zorbax SB-C18, 250×4.6 mm, 100 Å (S/No86996-11, B/No:5701-029) column was used. The mobile phase used for isocratic elution consisted of distilled water (MilliQ purity, 0.5 μS/cm at 20° C.)-methanol HPLC grade (60:40) (v/v). The acquisition parameters used were: flow rate 1.5 mL/min, injection volume 10 μL, column temperature 25° C., and detection was performed at 293 nm.

LCMS: Shimadzu LCMS 8040 system.

TLC: Silicacycle 20×20 cm, Layer Thickness 250 μm plates 1H NMR was performed on 400 MHz Brucker.

Loading levels of functional groups on the magnetic nanoparticles was determined by the following methods. Amines were measured by spectrophotometry at 282 nm. Azide was converted to the amine by the action of triphenylphosphine, and the so-formed amine groups were quantified spectroscopically as described above. The concentration of acidic groups was determined by titration with sodium hydroxide.

The following procedure was used to determine the loading level of amine, as described in Langmuir 2005, 21, 7029-7035. Nanoparticles (5 mg) were placed in a 1.5 mL Eppendorf tube and washed (×4) with 1 mL of coupling solution [0.8% (v/v) glacial acetic acid in dry methanol]. Subsequently, 1 mL of 4-nitrobenzaldehyde solution (7 mg in 10 mL of coupling solution) was added to the particles and the suspension was allowed to react for 3 h with gentle end-over-end rotation. After removal of the supernatant and washing (×4 in 1 mL of coupling solution), 1 mL of hydrolysis solution (75 mL of H₂O, 75 mL of MeOH, and 0.2 mL of glacial acetic acid) was added to the particles and the tube was shaken for a further hour. The supernatant was then removed from the particles with a magnetic separator and its absorbance was measured at 282 nm. The amount of 4-nitrobenzaldehyde in the hydrolysis solution was calculated by interpolation, by use of a calibration curve constructed from a range of standard solutions of 4-nitrobenzaldehyde prepared separately.

The presence and quantification of remaining-releasing NaCl/KCl was tested by titration using the standard Mohr method of chlorides (titrant solution of AgNO3, indicator chromate ion).

### Preparation 1

### Preparation of Magnetic Nanoparticles

The following procedures A, B and C were used to prepare Fe₃O₄ by co-precipitation from Fe²⁺/Fe³⁺ solution.

Procedure A: A mixture of 18.17 g of FeCl₃ and 11.13 g of FeCl₂·4H₂O was introduced into 1500 mL of water, and then after the addition of 1500 mL of NH₄OH (25 wt %) with agitation under N₂ protection, the Fe₃O₄ solid products were obtained at 50° C. for 30 min of reaction time.

Procedure B: 50 ml of 1.0 molar Fe²⁺ and 2.0 molar Fe³⁺ solutions were prepared with deionized water in two beakers and then transferred to a 250 ml three-necked flask together. The solution was heated to 80° C., NH₄OH (25 wt %) was added dropwise under argon protection and vigorous mechanical stirring was applied to reach pH 10-11. The mixture was heated at 80° C. for 1 h, and then the precipitated powders were collected by magnetic separation. The obtained magnetic nanoparticles were washed with deionized water five times and then with ethanol three times, and were dried to powder at 40° C. under vacuum. Magnetic nanoparticles were obtained with a yield of 98%.

Procedure C: 3.17 g of FeCl₂·4H₂O (0.016 mol) and 7.57 g of FeCl₃-6H₂O (0.028 mol) were dissolved in 320 mL of de-ionized water, such that Fe²⁺/Fe³⁺ ratio was 1.75. The mixed solution was stirred under N₂ at 80° C. for 1 h. Then, 40 mL of NH₃·H₂O was injected into the mixture rapidly, stirred under N₂ for another 1 h and then cooled to RT. The precipitated particles were washed five times with hot water and separated by magnetic decantation. Finally, Fe₃O₄—NPs were dried under vacuum at 70° C.

### Preparation 2

### Synthesis of Amino-Functionalized Magnetic Nanoparticles by direct addition of H₂N(CH₂)₃Si(OC₂H₅)₃

The surface of Fe₃O₄ was coated with aminopropyltriethoxysilane (APTES) by a silanization reaction to obtain modified magnetic nanoparticles (MNPs) with amine groups. 4.23 g of MNPs were mixed with ethanol (100 mL) using ultrasound to produce a homogeneous suspension, to which 16.16 g of APTES was added under argon atmosphere. To obtain the optimal surface modification, the molar ratio of APTES to Fe₃O₄ was applied as 4:1. The reaction mixture was kept at room temperature for 5 h under a nitrogen atmosphere with vigorous mechanical stirring. Then the obtained APTES-immobilized MNPs were washed with ethanol (2×30 mL) and dichloromethane (2×30 mL) in turn. Finally, APTES-modified nanoparticles were dried under vacuum at 40° C.

### Preparation 3

### Synthesis of Amino-Functionalized Magnetic Nanoparticles by a Two-Step Process

Step 1: Preparation of Fe₃O₄@SiO₂ Nanoparticles

A 500 ml three-necked round-bottom flask equipped with a stirrer and placed in an ultrasonic bath was charged with 80 mg Fe₃O₄ nanoparticles in 20 ml distilled water. After 30 min dispersing by the action of ultrasound (450 W), the mixture was treated with 4 ml of 2NH₃ (25%) solution, 12 ml water, and 200 ml of absolute ethanol denaturized with petrol. After 10 min, the stirred (300 min⁻¹) reaction mixture placed in an ultrasonic bath was treated with a solution of 140 mg (0.672 mmol) TEOS in 10 ml absolute ethanol, which was added dropwise over 10 min. After 24 hour stirring at 40° C., the particles of Fe₃O₄@SiO₂ were separated by means of a magnet and subsequently washed with 3×50 ml of distilled water and 2×50 ml of methanol and dried in a vacuum drying oven at 40° C. The yield was 120 mg Fe₃O₄@SiO₂ nanoparticles.

Step 2: Preparation of Fe₃O₄@SiO₂—NH₂ Nanoparticles

A mixture of 100 mg Fe₃O₄@SiO₂, 50 ml water, and 100 ml 3-aminopropylethoxysilane (0.452 mmol) in 200 ml tetrahydrofuran placed in a round-bottom flask was submitted to the action of ultrasound (450 W) at the temperature of 40° C. for different time periods (1 hour and 3 hours). The particles of Fe₃O₄@SiO₂—NH₂ were separated by means of a magnet and subsequently washed with 3×50 ml distilled water and 2×50 ml methanol and dried in a vacuum drying oven at the temperature of 40° C. In the nanoparticles prepared (about 100 mg), the total nitrogen content was determined by microanalysis, and the content of reactive amino groups was determined spectrophotometrically. The Fe₃O₄ nanoparticles prepared had the size equal to 114±59 nm. Publications showed that this way possible reach high loading of aminogroups from 73 to 128 mmol/g (based on the Harmand et al., Scientific Papers of the University of Pardubice, 2014—“Synthesis and Characterization of Magnetic nanoparticles Fe₃O₄@SiO₂ decorated with amino groups”].

### Preparation 4

### Synthesis of amino benz-15-crown-5-ether

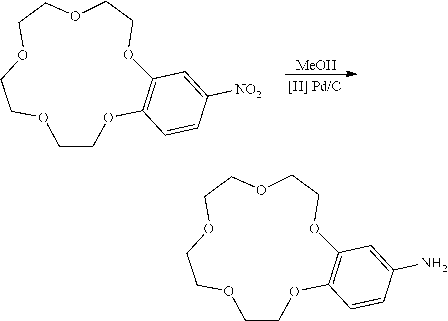 [SMILES: "MeOH" ; O=[N+]([O-])c1ccc2c(c1)OCCOCCOCCOCCO2 ; Nc1ccc2c(c1)OCCOCCOCCOCCO2]

A suspension of nitro-benz-15-crown-5-ether (5 g, 16 mmol) and the catalyst (10% Pd/C, 0.5 g) in methanol (150 mL) was subjected to hydrogenation under atmospheric pressure at RT for 5 h. The catalyst was filtered off and the solvent was removed under reduced pressure to give a slightly reddish viscous oil. Yield 4.6 g (99%). 1H NMR (CDCl₃), δ 6.73 (d, 1H, J=8.4 Hz), 6.27 (d, 1H, J=2.4 Hz), 6.21 (dd, 1H, J=8.4 Hz, J=2.4 Hz), 4.08-4.04 (m, 4H), 3.90-3.85 (m, 4H), 3.74 (s, 8H), 3.46 (brs, 2H) ppm.

### Preparation 5

### Synthesis of Ditosylate

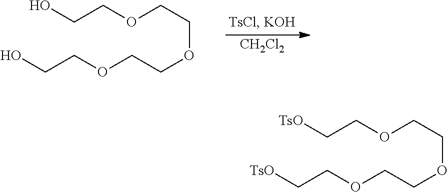

TsCl (41.6 g, 0.218 mol) and powdered KOH (49 g, 0.875 mol) were successively added to a stirred solution of tetraethylene glycol (21.04 g, 0.108 mol) in dichloromethane (120 mL) at 0° C. The reaction mixture was stirred at 0° C. for 1.5 h. Then the reaction mixture was poured into a glass beaker containing deionized water (200 mL) and dichloromethane (200 mL). The resulting mixture was stirred until the solid phase dissolved.

The organic layer was separated, and the aqueous phase was extracted with dichloromethane (2×150 mL). The combined organic layers were washed with water (150 mL) and dried over MgSO₄. The solvent was removed under reduced pressure to give colorless viscous oil. Yield 47.5 g (87%). 1H NMR (CDCl₃), δ 7.79 (d, 4H, J=8.4 Hz), 7.33 (d, 4H, J=2.4 Hz), 4.16-4.13 (m, 4H), 3.68-3.66 (m, 4H), 3.60-3.52 (m, 8H), 2.44 (s, 6H) ppm.

### Preparation 6

### Synthesis of aldehyde-benz-15-crown-5-ether

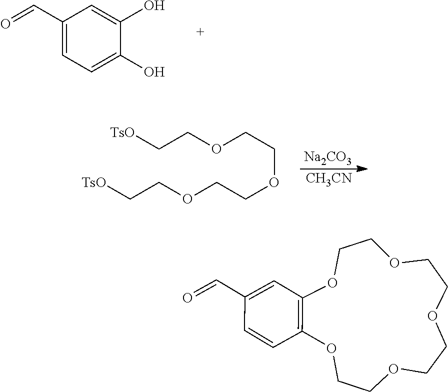

Powdered sodium carbonate (26 g, 0.245 mol) was added to a stirred solution of benzaldehyde (13.05 g, 0.094 mol) in acetonitrile and ditosylate from example 3 (47.5 g, 0.094 mol). The reaction mixture was stirred at 60° C. for 6 days. Then insoluble inorganic part was filtered off and the solvent was removed under reduced pressure affording colorless oil. The oil was triturated with water (80 mL) containing 6.2 mL of concentrated hydrochloric acid. The mixture was extracted with Et₂O/EtOAc (1:2) (4×120 mL). The organic extracts were combined, and solvents were removed under reduced pressure to yield a viscous oil. The oil was purified by flash chromatography on silica gel (Combiflash, dichloromethane/isopropanol: 2-3%) to afford white solid. Yield 7.2 g (26%). 1H NMR (CDCl₃), δ 9.82 (s, 1H), 7.43 (dd, 1H, J=8.0 Hz, J=2.0 Hz), 7.38 (d, 1H, J=2.0 Hz), 6.93 (d, 1H, J=8.0 Hz), 4.21-4.17 (m, 4H), 3.94-3.90 (m, 4H), 3.79-3.73 (m, 8H), 3.46 (brs, 2H) ppm.

### Preparation 7

### Synthesis of phenol-15-crown-5-ether

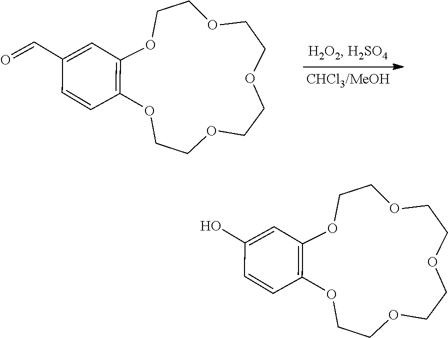 [SMILES: O=Cc1ccc2c(c1)OCCOCCOCCOCCO2 ; Oc1ccc2c(c1)OCCOCCOCCOCCO2]

Aqueous H₂O₂, 43% (2.23 mL, 31.2 mmol) and a solution of H₂SO₄ (0.26 mL, 4.6 mmol) in methanol (36 mL) were successively added dropwise to a solution of aldehyde from Preparation 6 (3.18 g, 10.7 mmol) during 1.5 h at RT. The reaction mixture was stirred at RT for 24 h. Then water (40 mL) was added to the stirred reaction mixture and the mixture was extracted with dichloromethane (4×40 mL). The combined extracts were washed with water (50 mL). The organic layer was separated, and the solvent was removed under reduced pressure giving reddish viscous oil. The oil turned into a crystalline solid upon standing under ambient conditions. Yield 3.05 g (98%). 1H NMR (CDCl₃), δ 6.67 (d, 1H, J=8.4 Hz), 6.37 (d, 1H, J=2.8 Hz), 6.30 (dd, 1H, J=8.4 Hz, J=2.8 Hz), 4.05-3.99 (m, 4H), 3.87-3.83 (m, 4H), 3.76-3.73 (m, 8H) ppm.

### Example 1

### Synthesis of Bisazocrownether Cesium Salt

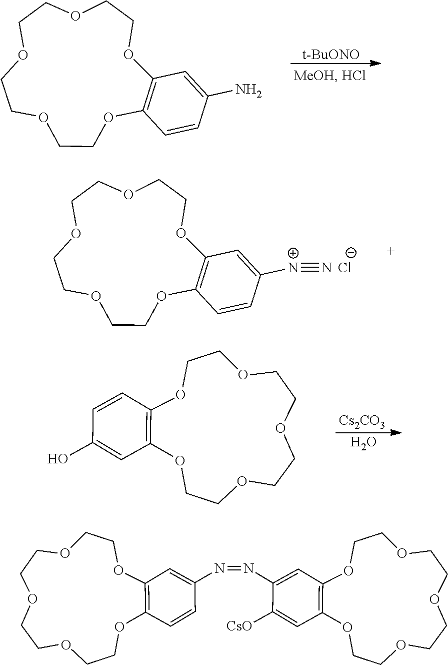

Solution A: concentrated aqueous HCl (4.1 mL, 45 mmol) was added dropwise to a stirred solution of amino benz-15-crown-5-ether from Example 2 (2.3 g, 8.1 mmol) in methanol (80 mL) at 10° C. Then tert-butyl nitrite (2.2 mL, 18.4 mmol) was added dropwise to the mixture at −10° C. The reaction mixture was stirred at −10° C. for 30 min.

Solution B: in another reactor phenol from Preparation 7 (3 g, 10.6 mmol) was added to a stirred solution of cesium carbonate (18.4 g, 56.5 mmol) in water (92 mL) and the mixture was stirred at RT for 20 min.

Solution A was added dropwise to a stirred solution B at 0° C. The reaction mixture was stirred at 0° C. for 1 h causing precipitation of an orange solid of the cesium salt that was involved in the next reaction step without further purification.

### Example 2

### Hydrolysis of Cesium Salt Bisazocrownether to Form the Phenol

Alternatively to Example 1, cesium phenolic salt may be hydrolyzed giving corresponding phenol quantitatively, upon bringing pH from acidic to neutral, giving yellow powder.

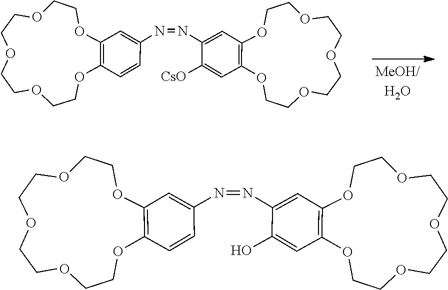

This phenol MW=578 (LCMS) gives an ester bond with acid modified magnetic nanomaterial.

### Example 3

### Synthesis of mono O-propargyl bisazocrownether

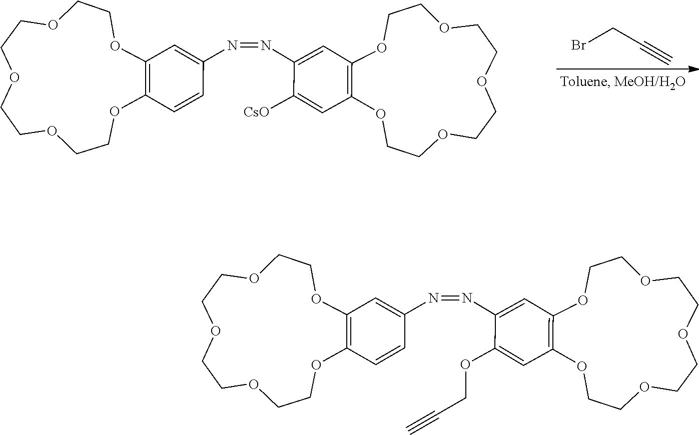

An 80% solution of propargyl bromide (2.9 mL, 26 mmol) in toluene was added to a stirred suspension of cesium salt received in Example 1 (8.12 mmol) in a mixture of methanol (80 mL) and water (90 mL). The reaction mixture was stirred at RT for 24 h. 40 mL of methanol was removed under reduced pressure and water (200 mL) was added to the reaction mixture. The resulting emulsion was extracted with ethyl acetate (4×100 mL). The organic extracts were combined, and the solvent was removed under reduced pressure to give dark orange solid. The crude product was purified by flash chromatography on silica gel (Combiflash, dichloromethane/acetone: 3-10%) to afford a yellowish powder. Yield 2.47 g (49%). 1H NMR (CDCl₃), δ 7.54 (dd, 1H, J=8.4 Hz, J=2.4 Hz), 7.45 (d, 1H, J=2.4 Hz), 7.38 (s, 1H), 6.94 (d, 1H, J=8.4 Hz), 6.76 (s, 1H), 4.93 (d, 2H, J=2.4 Hz), 4.24-4.17 (m, 8H), 3.96-3.89 (m, 8H), 3.78-3.76 (m, 16H), 2.53 (t, 1H, J=2.4 Hz) ppm.

### Example 4

### Alkylation of Cesium Salt Bisazocrownether

Cesium phenolic salt bisazocrownether synthesized in Example 1 alkylated producing phenoxyacids, for example with 2-bromoacetic acid or 2-chloroacetic acid to form the corresponding acid.

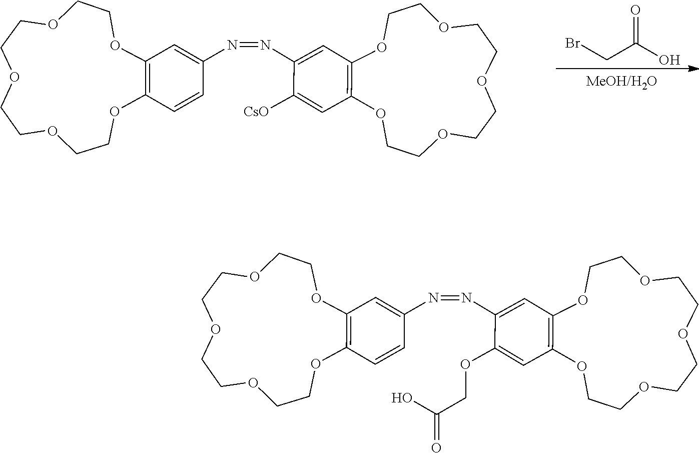

Bromoacetic acid (0.69 g, 5 mmol) was added to a stirred suspension of the cesium salt (5 mmol) in a mixture of methanol (90 mL) and water (90 mL). The reaction mixture was stirred at RT for 65 h until starting materials disappeared, TLC monitoring. Methanol was evaporated, and the crude product was extracted to dichloromethane until the aqueous phase was almost colorless. Dichloromethane was evaporated, and 20 ml of saturated cesium carbonate and 20 ml of ethyl acetate were added, the aqueous phase was acidified dropwise with diluted HCl solution, affording a yellow powder. Yield 2.89 g (90%). 1H NMR (DMSO-d6), δ 11.08 (s, 1H) 7.55 (dd, 1H, J=8.4 Hz, J=2.4 Hz), 7.45 (d, 1H, J=2.4 Hz), 7.38 (s, 1H), 6.94 (d, 1H, J=8.4 Hz), 6.76 (s, 1H), 4.93 (d, 2H, J=2.4 Hz), 4.69 (s, 2H) 4.24-4.17 (m, 8H), 3.96-3.89 (m, 8H), 3.78-3.76 (m, 16H) ppm.

### Example 5

### Alkylation of phenol-bisazocrownether

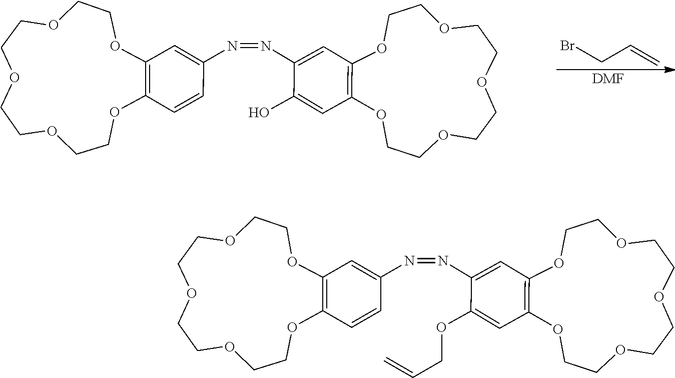

Allyl bromide (0.36 g, 3 mmol) was added to a solution of phenol-bisazocrownether (1.7 g,3 mmol) in 30 ml of DMF in the presence of 2 g of Cs₂CO₃. The reaction mixture was stirred at 60° C. until starting materials disappeared—77 h, TLC monitoring. The solvent was evaporated, the crude product was put in a dichloromethane/water mixture and stirred until the aqueous phase was almost colorless. Dichloromethane was evaporated, affording a yellow oil. The oil was crystallized from dioxane to get yellow powder. Yield 1.80 g (86%). MW=618 (LCMS). 1H NMR (DMSO-d6), δ 7.52 (dd, 1H, J=8.4 Hz, J=2.4 Hz), 7.47 (d, 1H, J=2.4 Hz), 7.38 (s, 1H), 6.95 (d, 1H, J=8.4 Hz), 6.73 (s, 1H), 5.74 (m, 1H), 5.42 (m, 1H), 5.13 (m, 1H), 4.79 (m, 2H), 4.24-4.17 (m, 8H), 3.96-3.89 (m, 8H), 3.78-3.76 (m, 16H) ppm.

### Examples 6A-6C

### Sulfonation of phenol-bisazocrownether

### Example 6 Å

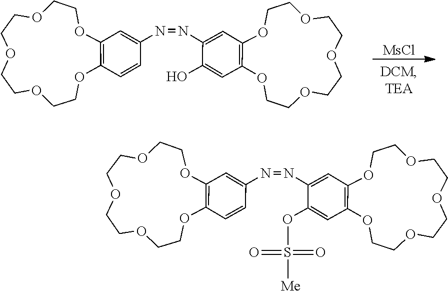 [SMILES: "MsCl" ; Oc1cc2c(cc1/N=N\c1ccc3c(c1)OCCOCCOCCOCCO3)OCCOCCOCCOCCO2 ; CS(=O)(=O)Oc1cc2c(cc1/N=N\c1ccc3c(c1)OCCOCCOCCOCCO3)OCCOCCOCCOCCO2]

Mesyl chloride (0.34 g, 3 mmol) in 5 ml of dichloromethane was added slowly to precooled (0° C.) solution of phenol-bisazocrownether (1.7 g, 3 mmol) in 20 ml of dichloromethane in the presence of 3 mmol of triethylamine. The reaction mixture was stirred for 1 h at 40° C. until starting materials disappeared—24 h, TLC monitoring. To crude product put in dichloromethane/water mixture (200 ml) and stirred, washed with 30 ml portions water until aqueous phase almost colorless. Phase separated. Dichloromethane dried with MgSO₄, evaporated, affording a yellow oil. Yield 1.25 g (83%). MW=656 (LCMS). 1H NMR (CDCl₃), δ 7.55 (s, 1H), 7.52 (s, 1H), 7.42 (s, 1H), 7.47 (d, 1H, J=8.4 Hz), 6.95 (d, 1H, J=8.4 Hz), 4.23 (t, 8H), 3.94 (t, 8H), 3.78 (m, 16H), 3.51 (s, 3H) ppm.

### Example 6 B

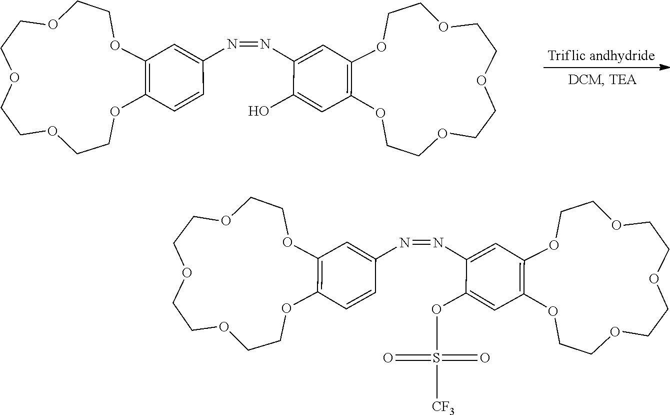 [SMILES: Oc1cc2c(cc1/N=N\c1ccc3c(c1)OCCOCCOCCOCCO3)OCCOCCOCCOCCO2 ; "Triflic andhydride" ; O=S(=O)(Oc1cc2c(cc1/N=N\c1ccc3c(c1)OCCOCCOCCOCCO3)OCCOCCOCCOCCO2)C(F)(F)F]

Triflic anhydride (0.85 g, 3 mmol) in 5 ml of dichloromethane was added slowly to precooled (0° C.) solution of phenol-bisazocrownether (1.7 g, 3 mmol) in 20 ml dichloromethane in presence of 7 mmol of Triethylamine. The reaction mixture was stirred for 1 h at 0° C. Then for twenty-four hours at RT until starting materials disappeared (under TLC monitoring). To crude product put in dichloromethane/water mixture (200 ml) and stirred, washed with 30 ml portions water until aqueous phase almost colorless. Phase separated. Dichloromethane dried with MgSO₄, evaporated, affording a yellow oil. Yield 1.85 g (89%). MW=710 (LCMS). 1H NMR (CDCl₃), δ 7.55 (s, 1H), 7.52 (s, 1H), 7.42 (s, 1H), 7.47 (d, 1H, J=8.4 Hz), 6.95 (d, 1H, J=8.4 Hz), 4.23 (t, 8H), 3.94 (t, 8H), 3.78 (m, 16H) ppm. ¹⁹F NMR (CDCl₃) 5-74.11 ppm.

### Example 6 C

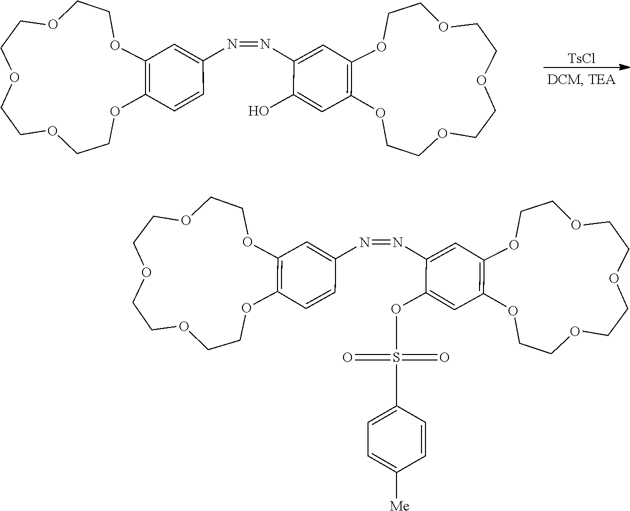 [SMILES: Oc1cc2c(cc1/N=N\c1ccc3c(c1)OCCOCCOCCOCCO3)OCCOCCOCCOCCO2 ; "TsCl" ; Cc1ccc(S(=O)(=O)Oc2cc3c(cc2/N=N\c2ccc4c(c2)OCCOCCOCCOCCO4)OCCOCCOCCOCCO3)cc1]

Tosyl chloride (0.57 g, 3 mmol) in 5 ml of dichloromethane was added slowly to precooled (0° C.) solution of phenol-bisazocrownether (1.7 g, 3 mmol) in 20 ml dichloromethane in presence of 3 mmol of triethylamine. The reaction mixture was stirred for 1 h at 0° C., and then for twenty-four hours at 40° C. until starting materials disappeared (under TLC monitoring). The crude product was put in dichloromethane/water mixture (200 ml) and stirred, washed with 30 ml portions water until aqueous phase almost colorless. Phase separated. Dichloromethane was dried over MgSO₄ and evaporated, affording a yellow powder. Yield 1.89 g (93%). MW=690 (LCMS). 1H NMR (CDCl₃), δ 7.55 (s, 1H), 7.52 (s, 1H), 7.42 (s, 1H), 7.47 (d, 1H, J=8.4 Hz), 7.20 (d, 2H, J=8.3 Hz), 7.11 (d, 2H, J=8.3 Hz), 6.95 (d, 1H, J=8.4 Hz), 4.23 (t, 8H), 3.94 (t, 8H), 3.78 (m, 16H), 2.65 (s, 3H) ppm.

### Example 7A-7B

### Synthesis of Secondary Amine-Substituted Bisazocrownether

### Example 7 Å

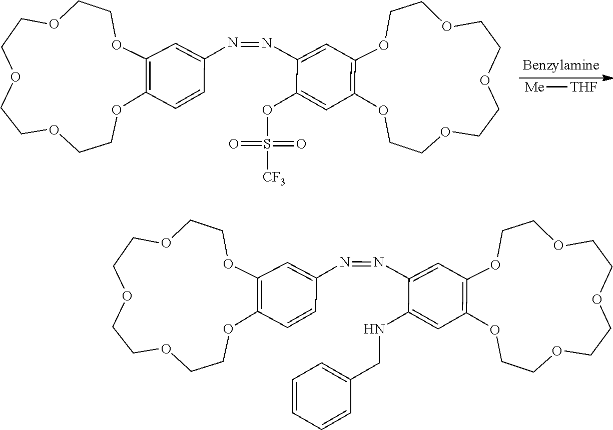

200 mg (0.28 mmol) of triflate bisazocrownether was dissolved in 20 ml of 2-MethylTHF under argon, 30 mg of benzylamine (0.28 mmol), 10 mg (0.036 mmol) of Ni(COD)₂, 40 mg (0.14 mmol) of tricyclohexylphosphine and 35 mg of Potassium tert-butoxide were charged in flask under inert atmosphere also. The mixture was refluxed until starting material was not detected by TLC. The solvent was evaporated and the mixture was chromatographed. Yield of product with MW=667 (LCMS) 155 mg (73%). 1H NMR (CDCl₃), δ 7.54 (dd, 1H, J=8.4 Hz, J=2.4 Hz), 7.48 (d, 1H, J=2.4 Hz), 7.39 (s, 1H), 7.33-7.07 (m, ar, 5H), 6.95 (d, 1H, J=8.4 Hz), 6.73 (s, 1H), 4.24-4.17 (m, 8H), 3.96-3.89 (m, 8H), 3.78-3.76 (m, 16H), 3.86 (s, 2H), 1.40 (s, 1H, N—H) ppm.

### Example 7 B

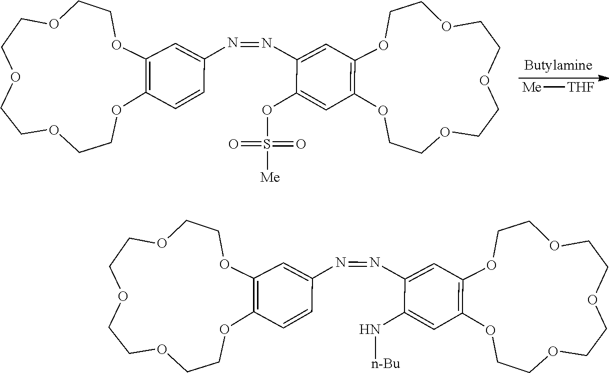

183 mg (0.28 mmol) of mesylate bisazocrownether was dissolved in 25 ml of 2-MethylTHF under argon, 20 mg of butylamine (0.28 mmol), 18 mg (0.028 mmol) of Pd(dba) 2, 35 mg (0.063 mmol) of DPPF, and 77 mg (0.8 mmol) of NaO-t-Bu and charged in flask under inert atmosphere also. The mixture was refluxed until starting material was not detected by TLC. The solvent was evaporated, and the mixture was chromatographed. Yield of product with MW=663 (LCMS) 110 mg (59%). 1H NMR (CDCl₃), δ 7.54 (dd, 1H, J=8.4 Hz, J=2.4 Hz), 7.48 (d, 1H, J=2.4 Hz), 7.39 (s, 1H), 6.95 (d, 1H, J=8.4 Hz), 6.73 (s, 1H), 4.24-4.17 (m, 8H), 3.96-3.89 (m, 8H), 3.78-3.76 (m, 16H), 3.5 (t, 2H), 1.54 (m, 2H), 1.47 (s, 1H, N—H) 1.20 (m, 2H), 0.93 (t, 3H) ppm.

### Example 8

### Synthesis of Primary Amine-Substituted Bisazocrownether

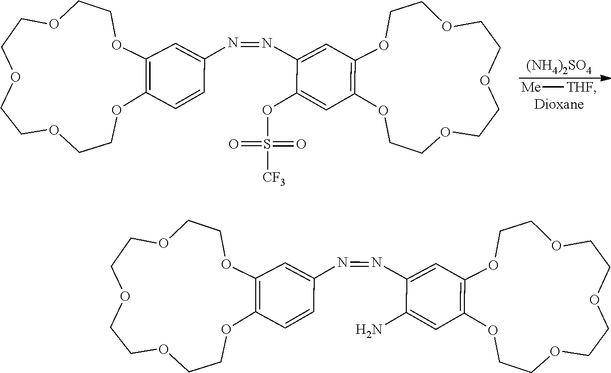

400 mg of triflate bisazocrownether (0.59 mmol), ammonium sulfate (0.90 mmol), Pd[P(o-tol)_{3]2} (6.0 μmol, 1.0 mol %), CyPF-tBu (6.0 μmol, 1.0 mol %), NaOtBu (2.80 mmol), 1,4-dioxane:2-methyl-THF (1:1) (8 mL); 95° C., 24 h. Isolated yields by chromatography 95 and 93% respectively for these substrates affording material with MW=577 (LCMS). 1H NMR (CDCl₃), δ 7.56 (dd, 1H, J=8.4 Hz, J=2.4 Hz), 7.48 (d, 1H, J=2.4 Hz), 7.40 (s, 1H), 6.95 (d, 1H, J=8.4 Hz), 6.73 (s, 1H), 4.24-4.17 (m, 8H), 3.96-3.89 (m, 8H), 3.78-3.76 (m, 16H), 3.59 (s, 2H, N—H) ppm.

### Example 9

### Synthesis of Bisazocrownether by Oxidation

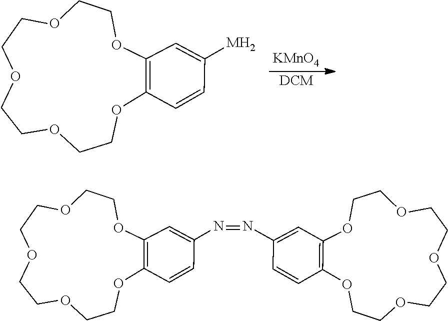

KMnO₄ (1.23 g) was added to a solution of commercially available aminobenzocrown ether (350 mg) in DCM 20 ml at RT and stirred overnight. The precipitate was filtered off, the solution was evaporated and treated with ether, the product was filtered.

Yield of 15-200 mg (29%) MW=562 (LCMS). 1H NMR (CDCl₃), δ 7.54 (dd, 1H, J=8.4 Hz, J=2.4 Hz), 7.48 (s, 1H), 6.95 (d, 1H, J=8.4 Hz), 4.23 (t, 4H), 3.94 (t, 4H), 3.78 (m, 8H) ppm.

### Example 10

### Syntheses of Ester and Diacid-Substituted Bisazocrownethers

### Example 10 Å

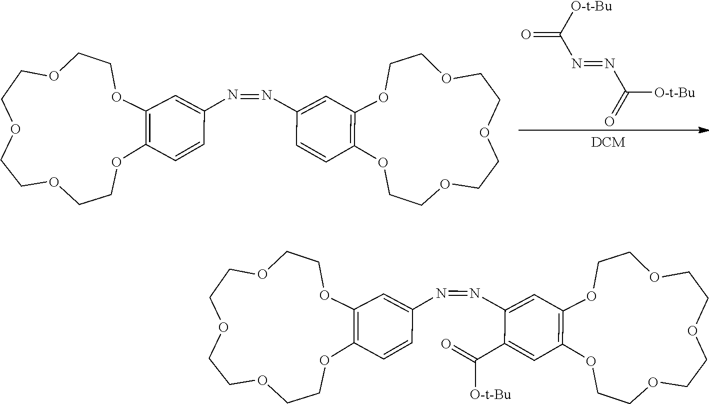

tert-Butyl diazoacetate (50 mg) was added to mixture of unsubstituted bisazocrownether obtained in previous example (50 mg), Cu(OAc)₂ (20 mg), PTSA (30 mg) and Pd(OAc)₂ (5 mg) in DCM at RT and stirred at 40° C. for 48 h. After column purification yield 43 mg (78%) of product characterized in LCMS by MW=662. ¹H NMR (CDCl₃), δ 7.55 (s, 1H), 7.52 (s.1H), 7.42 (s, 1H), 7.47 (d, 1H, J=8.4 Hz), 6.95 (d, 1H, J=8.4 Hz), 4.23 (t, 8H), 3.94 (t, 8H), 3.78 (m, 16H), 1.44 (s, 9H) ppm.

### Example 10 B

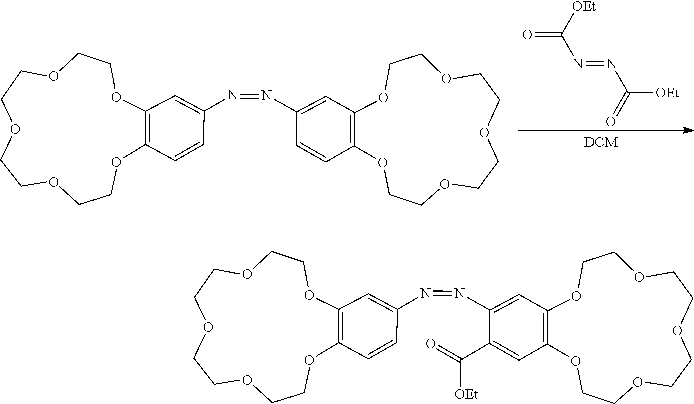 [SMILES: c1cc2c(cc1/N=N\c1ccc3c(c1)OCCOCCOCCOCCO3)OCCOCCOCCOCCO2 ; CCOC(=O)/N=N/C(=O)OCC ; CCOC(=O)c1cc2c(cc1/N=N\c1ccc3c(c1)OCCOCCOCCOCCO3)OCCOCCOCCOCCO2]

Ethyl diazoacetate (35 mg) was added to mixture of unsubstituted bisazocrownether obtained in previous example (50 mg), Cu(OAc)₂ (20 mg), PTSA (30 mg) and Pd(OAc)₂ (5 mg) in DCM at RT and stirred at 40° C. for 48 h. After column purification Yield 56 mg (89%) of product characterized in LCMS by MW=634. ¹H NMR (CDCl₃), δ 7.55 (s, 1H), 7.52 (s.1H), 7.42 (s, 1H), 7.47 (d, 1H, J=8.4 Hz), 6.95 (d, 1H, J=8.4 Hz), 4.23 (t, 8H), 4.17 (q, 2H), 3.94 (t, 8H), 3.78 (m, 16H), 1.30 (t, 3H) ppm.

### Example 10 C

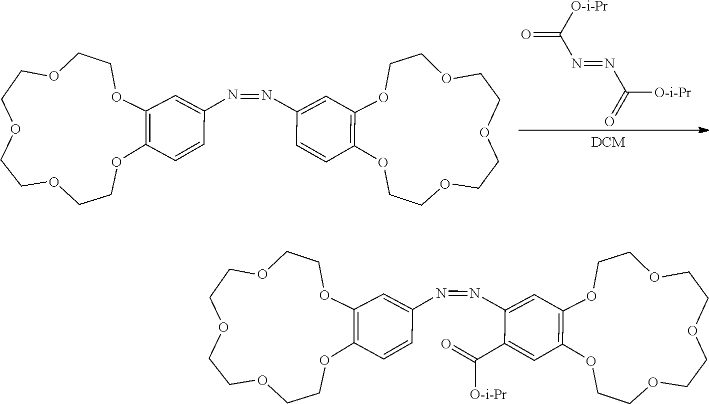

Isopropyl diazoacetate (45 mg) was added to mixture of unsubstituted bisazocrownether obtained in previous example (50 mg), Cu(OAc)₂ (20 mg), PTSA (30 mg) and Pd(OAc)₂ (5 mg) in DCM at RT and stirred at 40° C. for 48 h. After column purification Yield 57 mg (93%) of product characterized in LCMS by MW=648. ¹H NMR (CDCl₃), δ 7.55 (s, 1H), 7.52 (s, 1H), 7.42 (s, 1H), 7.47 (d, 1H, J=8.4 Hz), 6.95 (d, 1H, J=8.4 Hz), 4.23 (t, 8H), 4.07 (m, 1H), 3.94 (t, 8H), 3.78 (m, 16H), 1.24 (d, 6H) ppm.

### Example 10 D

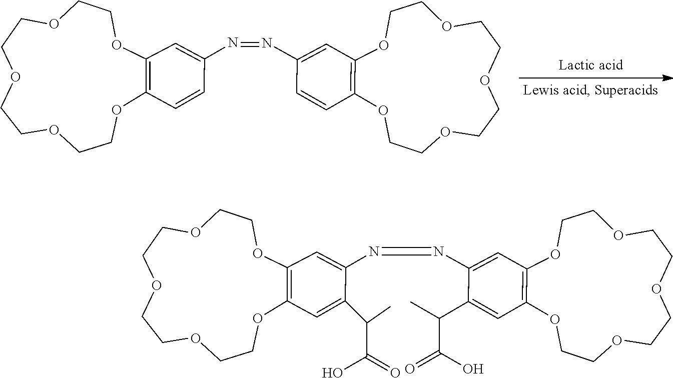 [SMILES: c1cc2c(cc1/N=N\c1ccc3c(c1)OCCOCCOCCOCCO3)OCCOCCOCCOCCO2 ; CC(C(=O)O)c1cc2c(cc1/N=N\c1cc3c(cc1C(C)C(=O)O)OCCOCCOCCOCCO3)OCCOCCOCCOCCO2]

2 g of unsubstituted bisazocrownether (3.5 mmol) was mixed in acetonitrile (30 ml) with 0.9 g (10 mmol) commercial (90%) lactic acid in presence of 3 g (1 mmol) of acidic catalyst H₃PW₁₂O₄₀·12H₂O (commercial). The mixture was stirred upon heating to 80° C. for 5 h. Acetonitrile was evaporated. Water and dichloromethane were added. The organic phase was separated and the solvent was evaporated. Product worked up with sodium carbonate and crystallized upon addition of a solution of the citric acid. The yellow precipitate was obtained with a yield of 0.45 g (18%). MW=706 (LCMS). 1H NMR (CDCl₃), δ 7.83 (s, 1H), 7.66 (s, 1H), 4.06 (t, 8H), 3.95 (t, 8H), 3.64 (q, 1H), 1.56 (d, 3H) ppm.

### Example 11

### Synthesis of Monoacid-Substituted Bisazocrownether

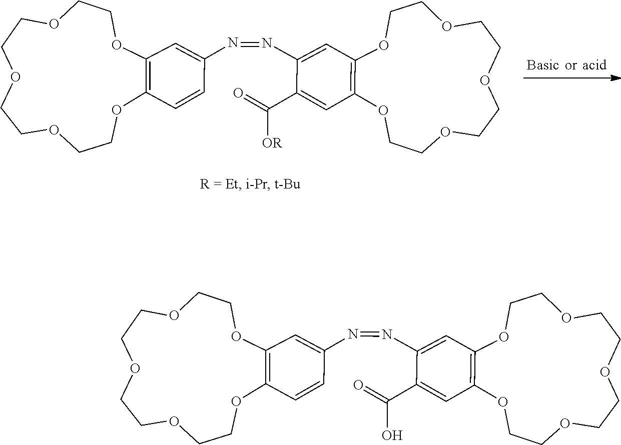

Hydrolysis of all three esters may be done upon the basic or acidic condition. In all cases, desirable acid was obtained with 40-90% yields depending on the nature of ester and hydrolysis condition characterized in LCMS with MW=606. ¹H NMR (DMSO-d6), δ 11.04 (s, 1H), 7.55 (s, 1H), 7.52 (s, 1H), 7.42 (s, 1H), 7.47 (d, 1H, J=8.4 Hz), 6.95 (d, 1H, J=8.4 Hz), 4.23 (t, 8H), 3.94 (t, 8H), 3.78 (m, 16H) ppm.

### Example 12

### Formylation of Unsubstituted Bisazocrownether

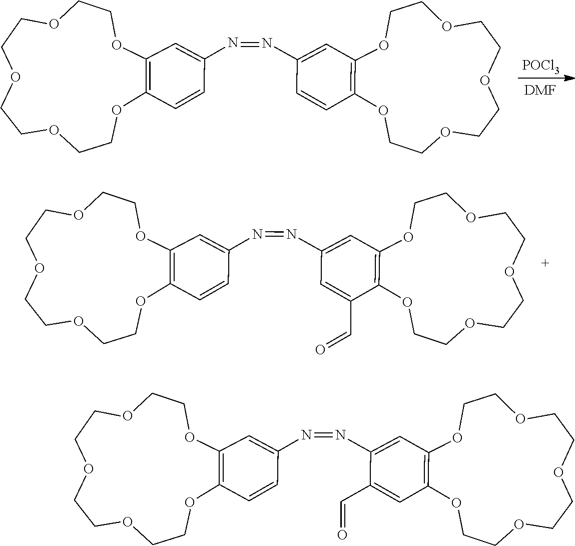

3 g of unsubstituted bisazocrownether (5.6 mmol) in 5 ml of DMF was added dropwise into precooled to −5° C. mixture of 10 ml of DMF and 3 ml of POCl₃. When the addition of the crownether is complete precipitate, the reaction mixture is heated on a steam bath, and stirring is continued for 2 h. The yellow precipitate is redissolved when heating is begun. The mixture is then cooled and poured over 100 g of crushed ice. After the ice melted, a solution is neutralized to pH 8 by the dropwise addition of approximately 200 ml of saturated aqueous sodium acetate. The product started to precipitate. The neutral mixture is stored in the refrigerator overnight. The yellow crystalline precipitate is filtered by suction and washed several times with water on the filter. LCMS analysis shows a mixture of few products with MW 590 and 618 (bisformylation).

Preparative HPLC was applied and compounds N-α- and N-β-formylated compounds were isolated with MW 590:

N-β-formylated, yield 0.7 g, 1H NMR (CDCl₃), δ 10.89 (s, 1H), 7.54 (dd, 1H, J=8.4 Hz, J=2.4 Hz), 7.48 (d, 1H, J=2.4 Hz), 7.39 (s, 1H), 6.95 (d, 1H, J=8.4 Hz), 4.24-4.17 (m, 8H), 3.96-3.89 (m, 8H), 3.78-3.76 (m, 16H), N-α-formylated, Yield 0.9 g, 1H NMR (CDCl₃), δ 10.84 (s, 1H), 7.55 (s, 1H), 7.52 (s, 1H), 7.42 (s, 1H), 7.47 (d, 1H, J=8.4 Hz), 6.95 (d, 1H, J=8.4 Hz), 4.23 (t, 8H), 3.94 (t, 8H), 3.78 (m, 16H) ppm.

### Example 13

### Oxidation of Aldehyde Monosubstituted Bisazocrownether to Acid

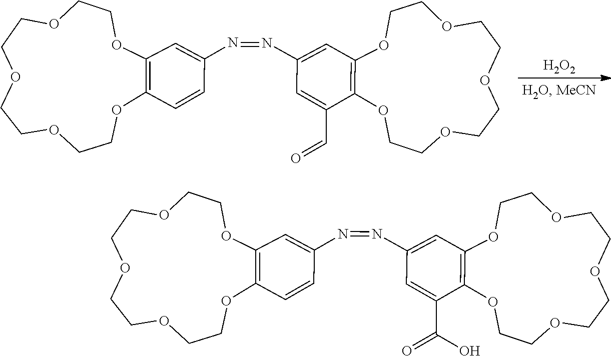

200 mg (0.3 mmol) of N-β-aldehyde bisazocrownether upon action of (0.9 mmol) of 30% H₂O₂ in presence of 45 mg of VO(acac)₂ in mixture acetonitrile-water 9:1 (10 ml) at RT during 12 h yielded 160 mg (78%). with MW 606 (LCMS). 1H NMR (DMSO-d6), δ 11.0 (s, 1H), 7.54 (dd, 1H, J=8.4 Hz, J=2.4 Hz), 7.48 (d, 1H, J=2.4 Hz), 7.39 (s, 1H), 6.95 (d, 1H, J=8.4 Hz), 4.24-4.17 (m, 8H), 3.96-3.89 (m, 8H), 3.78-3.76 (m, 16H) ppm.

### Example 14

### Synthesis of Diacid-Substituted Bisazocrownether by Oxidative Amination

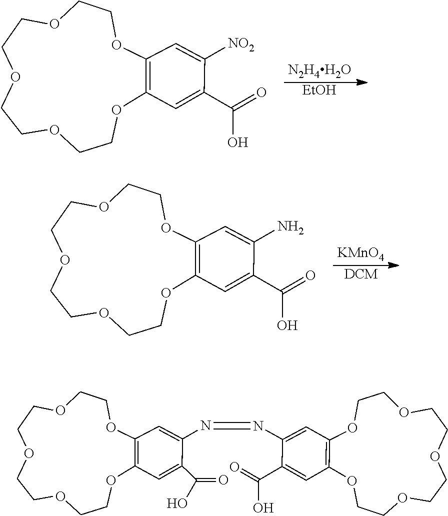

### Step A.

2.1 g (5.9 mmol) of Nitro carboxy benz-5-crown-15 ether (that was prepared according to literature procedure, Toke, 1988) was dissolved in 80 ml of ethanol. Hydrazine hydrate (20 ml) was added dropwise to the mixture of starting material and 10% Pd/C (0.5 g) in ethanol (40 ml) with stirring at 70° C. for 4 h. Pd/C was filtered off and the solution was evaporated. The yield of aminocarboxy benz-5-crown-15 ether—1.78 g (93%). MW=327 (LCMS). 1H NMR (CDCl₃), δ 7.83 (s, 1H), 7.49 (s, 1H), 4.09 (t, 8H), 3.94 (t, 8H) ppm.

### Step B.

Oxidative formation of bisacidazabiscrown ether was done using KMnO₄ as an oxidant. 1.3 g of material preparing in step 1 (4 mmol) was dissolved in 90 ml of dichloromethane, 1.89 g (12 mmol) of KMnO₄ was added and the mixture was stirred for 48 h at room temperature. The precipitate was filtered. The solvent was evaporated. Ether was added to residue forming a yellow powder. Yield—0.85 g (65%). MW=650 (LCMS). ¹H NMR (CDCl₃), δ 7.90 (s, 1H), 7.45 (s, 1H), 4.08 (t, 8H), 3.98 (t, 8H) ppm.

### Examples 15A and 15B

### Salt Removal from Water

Desalination with diazobiscrownether functionalized nanoparticles was performed when functionalized nanoparticles were added to distilled water with a known amount of NaCl and stirred for several hours. The sample was then “magnetically filtered” to separate the nanoparticles from the water (by placing a magnet externally at the bottom of the vessel and decanting the water). The presence and quantification of remaining NaCl in the filtrate was determined using the Mohr method. Results are summarized in Table 1.

The nanoparticles were then added to a double distilled water and the mixture was exposed to UV light (400 nm wavelength) for 5 to 20 min, using SCHOTT KL1500 Electronic 150 watt halogen lamp with optic fiber and a UV filter to receive 400 nm wavelength, and then filtered. An aliquot was taken and titrated for quantification of NaCl. It was found that around half of the NaCl, was released into the water upon UV radiation. Results are summarized in Table 1.

A second capture test with the used nanoparticles on the salt solution obtained after the release step showed that the used nanoparticles achieve good removal rate of alkali metal from the solution. On exposure to UV radiation, the captured amount of alkali metal is released almost entirely.

Titration of chloride was done by Mohr method using 1 mL of 5% potassium chromate solution as an indicator.

Before every titration, the concentration of the titrant (argentum nitrate) was tested and calibrated on a sample of water with a known amount of NaCl.

### Summary of the Functionalized Nanoparticles Activity Upon Capture and Release of Sodium Ions.

TABLE 1
Summary of the functionalized nanoparticles activity
upon capture and release of sodium ions (mmol).

| | NaCl | 1^{st} | 1^{st} | NaCl | 2^{nd} | 2^{nd} |
|---|---|---|---|---|---|---|
| nanoparticles | initial | catch | release | initial | catch | release |
| Example 15A | 0.47 | 0.435 | 0.245 | ~ 0.245 | 0.154 | 0.154 |
| 3.24 g | mmol | mmol | mmol | mmol | mmol | mmol |
| Example 15B | 0.35 | 0.3 | 0.144 | ~ 0.144 | 0.148 | 0.14 |
| 2.257 g | mmol | mmol | mmol | mmol | mmol | mmol |

~ because of a small loss due to aliquot removal

The surface modified magnetic nanoparticles having crown ether covalently bonded on their surface, which were tested in this experiment, were prepared in the following way:

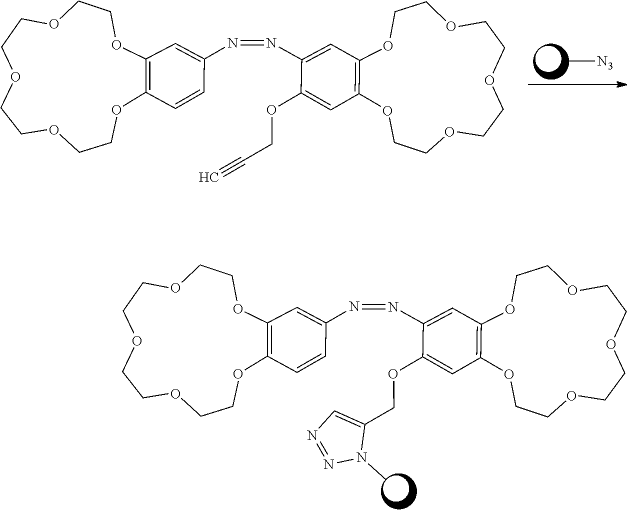

5 g of azidomodified nanoparticle (Turbobeads LLC) with loading 0.1 mmol/g, 0.5 mmol were mixed in water with 400 mg of 0-propargyl diazobiscrown ether (of Example 3; 0.54 mmol) in the presence of 30 mg of Cu(NO₃)₂·6H₂O and 85 mg of ascorbic acid. After stirring at 65° C. for 3 h nanomaterial was extracted by applying an external magnet, washed with water, methanol, acetone and dried on air.

### Example 16

### Preparation of Surface Modified Magnetic Nanoparticle Having a Crown Ether Covalently Bonded on its Surface and Testing its Action in Water Treatment

### Preparation:

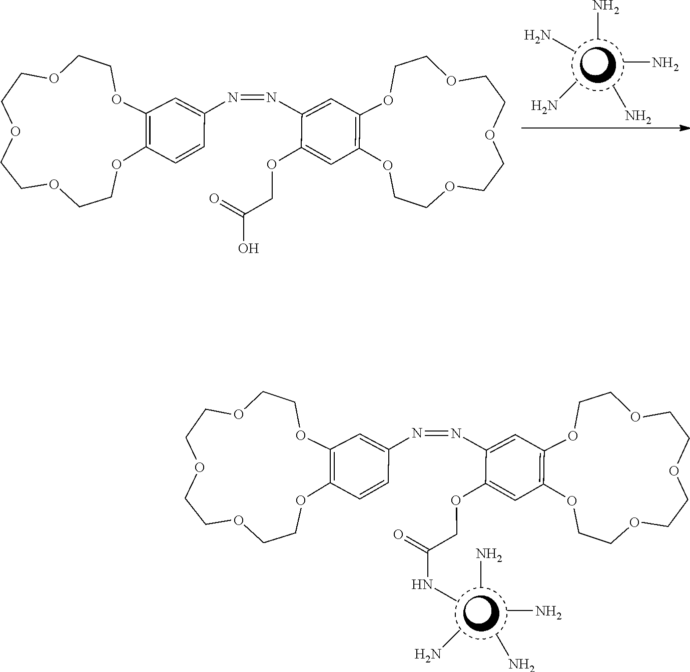

1.16 g of aminomodified nanoparticles with loading 3 mmol/g preparation 3 were mixed in water with 1.35 g of 0-acetic acid diazobiscrown ether prepared in Example 4 (3.38 mmol) in presence of 2 g of HOBT*hydrate and 2 g of EDCI in 100 ml water. After stirring at 45° C. for 18 h nanomaterial was extracted by applying an external magnet, washed with water, methanol, acetone and dried on air.

Test: the test protocol was as described in Example 15. The results are set out in Table 2.

TABLE 2
Summary of the amine functionalized nanoparticles
activity upon capture and release of sodium ions (mmol).

| | NaCl | 1^{st} | 1^{st} | NaCl | 2^{nd} | 2^{nd} |
|---|---|---|---|---|---|---|
| nanoparticles | initial | catch | release | initial | catch | release |
| Example 16A | 2.9 | 2.85 | 1.39 | ~1.39 | 1.31 | 1.3 |
| 1.0 g | | | | | | |
| Example 16B | 2.98 | 2.93 | 1.38 | ~1.38 | 1.34 | 1.32 |
| 1.2 g | | | | | | |

~because of a small loss due to aliquot removal

### Example 17

### Preparation of Surface Modified Magnetic Nanoparticle Having a Crown Ether Covalently Bonded on its Surface and Testing its Action in Water Treatment

### Preparation

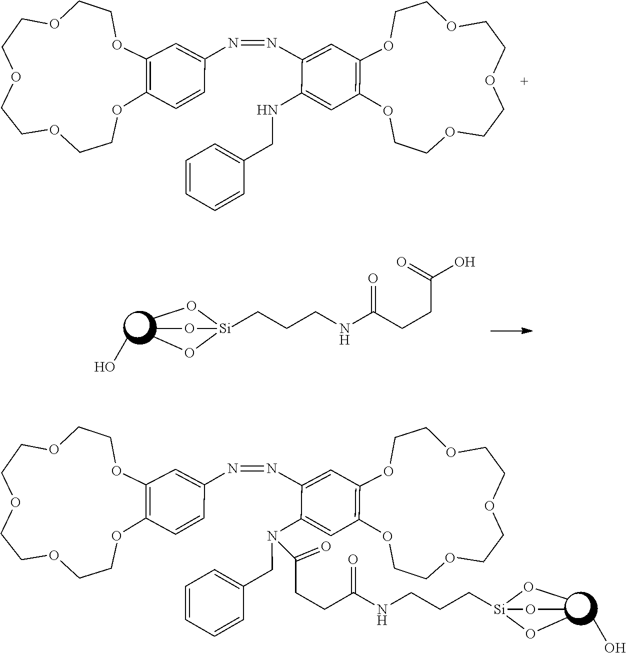

1.1 g of acid modified magnetic nanoparticle with loading 2.3 mmol/g (Preparation 2) were mixed in water with 1.68 g of N-benzylamine substituted-diazobiscrown ether obtained in Example 7A (2.5 mmol) in presence of 2 g of HOBT*hydrate and 2 g of EDCI in 100 ml of water. After stirring at 45° C. for 18 h nanomaterial was extracted by applying an external magnet, washed with water, methanol, acetone, and dried on air.

Test: the test protocol was as described in Example 15. The results are set out in Table 3.

TABLE 3
Summary of the acid modified nanoparticles activity
upon capture and release of sodium ions (mmol).

| | NaCl | 1^{st} | 1^{st} | NaCl | 2^{nd} | 2^{nd} |
|---|---|---|---|---|---|---|
| nanoparticles | initial | catch | release | initial | catch | release |
| Example 17A | 1.9 | 1.82 | 0.79 | ~0.79 | 0.74 | 0.71 |
| 1.0 g | | | | | | |
| Example 17B | 0.93 | 0.9 | 0.47 | ~0.47 | 0.45 | 0.45 |
| 0.5 g | | | | | | |

~because of a small loss due to aliquot removal

### Example 18

### Preparation of Surface Modified Magnetic Nanoparticle Having a Crown Ether Covalently Bonded on its Surface and Testing its Action in Water Treatment

### Preparation

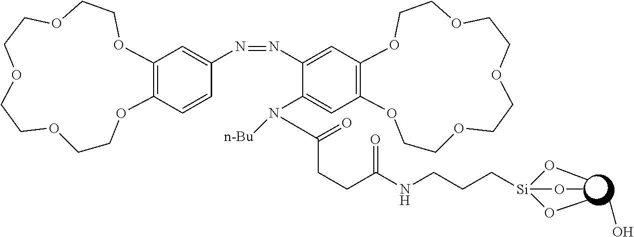

1.0 g of acid modified nanoparticle with loading 2.3 mmol/g (Preparation 2) were mixed in water with 1.54 g of N-butylamine diazobiscrown ether obtained in Example 7B (2.5 mmol) in the presence of 2 g of HOBT*hydrate and 2 g of EDCI in 100 ml of water. After stirring at 45° C. for 18 h nanomaterial was extracted by applying an external magnet, washed with water, methanol, acetone, and dried on air.

Test: the test protocol was as described in Example 15. The results are set out in Table 4.

TABLE 4
Summary of the acid modified nanoparticles activity
upon capture and release of sodium ions (mmol).

| | NaCl | 1^{st} | 1^{st} | NaCl | 2^{nd} | 2^{nd} |
|---|---|---|---|---|---|---|
| nanoparticles | initial | catch | release | initial | catch | release |
| Example 18A | 1.8 | 1.77 | 0.73 | ~0.73 | 0.69 | 0.68 |
| 1.0 g | | | | | | |
| Example 18B | 1.6 | 1.54 | 0.65 | ~0.65 | 0.63 | 0.61 |
| 0.9 g | | | | | | |

~because of a small loss due to aliquot removal

### Example 19

### Preparation of Surface Modified Magnetic Nanoparticle Having a Crown Ether Covalently Bonded on its Surface and Testing its Action in Water Treatment

Nanomaterial prepared as described in Example 18, was applied for capture-releasing experiments of potassium chloride, by the same test protocol.

TABLE 5
Summary of the acid modified nanoparticles activity
upon capture and release of potassium ions (mmol) .

| | KCl | 1^{st} | 1^{st} | KC1 | 2^{nd} | 2^{nd} |
|---|---|---|---|---|---|---|
| nanoparticles | initial | catch | release | initial | catch | release |
| 1.0 g | 1.7 | 1.64 | 0.71 | ~ 0.71 | 0.65 | 0.59 |
| 0.5 g | 0.84 | 0.81 | 0.39 | ~ 0.39 | 0.35 | 0.31 |

~ because of a small loss due to aliquot removal

### List of Abbreviations

APTES—aminopropyltriethoxysilane
CCU—command and control unit
COD—cyclooctadiene
DC—direct current
DCM—methylene chloride
DMF—Dimethylformamide
DPPF—1,1′-bis(diphenylphosphino)ferrocene
EDCI—1-Ethyl-3-(3-dimethylaminopropyl)carbodiimide
HOBt—hydroxybenzotriazole
IR—infra red
MNPs—magnetic nanoparticles
Ms—mesylate
NPs—nanoparticles
PSU—power supply unit
PTSA—≡TsOH≡tosylic acid, p-Toluenesulfonic acid hydrate
RF—radio frequency
RO—reverse osmosis
RT—room temperature
SUV—sport utility vehicle
TEA—triethylamine
TEOS—tetraethoxysilane
Tf—triflate
THF—Tetrahydrofuran
Ts—tosylate
UV—ultraviolet

1. Surface-modified magnetic particle having a crown ether covalently bonded on its surface through at least one linker: 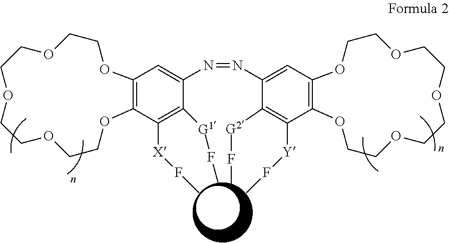
wherein the solid circle indicates the magnetic particle, n=0, 1, 2, and wherein each of F—X′, F-G¹′, F-G²′ and F—Y′ is a linker connecting the crown ether to the particle.

2. A surface-modified magnetic particle according to claim 1, wherein a single linker connects the crown ether to the nanoparticle, said linker being F-G²′ or F—Y′.

3. A surface-modified magnetic particle according to claim 1, comprising FesCh nanoparticle, and wherein the linker contains a linkage selected from
amide bond —C(O)NH— or —C(O)NR—, wherein R is selected from the group consisting of C1-C10 straight or branched optionally substituted alkyl, cycloalkyl, —(CH2)ₚ-optionally substituted aryl, wherein p is from a to 5, and —(CH2)ₚ-heteroaryl;
ether bond;
thioether bond;
imine bond —HC═N— or —RC═N—, wherein R is C1-C10 alkyl; ester bond —C(O)—O—; and
C3-C6 ring or heterocyclic group obtainable by cycloaddition reaction.

4. A surface-modified magnetic nanoparticle according to claim 3, selected from the group consisting of: 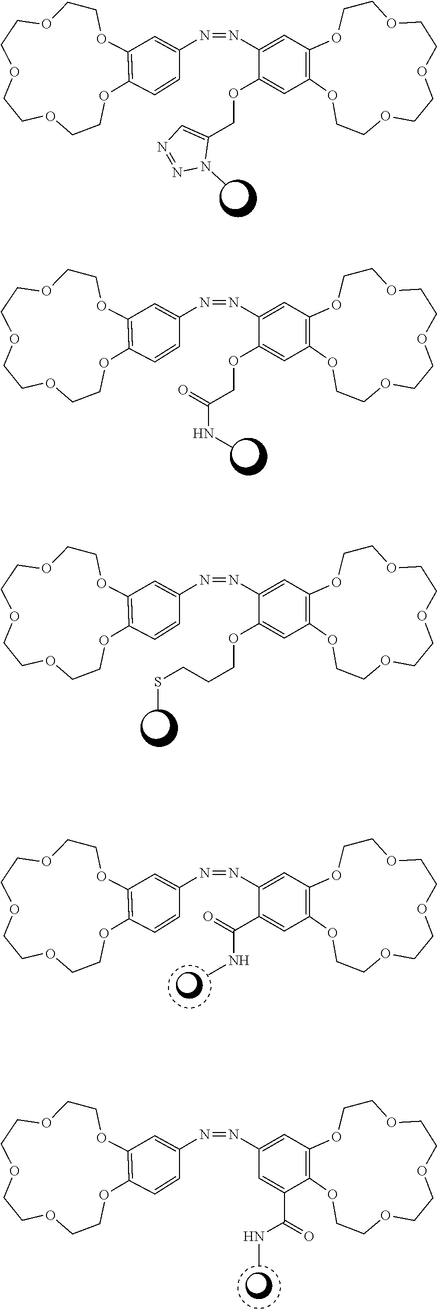 [SMILES: Cn1nncc1COc1cc2c(cc1/N=N\c1ccc3c(c1)OCCOCCOCCOCCO3)OCCOCCOCCOCCO2 ; CNC(=O)COc1cc2c(cc1/N=N\c1ccc3c(c1)OCCOCCOCCOCCO3)OCCOCCOCCOCCO2 ; CSCCCOc1cc2c(cc1/N=N\c1ccc3c(c1)OCCOCCOCCOCCO3)OCCOCCOCCOCCO2 ; CNC(=O)c1cc2c(cc1/N=N\c1ccc3c(c1)OCCOCCOCCOCCO3)OCCOCCOCCOCCO2 ; CNC(=O)c1cc(/N=N\c2ccc3c(c2)OCCOCCOCCOCCO3)cc2c1OCCOCCOCCOCCO2] 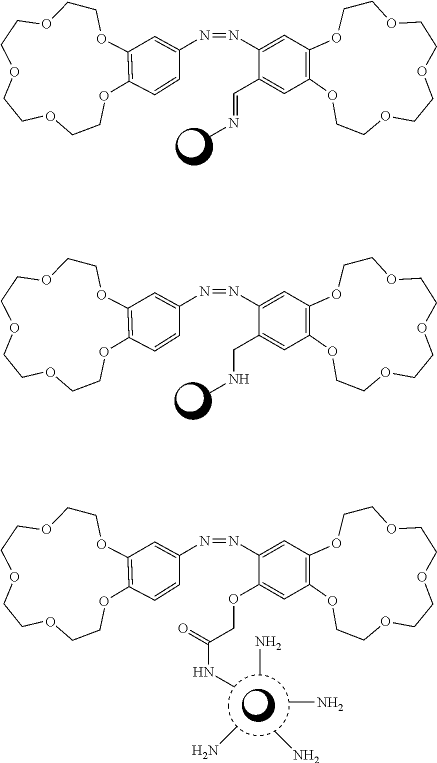
wherein the dashed line indicates a silanol layer applied onto the magnetic particle;

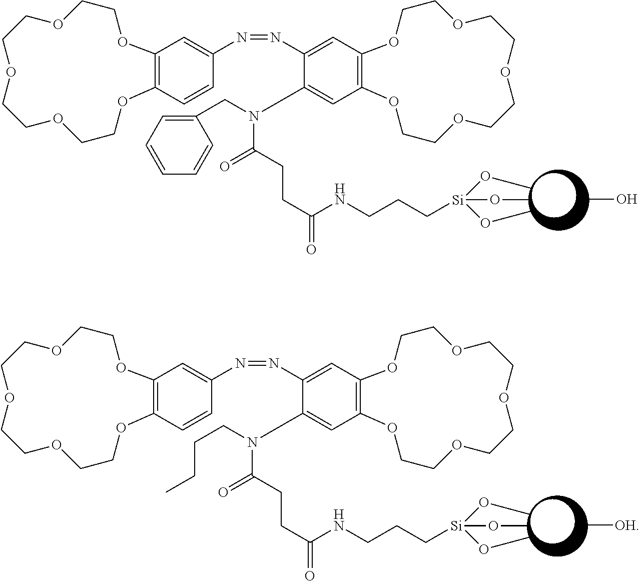

5. A system for purifying water comprising:
complexing units, each of said complexing units include a complexing site configured to bind a contaminant;
a reactor configured for mixing water containing said contaminant with said complexing units;
a concentrator configured for drawing said complexing units to a release area, said release area selected from inside of said reactor and is in communication with said reactor;
an energy source configured to direct energy to said release area causing said complexing sites to release a portion of said contaminant.

6. A system according to claim 5, wherein the complexing unit is connected to a nanoparticle by a covalent bond.

7. A system according to claim 6, wherein the complexing unit is crown ether, and is provided in the form of a surface-modified magnetic nanoparticle having the crown ether covalently bonded on its surface through at least one linker as defined by: 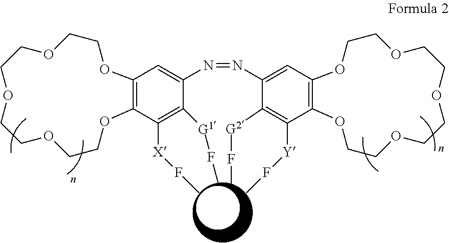
wherein the solid circle indicates the magnetic particle, n=0, 1, 2, and wherein each of F—X′, F-G¹′, F-G²′ and F—Y′ is a linker connecting the crown ether to the particle.

8. A system of claim 5, wherein said concentrator includes a magnet, wherein the magnet is an electromagnet or a permanent magnet.

9. A system according to claim 8, wherein the magnet is movable between a location near the release site for concentrating said particles and a location far from said release site for freeing said particles.

10. A system according to claim 5, wherein said energy source is configured to direct light to said release area.

11. A system according to claim 10, wherein said energy source includes at least one of a source of ultra violet light and a means to direct sunlight to said release area.

12. A process comprising: preparing a compound of Formula 1, 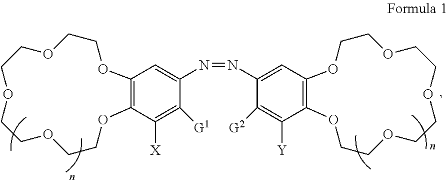
wherein, n=0, 1, 2;
G¹, G², X, Y are independently selected from H, —OH, —O-Metal, -GN, —R¹, —C(O)H—, —NH₂, —NHR², —N₃, —SH, —O—R³, —COOH, —COOR², —R⁴COOH, —R⁴COOR², —O(SO₂)—R⁵;
R¹ is optionally substituted alkyl, alkenyl or alkynyl;
R² is alkyl, cycloalkyl, aryl, and heteroaryl;
R³, is substituted alkyl, alkynyl, alkenyl;
R⁴ is linear or branched alkylene, oxo-substituted linear or branched alkylene; hydroxy-substituted linear or branched alkylene, linear or branched alkenylene;
R⁵ is alkyl, halogenated alkyl, aryl and heteroaryl,
and wherein at least one of G¹, G², X, Y is other than hydrogen or unsubstituted alkyl.

13. The process of claim 12, further comprising combining 4′-Aminobenzo-crown ether: 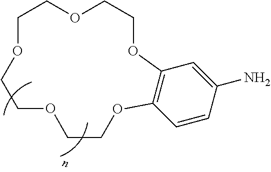
with nitrite source in an acid to form the corresponding diazonium salt: 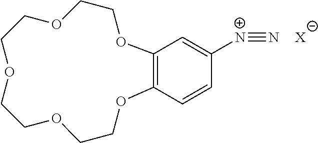
wherein X— is the counter anion supplied by the acid,
and reacting the diazonium salt with phenol-crown ether in the presence of alkali base to form the corresponding alkali phenoxide of Formula Ia: 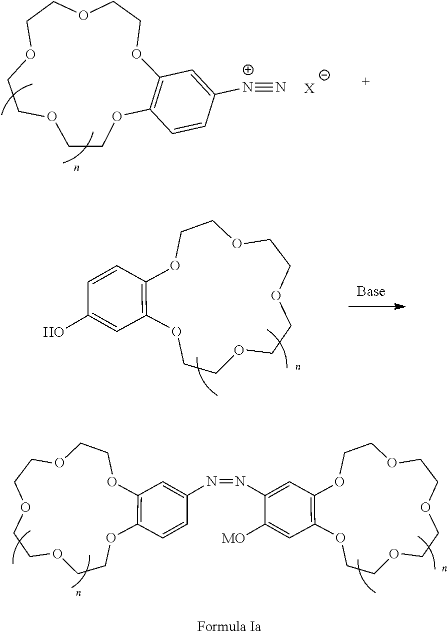
wherein M is the alkali metal.

14. A process according to claim 13, wherein the base is CS2CO3 and the alkali phenoxide is cesium phenoxide.

15. A process according to claim 13, further comprising a step of:
hydrolyzing the alkali phenoxide of Formula Ia to form the corresponding crown ether of Formula 1b

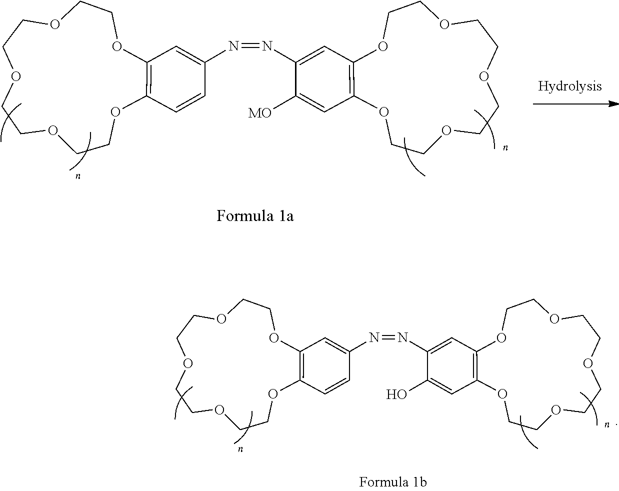

16. A process according to claim 13, further comprising a step of alkylating the alkali phenoxide of Formula Ia with haloalkyne or halo-carboxylic acid, or alkylating the crown ether of Formula 1b with haloalkene: 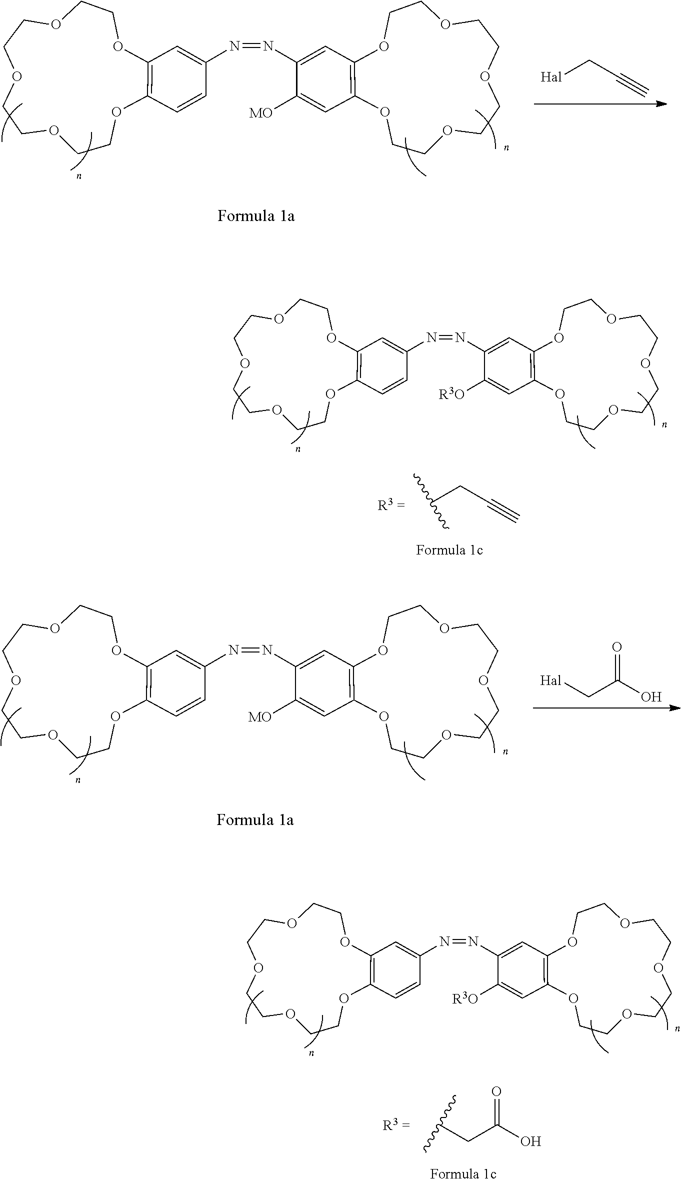 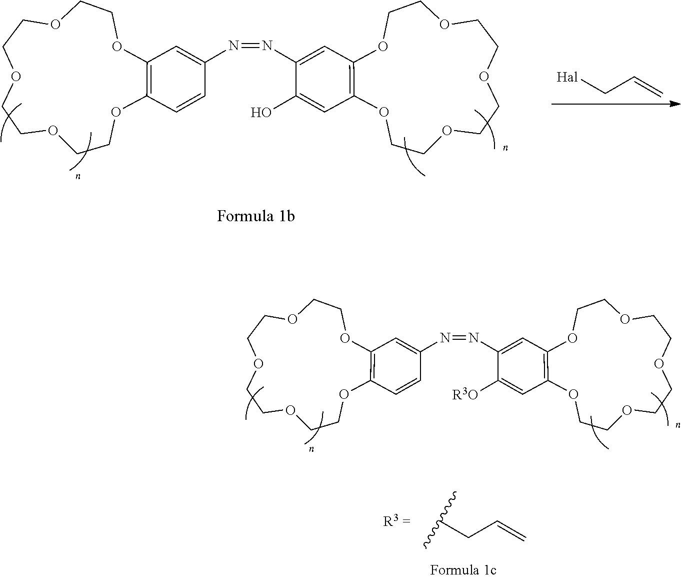
to form a compound of Formula 1 wherein G¹, X, Y are hydrogens and G² is —OR³, wherein R³ is selected from alkynyl, alkyl substituted with —COOH and alkenyl.

17. A process according to claim 15, further comprising the steps of:
a) transformation of the crown ether of Formula 1b into sulfonic ester: 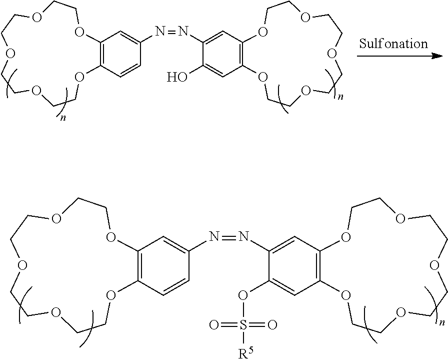
b) transition metal-catalyzed amination of the sulfonic ester to the corresponding secondary amine: 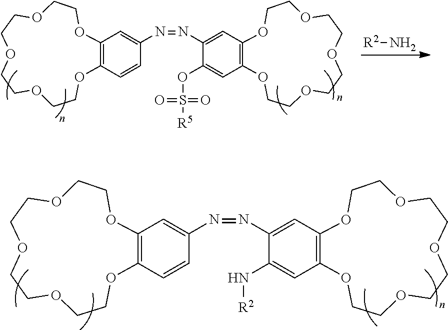
or
b2) transition metal-catalyzed coupling of the sulfonic ester with ammonia supplied in the form of an ammonium salt, in the presence of a strong non-nucleophilic base, to give the corresponding primary amine:

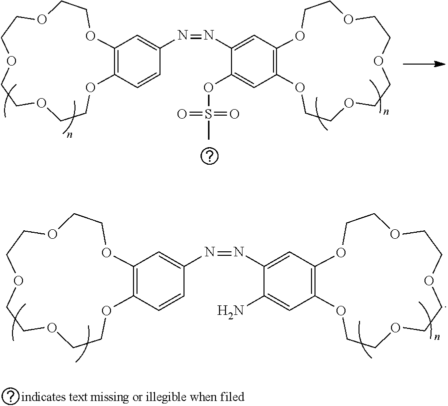

18. A process for preparing a compound of Formula 1 as defined in claim 12, further comprising:
a1) oxidizing 4-amino-crown-ether to form unsubstituted bisazocrown ether: 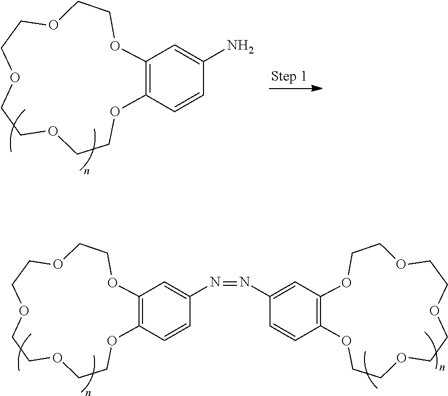
or
a2) reducing 4′-nitro-crown-ether to form unsubstituted bisazocrown ether: 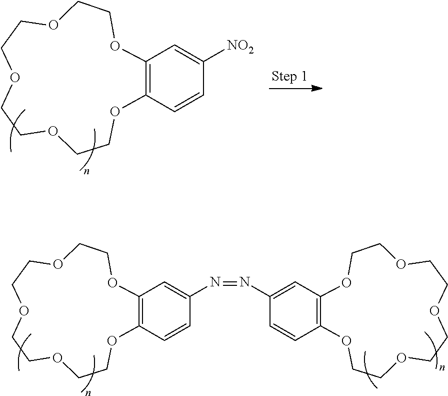
b1) reacting the unsubstituted bisazocrown ether obtained in step a1) or a2) with Alkyl-OOC—N═N—COO-Alkyl in the presence of transition metal catalyst, to form the corresponding ester of Formula Id: 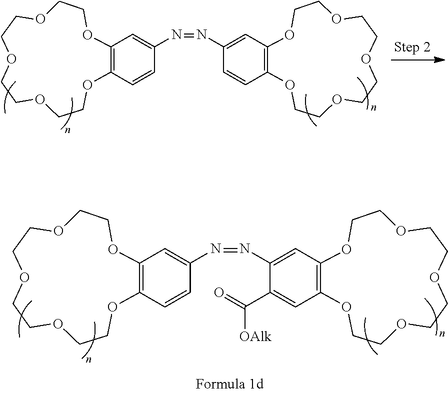
and optionally hydrolyzing the ester of Formula Id to the corresponding acid of Formula If: 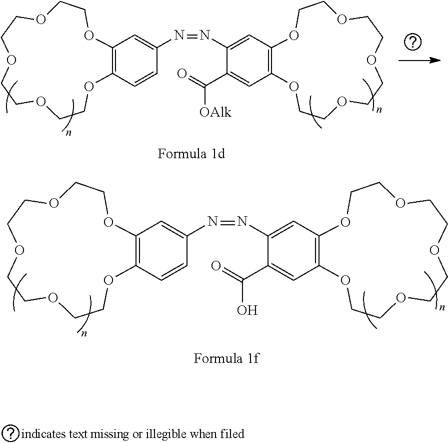
b2) formylation of the unsubstituted bisazocrown ether obtained in step a1) or a2), to form the corresponding isomers of the aldehyde of Formulas Ie and Ie′: 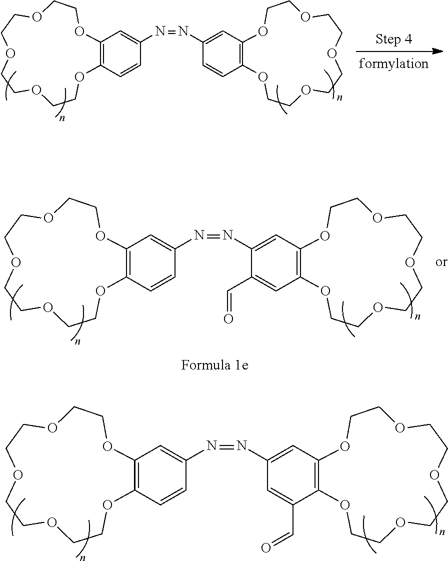
Formula Ie′ and optionally oxidizing the aldehyde of Formulas Ie and/or Ie′ to the corresponding acid of Formula If:

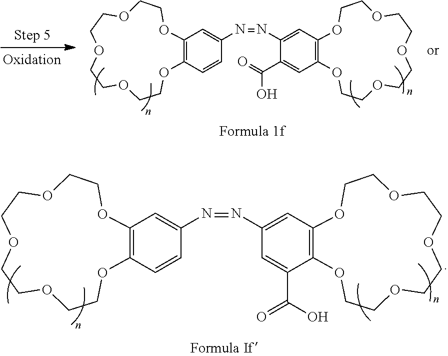

19. A process for preparing a compound of Formula 1 as defined in claim 12, wherein G¹ and G² are the same, further comprising:
reducing nitro-benzocrown ether having the structure: 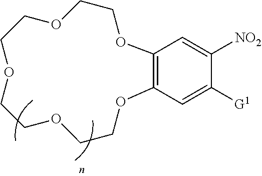
in an alkaline environment with zinc metal, to afford the compound of Formula 1: 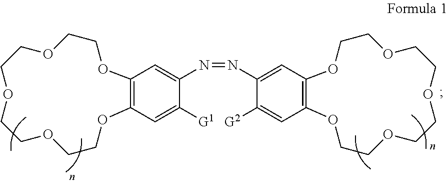
or
reducing the nitro-benzocrown ether to the corresponding amino-benzocrown ether, followed by oxidation to the compound of Formula 1: [chemical structure]
